(19) United States
(12) Patent Application Publication
(10) Pub. No.: US 2009/0297850 A1
(43) Pub. Date: Dec. 3, 2009

(54) HOLLOW FIBER, DOPE COMPOSITION FOR FORMING HOLLOW FIBER, AND METHOD OF MAKING HOLLOW FIBER USING THE SAME

(75) Inventors: Chul-Ho Jung, Buk-gu (KR); Sang-Hoon Han, Seoul (KR); Young-Moo Lee, Seoul (KR); Ho-Bum Park, Seoul (KR)

Correspondence Address: LEXYOUME IP GROUP, LLC, 5180 PARKSTONE DRIVE, SUITE 175, CHANTILLY, VA, 20151, US

(73) Assignee: IUCF-HYU(Industry-University Cooperation Foundation Hanyang University), Seoul (KR)

(21) Appl. No.: 12/468,859

(22) Filed: May 19, 2009

Related U.S. Application Data
(63) Continuation-in-part of application No. 12/248,334, filed on Oct. 9, 2008.

(30) Foreign Application Priority Data
May 19, 2008 (KR) 10-2008-0046127

(51) Int. Cl. B01D 69/08; D01D 5/24; B01D 53/22; B01D 71/64; D01D 1/00; C08L 79/08; C08K 5/05; C08K 5/07; C08L 29/04; C08L 39/06; C08K 5/06; C08L 5/08; C08L 5/02; C08K 3/10; C08K 5/098; C08K 3/20; C08K 5/1535; C08L 33/00

(52) U.S. Cl. 428/398; 96/10; 264/49; 524/608; 524/379; 524/356; 525/56; 525/190; 524/377; 524/27; 524/54; 524/401; 524/436; 524/394; 524/113

(57) ABSTRACT

Disclosed is a hollow fiber that includes a hollow positioned at the center of the hollow fiber, macropores positioned at adjacent to the hollow, and mesopores and picopores positioned at adjacent to macropores, and the picopores are three dimensionally connected to each other to form a three dimensional network structure. The hollow fiber includes a polymer derived from polyimide, and the polyimide includes a repeating unit obtained from aromatic diamine including at least one ortho-positioned functional group with respect to an amine group and dianhydride.

### CROSS-REFERENCE TO RELATED APPLICATION

This application claims priority to and the benefit of Korean Patent Application No. 10-2008-0046127 filed in the Korean Intellectual Property Office on May 19, 2009, the entire contents of which are incorporated herein by reference.

### BACKGROUND OF THE INVENTION

(a) Field of the Invention This disclosure relates to a hollow fiber, a dope solution composition for forming a hollow fiber, and a method of preparing a hollow fiber using the same.

(b) Description of the Related Art

Separation membranes should satisfy the requirements of superior thermal, chemical and mechanical stability, high permeability and high selectivity so that they can be commercialized and then applied to a variety of industries. The term “permeability” used herein is defined as a rate at which a substance permeates through a separation membrane. The term “selectivity” used herein is defined as a permeation ratio between two different gas components.

Based on the separation performance, separation membranes may be classified into reverse osmosis membranes, ultrafiltration membranes, microfiltration membranes, gas separation membranes, etc. Based on the shape, separation membranes may be largely classified into flat sheet membranes, spiral-wound membranes, composite membranes and hollow fiber membranes. Of these, asymmetric hollow fiber membranes have the largest membrane areas per unit volume and are thus generally used as gas separation membranes.

A process for separating a specific gas component from various ingredients constituting a gas mixture is greatly important. This gas separation process generally employs a membrane process, a pressure swing adsorption process, a cryogenic process and the like. Of these, the pressure swing adsorption process and the cryogenic process are generalized techniques, design and operations methods of which have already been developed, and are now in widespread use. On the other hand, gas separation using the membrane process has a relatively short history.

The gas separation membrane for membrane process application is used to separate and concentrate various gases, e.g., hydrogen (H₂), helium (He), nitrogen (N₂), oxygen (O₂), carbon monoxide (CO), carbon dioxide (CO₂), water vapor (H₂O), ammonia (NH₃), sulfur compounds (SO₂) and light hydrocarbon gases such as methane (CH₄), ethane (C₂H₆), ethylene (C₂H₄), propane (C₃H₈), propylene (C₃H₆), butane (C₄H₁₀), butylene (C₄H₈). Gas separation may be used in the fields including separation of oxygen or nitrogen present in air, removal of moisture present in compressed air and the like.

The principle for the gas separation using membranes is based on the difference in permeability between respective components constituting a mixture of two or more gases. The gas separation involves a solution-diffusion process, in which a gas mixture comes in contact with a surface of a membrane and at least one component thereof is selectively dissolved. Inside the membrane, selective diffusion occurs. The gas component which permeates the membrane is more rapid than at least one of other components. Gas components having a relatively low permeability pass through the membrane at a speed lower than at least one component. Based upon such a principle, the gas mixture is divided into two flows, i.e., a selectively permeated gas-containing flow and a non-permeated gas-containing flow. Accordingly, in order to suitably separate gas mixtures, there is a demand for techniques to select a membrane-forming material having high perm-selectivity to a specific gas ingredient and to control the material to have a structure capable of exhibiting sufficient permeability.

In order to selectively separate gases and concentrate the same through the membrane separation method, the separation membrane must generally have an asymmetric structure comprising a dense selective-separation layer arranged on the surface of the membrane and a porous supporter with a minimum permeation resistance arranged on the bottom of the membrane. One membrane property, i.e., selectivity, is determined depending upon the structure of the selective-separation layer. Another membrane property, i.e., permeability, depends on the thickness of the selective-separation layer and the porosity level of the lower structure, i.e., the porous supporter of the asymmetric membrane. Furthermore, to selectively separate a mixture of gases, the separation layer must be free from surface defects and have a fine pore size.

Since a system using a gas separation membrane module was developed in 1977 by the Monsanto Company under the trade name “Prism”, gas separation processes using polymer membranes has been first available commercially. The gas separation process has shown a gradual increase in annual gas separation market share due to low energy consumption and low installation cost, as compared to conventional methods.

Since a cellulose acetate semi-permeation membrane having an asymmetric structure as disclosed in U.S. Pat. No. 3,133,132 was developed, a great deal of research has been conducted on polymeric membranes and various polymers are being prepared into hollow fibers using phase inversion methods.

General methods for preparing asymmetric hollow fiber membranes using phase-inversion are wet-spinning and dry-jet-wet spinning. A representative hollow fiber preparation process using dry-jet-wet spinning comprises the following four steps, (1) spinning hollow fibers with a polymeric dope solution, (2) bringing the hollow fibers into contact with air to evaporate volatile ingredients therefrom, (3) precipitating the resulting fibers in a coagulation bath, and (4) subjecting the fibers to post-treatment including washing, drying and the like.

Organic polymers such as polysulfones, polycarbonates, polypyrrolones, polyarylates, cellulose acetates and polyimides are widely used as hollow fiber membrane materials for gas separation. Various attempts have been made to impart permeability and selectivity for a specific gas to polyimide membranes having superior chemical and thermal stability among these polymer materials for gas separation. However, in general polymeric membrane, permeability and selectivity are inversely proportional.

For example, U.S. Pat. No. 4,880,442 discloses polyimide membranes wherein a large fractional free volume is imparted to polymeric chains and permeability is improved using non-rigid anhydrides. Furthermore, U.S. Pat. No. 4,717,393 discloses crosslinked polyimide membranes exhibiting high gas selectivity and superior stability, as compared to conventional polyimide gas separation membranes. In addition, U.S. Pat. Nos. 4,851,505 and 4,912,197 disclose polyimide gas separation membranes capable of reducing the difficulty of polymer processing due to superior solubility in generally-used solvents. In addition, PCT Publication No. WO 2005/007277 discloses defect-free asymmetric membranes comprising polyimide and another polymer selected from the group consisting of polyvinylpyrrolidones, sulfonated polyetheretherketones and mixtures thereof.

However, polymeric materials having membrane performance available commercially for use in gas separation (in the case of air separation, oxygen permeability is 1 Barrer or higher, and oxygen/nitrogen selectivity is 6.0 or higher) are limited to only a few types. This is because there is considerable limitation in improving polymeric structures, and great compatibility between permeability and selectivity makes it difficult to obtain separation and permeation capabilities beyond a predetermined upper limit.

Furthermore, conventional polymeric membrane materials have a limitation of permeation and separation properties and disadvantages in that they undergo decomposition and aging upon a long-term exposure to high pressure and high temperature processes or to gas mixtures containing hydrocarbon, aromatic and polar solvents, thus causing a considerable decrease in inherent membrane performance. Due to these problems, in spite of their high economic value, gas separation processes are utilized in considerably limited applications to date.

Accordingly, there is an increasing demand for development of polymeric materials capable of achieving both high permeability and superior selectivity, and novel gas separation membranes using the same.

In accordance with such demand, a great deal of research has been conducted to modify polymers into ideal structures that exhibit superior gas permeability and selectivity, and have a desired pore size.

### SUMMARY OF THE INVENTION

One aspect of the present invention provides a hollow fiber having gas permeability and selectivity.

Another aspect of the present invention provides a dope solution composition for forming a hollow fiber.

Further aspect of the present invention provides a method of preparing a hollow fiber using the dope solution composition for forming a hollow fiber.

According to one aspect of the present invention, a hollow fiber is provided that includes a hollow positioned at the center of the hollow fiber, macropores positioned at adjacent to the hollow, and mesopores and picopores positioned at adjacent to macropores, and the picopores are three dimensionally connected to each other to form a three dimensional network structure. The hollow fiber includes a polymer derived from polyimide, and the polyimide includes a repeating unit obtained from aromatic diamine including at least one ortho-positioned functional group with respect to an amine group and dianhydride.

The hollow fiber may include a dense layer including picopores at a surface portion, and the dense layer has a structure where the number of the picopores increases as near to the surface of the hollow fiber.

The three dimensional network structure where at least two picopores are three-dimensionally connected includes an hourglass shaped structure forming a narrow valley at connection parts.

The ortho-positioned functional group with respect to the amine group may include OH, SH, or NH₂.

The polymer derived from polyimide has a fractional free volume (FFV) of about 0.15 to about 0.40, and interplanar distance (d-spacing) of about 580 pm to about 800 pm measured by X-ray diffraction (XRD).

The polymer derived from polyimide includes picopores, and the picopores has a full width at half maximum (FWHM) of about 10 pm to about 40 pm measured by positron annihilation lifetime spectroscopy (PALS).

The polymer derived from polyimide has a BET surface area of about 100 to about 1,000 m²/g.

The polyimide may be selected from the group consisting of polyimide represented by the following Chemical Formulae 1 to 4, polyimide copolymers represented by the following Chemical Formulae 5 to 8, copolymers thereof, and blends thereof.

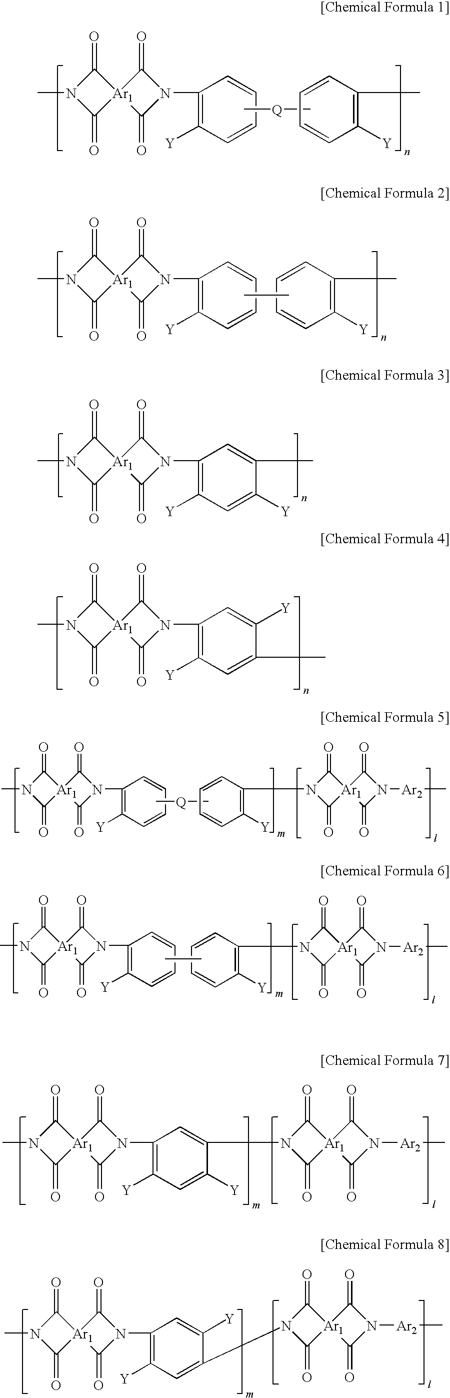

In the above Chemical Formulae 1 to 8,

Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different from each other in each repeating unit and independently selected from OH, SH, or NH₂,

n is an integer ranging from 20 to 200,

m is an integer ranging from 10 to 400, and

l is an integer ranging from 10 to 400.

The polymer may include a polymer represented by one of the following Chemical Formulae 19 to 32, or copolymers thereof.

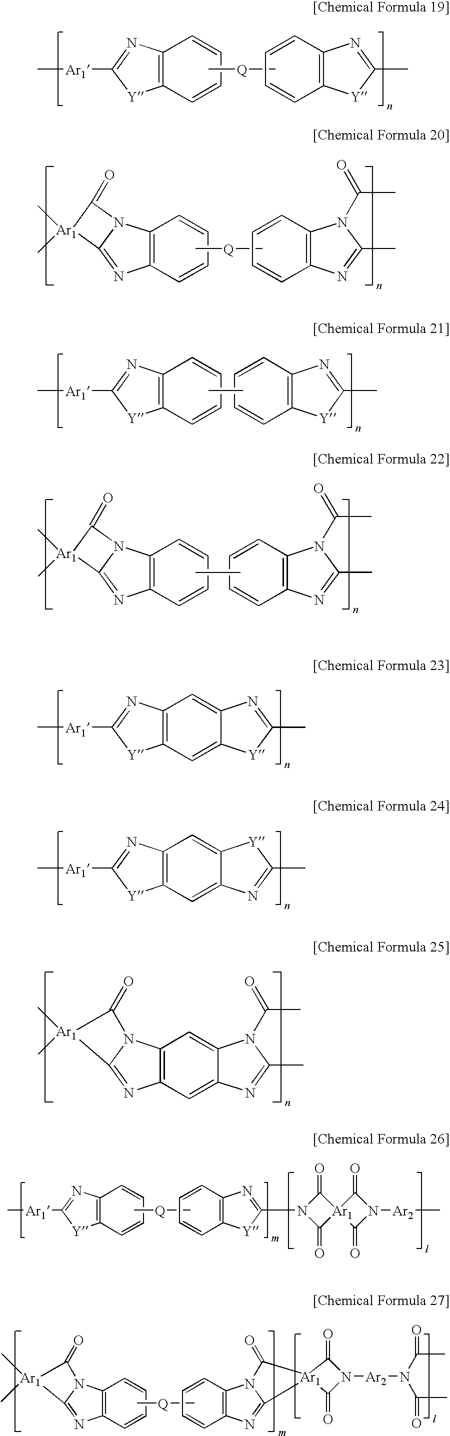

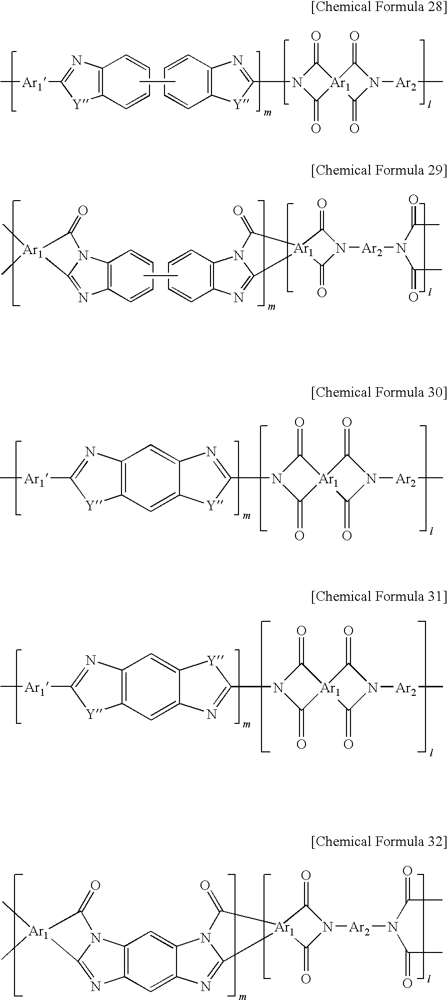

In the above Chemical Formulae 19 to 32,

Ar₁, Ar₂, Q, n, m, and l are the same as defined in the above Chemical Formulae 1 to 8,

Ar₁′ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH, and

Y″ is O or S.

The hollow fiber may be applicable as a gas separation membrane for separating at least one selected from the group consisting of He, H₂, N₂, CH₄, O₂, N₂, CO₂, and combinations thereof.

The hollow fiber has O₂/N₂ selectivity of 4 or more, CO₂/CH₄ selectivity of 30 or more, H₂/N₂ selectivity of 30 or more, H₂/CH₄ selectivity of 50 or more, CO₂/N₂ selectivity of 20 or more, and He/N₂ selectivity of 40 or more. In one embodiment, the hollow fiber may have O₂/N₂ selectivity of 4 to 20, CO₂/CH₄ selectivity of 30 to 80, H₂/N₂ selectivity of 30 to 80, H₂/CH₄ selectivity of 50 to 90, CO₂/N₂ selectivity of 20 to 50, and He/N₂ selectivity of 40 to 120.

Another aspect of the present invention, a dope solution composition for forming a hollow fiber is provided that includes polyimide including a repeating unit prepared from aromatic diamine including at least one ortho-positioned functional group and dianhydride, an organic solvent, and an additive.

The organic solvent includes one selected from the group consisting of dimethylsulfoxide; N-methyl-2-pyrrolidone; N-methylpyrrolidone; N,N-dimethyl formamide; ketones selected from the group consisting of N,N-dimethyl acetamide; γ-butyrolactone, cyclohexanone, 3-hexanone, 3-heptanone, 3-octanone; and combinations thereof.

The additive includes one selected from the group consisting of water; alcohols selected from the group consisting of methanol, ethanol, 2-methyl-1-butanol, 2-methyl-2-butanol, glycerol, ethylene glycol, diethylene glycol, and propylene glycol; ketones selected from the group consisting of acetone and methyl ethyl ketone; polymer compounds selected from the group consisting of polyvinyl alcohol, polyacrylic acid, polyacryl amide, polyethylene glycol, polypropylene glycol, chitosan, chitin, dextran, and polyvinylpyrrolidone; salts selected from the group consisting of lithium chloride, sodium chloride, calcium chloride, lithium acetate, sodium sulfate, and sodium hydroxide; tetrahydrofuran; trichloroethane; and mixtures thereof.

The ortho-positioned functional group with respect to the amine group may include OH, SH, or NH₂.

The dope solution composition for forming a hollow fiber includes about 10 to about 45 wt % of the polyimide, about 25 to about 70 wt % of the organic solvent, and about 2 to about 30 wt % of the additive.

The dope solution composition for forming a hollow fiber has a viscosity of about 2 Pa·s to about 200 Pa·s.

The polyimide has a weight average molecular weight (Mw) of about 10,000 to about 200,000.

In the dope solution composition for forming a hollow fiber, the polyimide may be selected from the group consisting of polyimide represented by the following Chemical Formulae 1 to 4, polyimide copolymers represented by the following Chemical Formulae 5 to 8, copolymers thereof, and blends thereof.

Another embodiment of the present invention, a method of preparing a hollow fiber is provided that includes spinning a dope solution composition for forming a hollow fiber to prepare a polyimide hollow fiber, and heat-treating the polyimide hollow fiber to obtain a hollow fiber including thermally rearranged polymer. The hollow fiber includes a hollow positioned at the center of the hollow fiber, macropores positioned at adjacent to the hollow, and mesopores and picopores positioned at adjacent to macropores, and the picopores are three dimensionally connected to each other to form a three dimensional network structure.

The thermally rearranged polymer may include polymers represented by one of the above Chemical Formulae 19 to 32 or copolymers thereof.

The polyimide represented by one of the above Chemical Formulae 1 to 8 may be obtained from imidization of polyamic acid represented by one of the following Chemical Formulae 33 to 40.

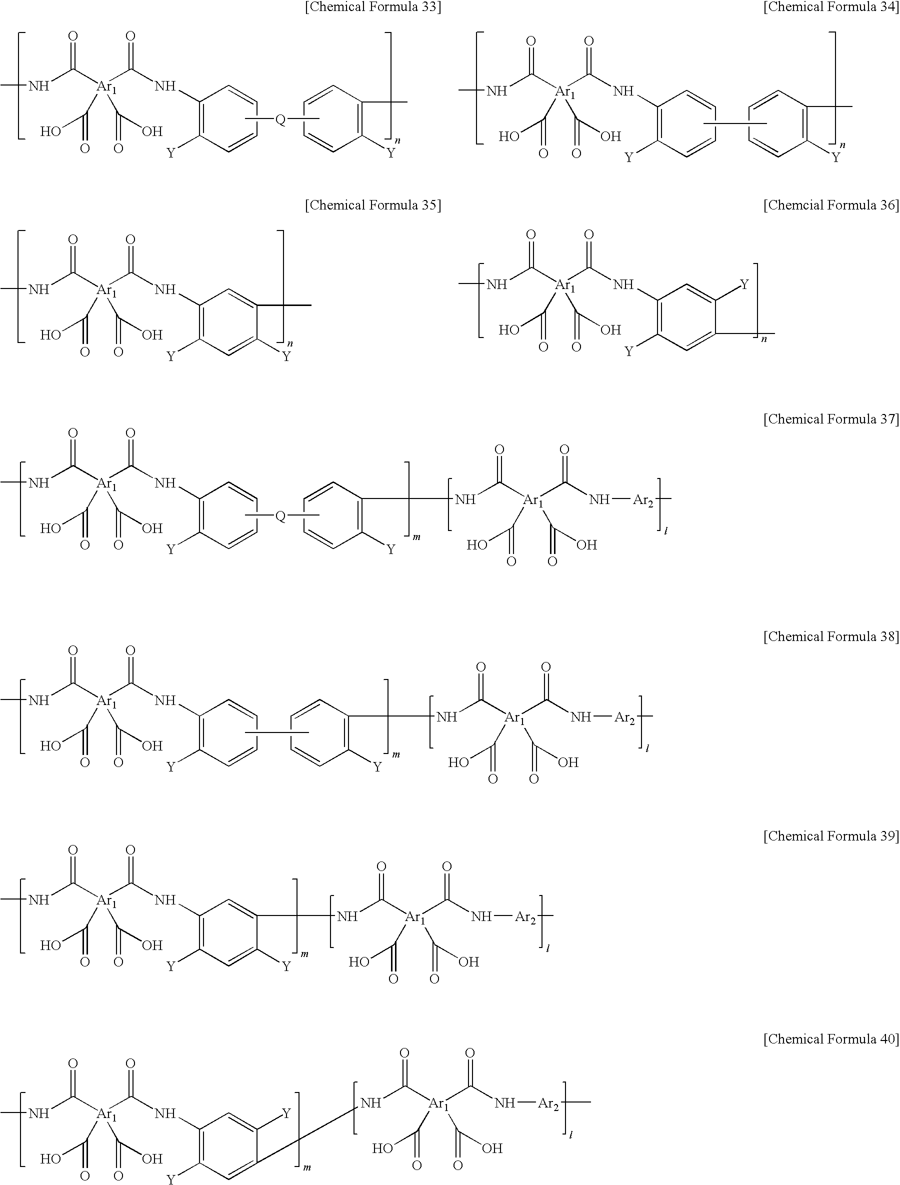

In the above Chemical Formulae 33 to 40, Ar₁, Ar₂, Q, Y, n, m and l are the same as in the above Chemical Formulae 1 to 8.

The imidization include chemical imidization and solution-thermal imidization.

The chemical imidization is carried out at about 20 to about 180° C. for about 4 to about 24 hours.

The chemical imidization may further include protecting an ortho-positioned functional group of polyamic acid with a protecting group before imidization, and removing the protecting group after imidization.

The solution-thermal imidization may be performed at about 100 to about 180° C. for about 2 to about 30 hours in a solution.

The solution-thermal imidization may also further include protecting an ortho-positioned functional group of polyamic acid with a protecting group before imidization, and removing the protecting group after imidization.

The solution-thermal imidization may be performed using an azeotropic mixture.

In the above method of preparing the hollow fiber, the heat treatment of the polyimide hollow fiber may be performed by increasing a temperature at about 10 to about 30° C./min up to about 400 to about 550° C., and then maintaining the temperature for about 1 minute to about 1 hour under an inert atmosphere.

In the above Chemical Formulae 1 to 8 and Chemical Formulae 19 to 40, Ar₁ may be selected from one of the following Chemical Formulae.

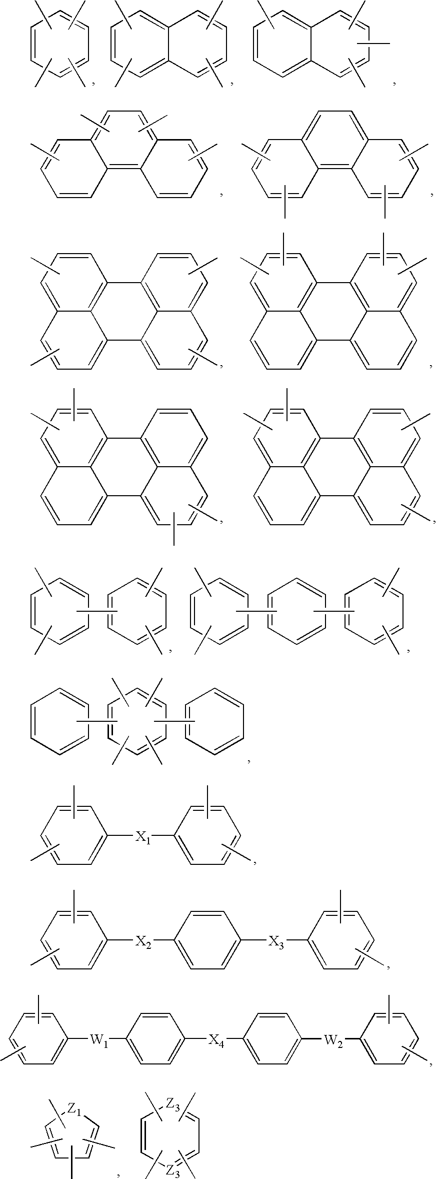

In the above Chemical Formulae,

X₁, X₂, X₃, and X₄ are the same or different and independently O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, or C(═O)NH,

W₁ and W₂ are the same or different, and independently O, S, or C(═O),

Z₁ is O, S, CR₁R₂ or NR₃, where R₁, R₂, and R₃ are the same or different from each other and independently hydrogen or a C1 to C5 alkyl group, and

Z₂ and Z₃ are the same or different from each other and independently N or CR₄ (where, R₄ is hydrogen or a C1 to C5 alkyl group), provided that both Z₂ and Z₃ are not CR₄.

In the above Chemical Formulae 1 to 8 and Chemical Formula 19 to Chemical Formula 40, specific examples of Ar₁ may be selected from one of the following Chemical Formulae.

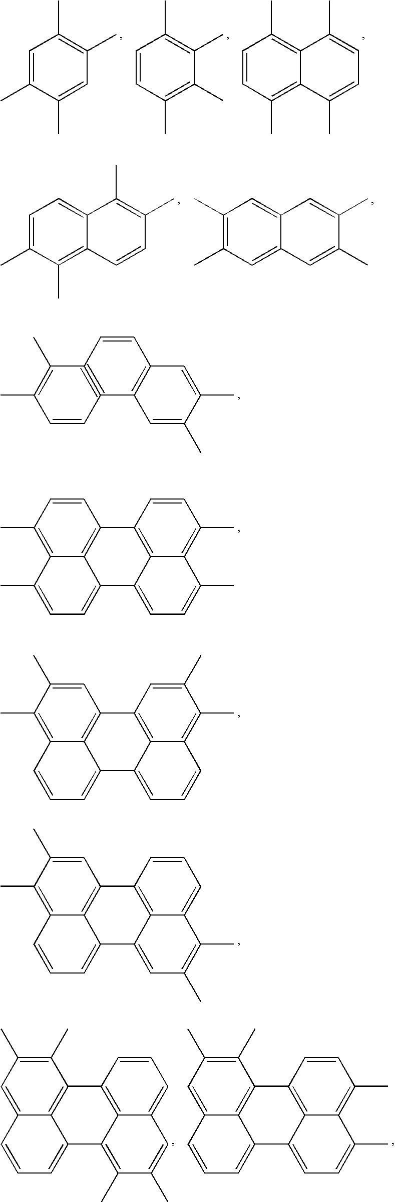

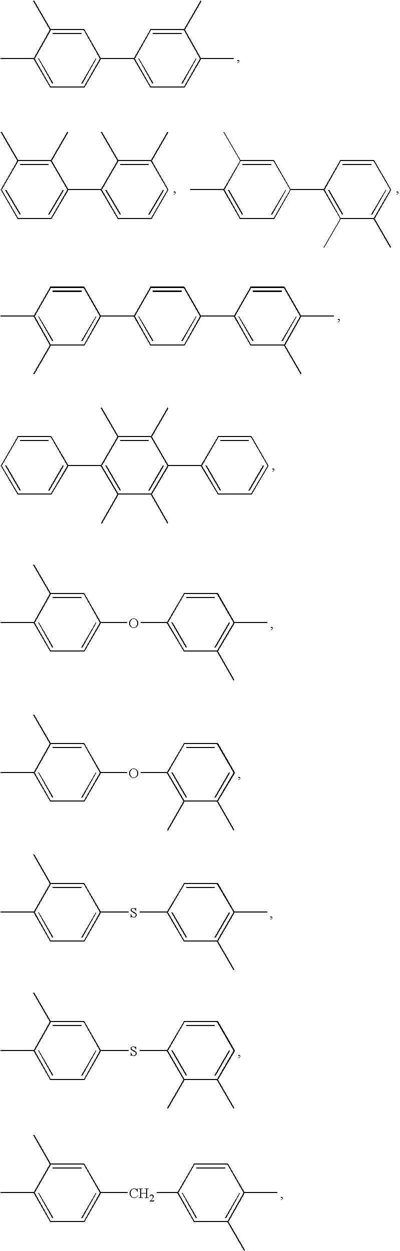

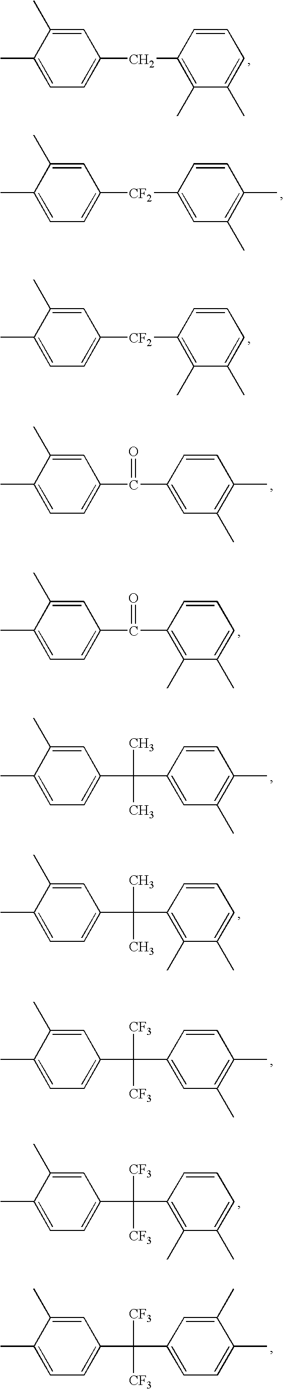

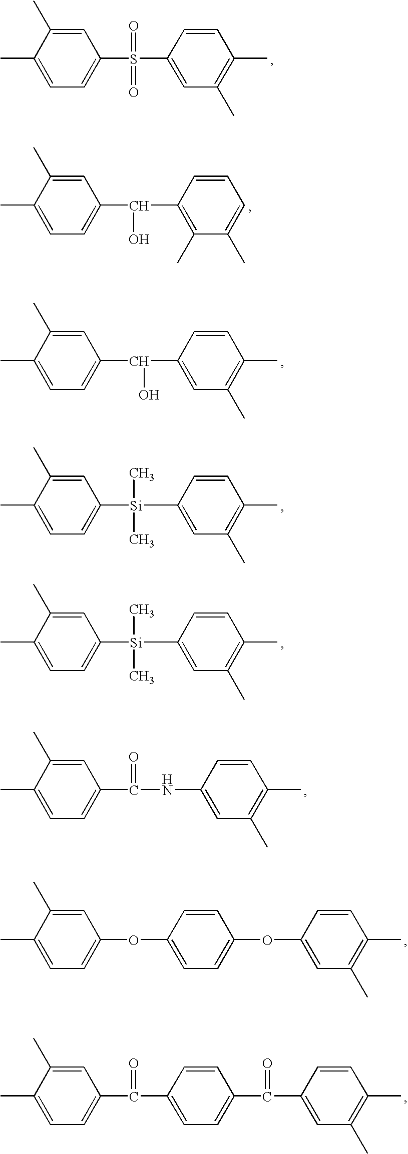

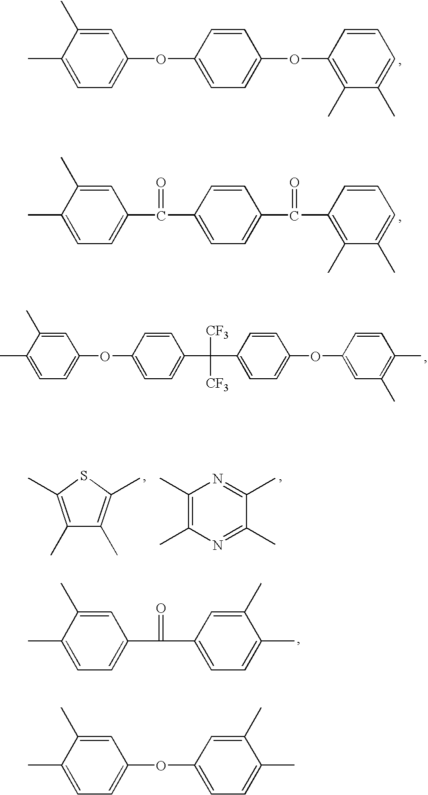

In the above Chemical Formulae 1 to 8 and Chemical Formulae 19 to 40, Ar₂ may be selected from one of the following Chemical Formulae.

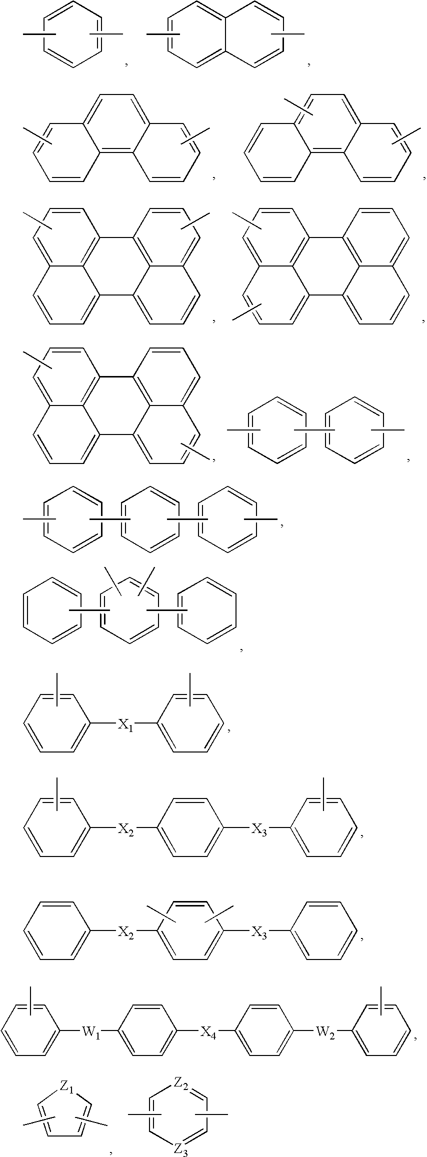

In the above Chemical Formulae,

X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different, and independently O, S, or C(═O),

Z₁ is O, S, CR₁R₂ or NR₃, where R₁, R₂ and R₃ are the same or different from each other and independently hydrogen or a C1 to C5 alkyl group, and

Z₂ and Z₃ are the same or different from each other and independently N or CR₄ (where, R₄ is hydrogen or a C1 to C5 alkyl group), provided that both Z₂ and Z₃ are not CR₄.

In the above Chemical Formulae 1 to 8 and Chemical Formulae 19 to 40, specific examples of Ar₂ may be selected from one of the following Chemical Formulae.

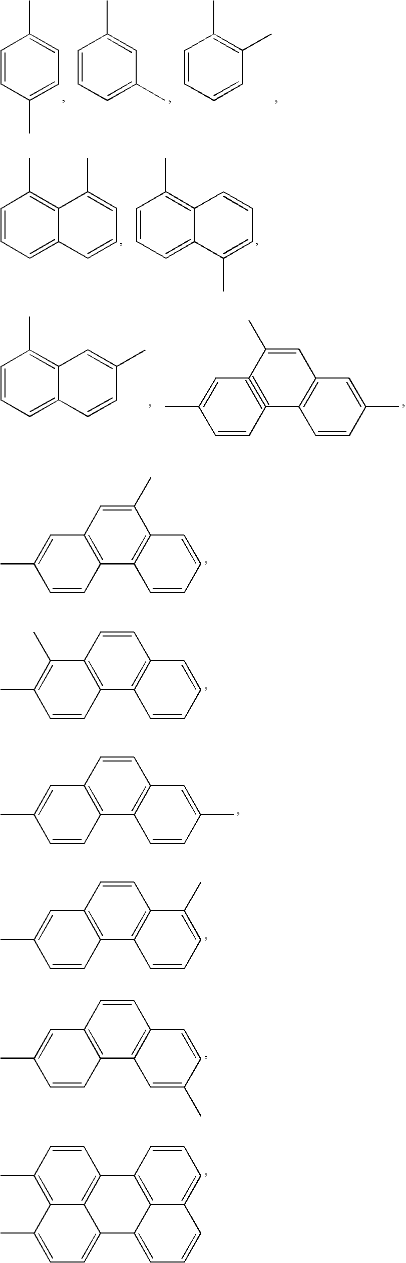

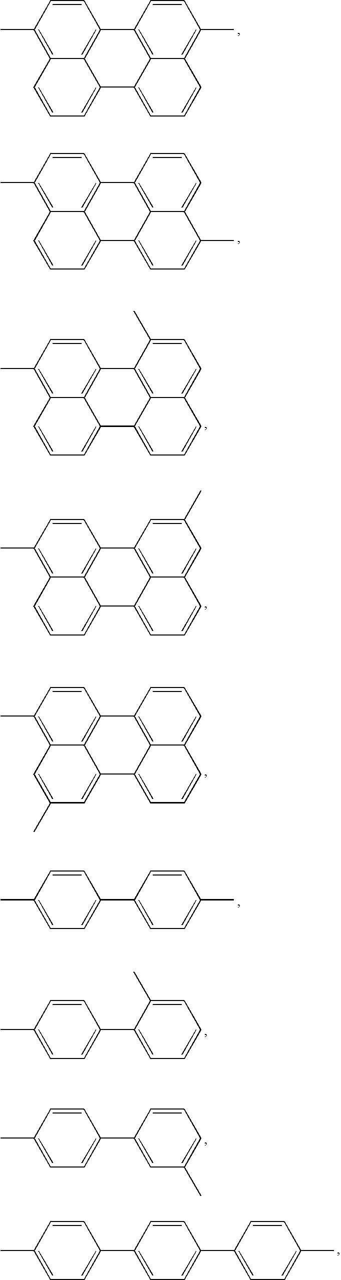

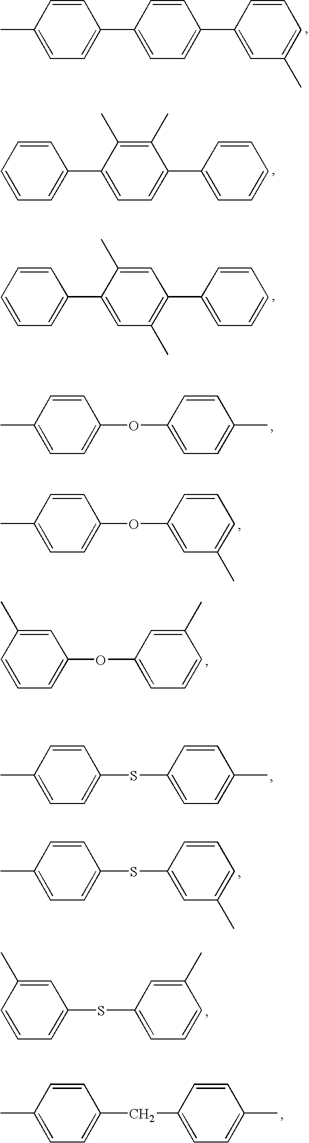

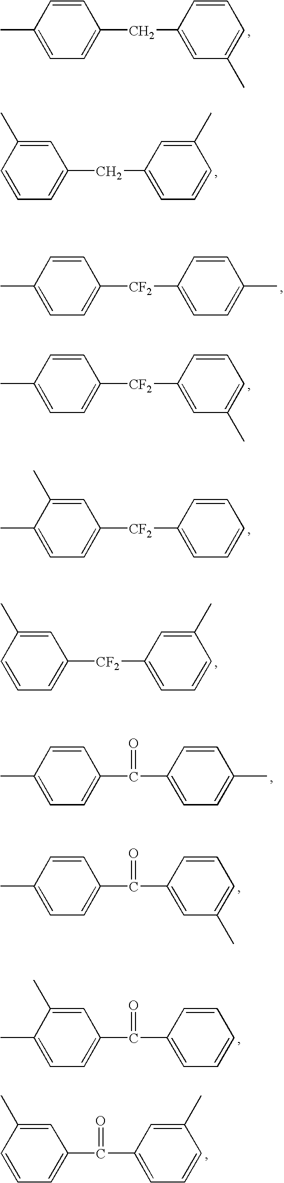

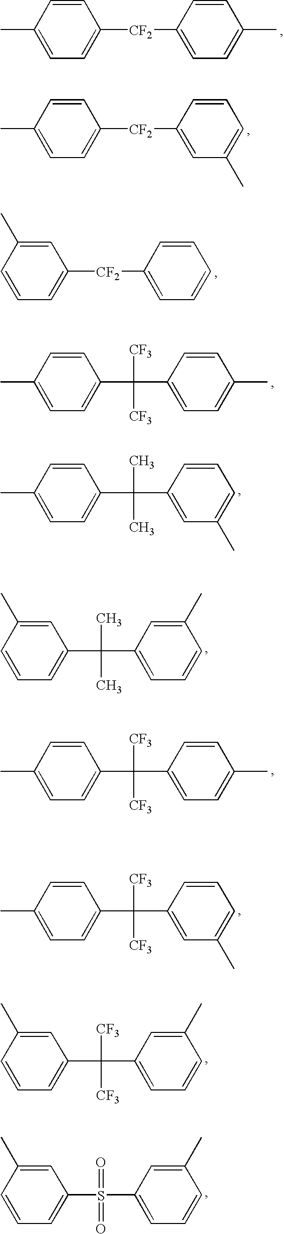

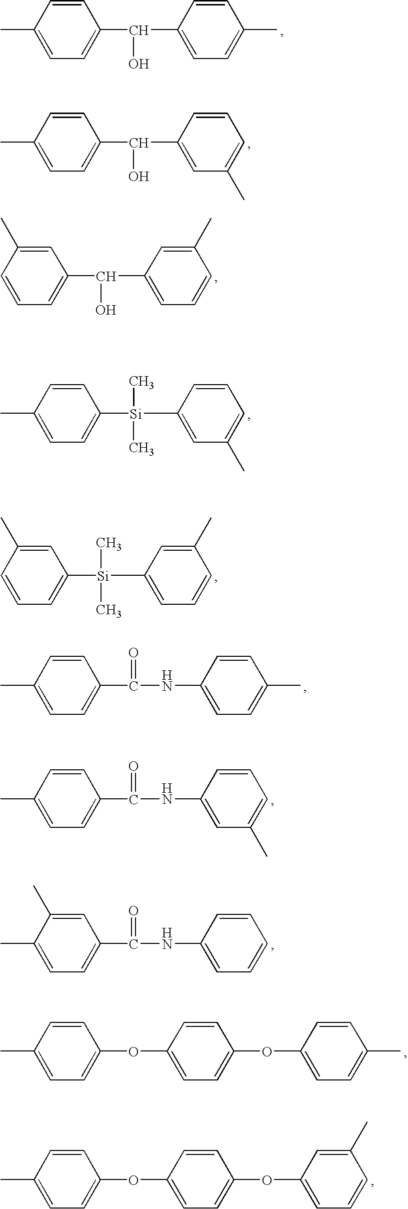

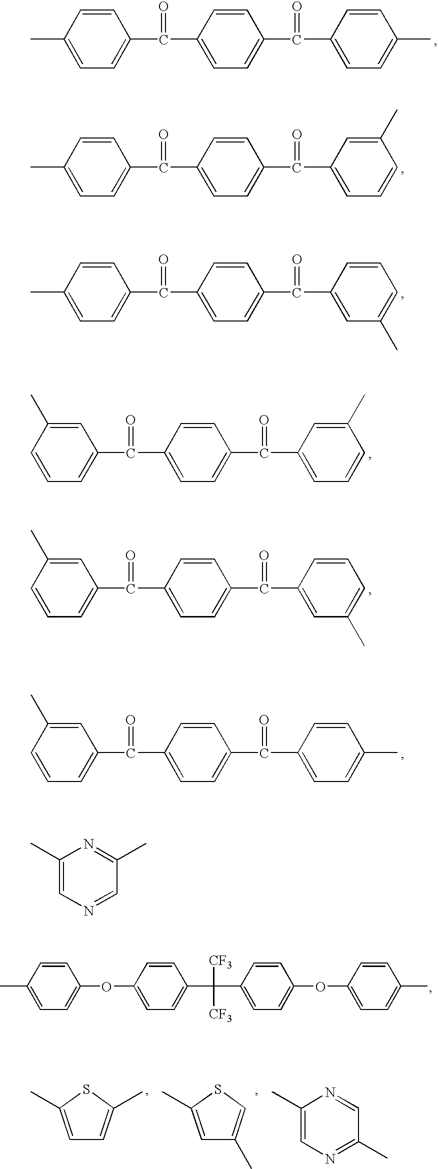

In the above Chemical Formulae 1 to 8 and Chemical Formulae 19 to 40, Q is selected from C(CH₃)₂, C(CF₃)₂, O, S, S(═O)₂, or C(═O).

In the above Chemical Formulae 19 to 32, examples of Ar₁′ are the same as in those of Ar₂ of the above Chemical Formulae 1 to 8 and Chemical Formulae 19 to 40.

In the above Chemical Formulae 1 to 8, Ar₁ may be a functional group represented by the following Chemical Formula A, B, or C, Ar₂ may be a functional group represented by the following Chemical Formula D or E, and Q may be C(CF₃)₂.

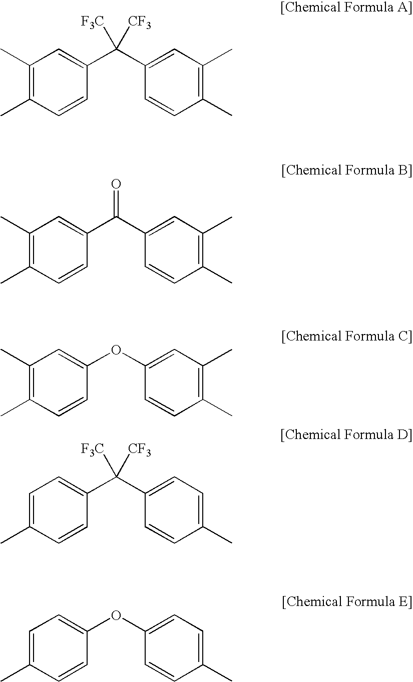

In the above Chemical Formulae 19 to 32, Ar₁ may be a functional group represented by the following Chemical Formula A, B, or C, Ar₁′ may be a functional group represented by the following Chemical Formula F, G, or H, Ar₂ may be a functional group represented by the following Chemical Formula D or E, and Q may be C(CF₃)₂.

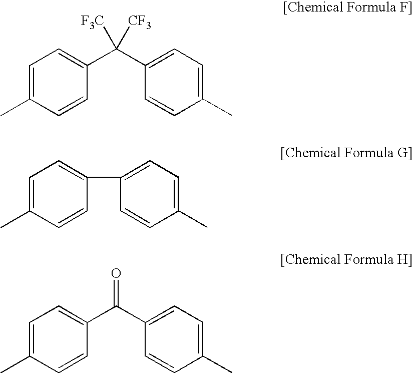

In the polyimide copolymer represented by the above Chemical Formulae 1 to 4 and Chemical Formula 5 to 8, a m:l mole ratio of each repeating unit ranges from 0.1:9.9 to 9.9:0.1.

Hereinafter, further embodiments of the present invention will be described in detail.

The hollow fiber has excellent gas permeability, selectivity, mechanical strength, and chemical stability, and good endurance to stringent condition such as long operation time, acidic conditions, and high humidity.

### BRIEF DESCRIPTION OF THE DRAWINGS

FIG. 1 is a cross-sectional scanning electron microscope (SEM) image of a hollow fiber prepared in Example 1 at 100× magnification;

FIG. 2 is a cross-sectional scanning electron microscope (SEM) image of a hollow fiber prepared in Example 1 at 3,000× magnification;

FIG. 3 is a cross-sectional scanning electron microscope (SEM) image of a hollow fiber prepared in Example 1 at 10,000× magnification;

FIG. 4 is a cross-sectional scanning electron microscope (SEM) image of a hollow fiber prepared in Example 1 at 40,000× magnification;

FIG. 5 is a cross-sectional scanning electron microscope (SEM) image of a hollow fiber prepared in Example 8 at 100× magnification;

FIG. 6 is a cross-sectional scanning electron microscope (SEM) image of a hollow fiber prepared in Example 8 at 1,000× magnification;

FIG. 7 is a cross-sectional scanning electron microscope (SEM) image of a hollow fiber prepared in Example 8 at 5,000× magnification;

FIG. 7 is a graph comparing oxygen permeability (GPU) and oxygen/nitrogen selectivity for hollow fibers prepared in Examples 1 to 18 and Comparative Examples 1 to 3 (the numbers 1′ to 3′ indicate Comparative Examples 1 to 3, respectively; and the numbers 1 to 18 indicate Examples 1 to 18, respectively); and

FIG. 8 is a graph comparing carbon dioxide permeability (GPU) and carbon dioxide/methane selectivity for hollow fibers prepared in Examples 1 to 18 and Comparative Examples 1 to 3 (the numbers 1′ to 3′ indicate Comparative Examples 1 to 3, respectively; and the numbers 1 to 18 indicate Examples 1 to 18, respectively).

### DETAILED DESCRIPTION OF THE INVENTION

This application is a continuation-in-part application of U.S. patent application Ser. No. 12/248,334, filed on Oct. 9, 2008, which is incorporated by reference herein in its entirety.

Exemplary embodiments of the present invention will hereinafter be described in detail. However, these embodiments are only exemplary, and the present invention is not limited thereto.

As used herein, when a specific definition is not provided, the term “surface portion” refers to an outer surface portion, an inner surface portion, or outer surface portion/inner surface portion of a hollow fiber, and the term “surface” refers to an outer surface, an inner surface, or outer surface/inner surface of a hollow fiber. The term “picopore” refers to a pore having an average diameter of hundreds of picometers, and in one embodiment having 100 picometers to 1000 picometers. The term “mesopore” refers to a pore having an average diameter of 2 to 50 naometers, and the term “macropore” refers to a pore having an average diameter of more than 50 naometers.

As used herein, when a specific definition is not provided, the term “substituted” refers to a compound or a functional group where hydrogen is substituted with at least one substituent selected from the group consisting of a C1 to C10 alkyl group, a C1 to C10 alkoxy group, a C1 to C10 haloalkyl group, and a C1 to C10 haloalkoxy group. The term, “hetero cyclic group” refers to a C3 to C30 heterocycloalkyl group, a C3 to C30 heterocycloalkenyl group, or a C3 to C30 heteroaryl group including 1 to 3 heteroatoms selected from the group consisting of O, S, N, P, Si, and combinations thereof. The term “copolymer” refers to a block copolymer to a random copolymer.

The hollow fiber according to one embodiment of the present invention includes a hollow positioned at the center of the hollow fiber, macropores positioned at adjacent to the hollow, and mesopores and picopores positioned at adjacent to macropores, and the picopores are three dimensionally connected to each other to form a three dimensional network structure. The hollow fiber includes a polymer derived from polyimide, and the polyimide includes a repeating unit obtained from aromatic diamine including at least one ortho-positioned functional group with respect to an amine group and dianhydride.

The hollow fiber may include a dense layer including picopores at a surface portion The hollow fiber is capable of separating gases selectively and efficiently due to such a dense layer. The dense layer may have a thickness ranging from 50 nm to 1 μm.

The dense layer has a structure where the number of the picopores increases as near to the surface of the hollow fiber. Thereby, at the hollow fiber surface, selective gas separation may be realized, and at a lower of the membrane, gas concentration may be efficiently realized.

The three dimensional network structure where at least two picopores are three-dimensionally connected includes a hourglass shaped structure forming a narrow valley at connection parts. The hourglass shaped structure forming a narrow valley at connection parts makes gases selective separation and relatively wider picopores than the valley makes separated gases transfer fast.

The ortho-positioned functional group with respect to the amine group may include OH, SH, or NH₂. The polyimide may be prepared by generally-used method in this art. For example, the polyimide is obtained form imidization of polyhydroxyamic acid having OH group at ortho-position with respect to an amine group, polythiolamic acid having SH group at ortho-position with respect to an amine group, polyaminoamic acid having a NH₂ group at ortho-position with respect to an amine group, or copolymers of the polyamic acid.

The polyimide is thermally rearranged into a polymer such as polybenzoxazole, polybenzthiazole, or polypyrrolone having high fractional free volume in accordance with a method that will be described below. For example, polyhydroxyimide having an ortho-positioned OH group with respect to an amine group is thermally rearranged to polybenzoxazole, polythiolimide having an ortho-positioned SH group with respect to an amine group is thermally rearranged to polybenzthiazole, and polyaminoimide having an ortho-positioned NH₂ group with respect to an amine group is thermally rearranged to polypyrrolone. The hollow fiber according to one embodiment of the present invention includes the polymer such as polybenzoxazole, polybenzthiazole, or polypyrrolone having high fractional free volume.

The polymer derived from polyimide has a fractional free volume (FFV) of about 0.15 to about 0.40, and interplanar distance (d-spacing) of about 580 pm to about 800 pm measured by X-ray diffraction (XRD). The polymer derived from polyimide has excellent gas permeability, and the hollow fiber including the polymer derived from polyimide is applicable for selective and efficient gas separation.

The polymer derived from polyimide includes picopores. The picopores has an average diameter having about 600 pm to about 800 pm. The picopores has a full width at half maximum (FWHM) of about 10 pm to about 40 pm measured by positron annihilation lifetime spectroscopy (PALS). It indicates that the produced picopores have significantly uniform size. Thereby, the hollow including the polymer derived from polyimide is capable of separating gases selectively and stably. The PALS measurement is performed by obtaining time difference, [symbol] and the like between γ₀ of 1.27 MeV produced by radiation of positron produced from ²²Na isotope and γ₁ and γ₂ of 0.511 MeV produced by annihilation thereafter.

The polymer derived from polyimide has a BET (Brunauer, Emmett, Teller) surface area of about 100 to about 1,000 m²/g. When the BET surface area is within the range, surface area appropriate for gas adsorption can be obtained. Thereby, the hollow fiber has excellent selectivity and permeability at separating gases through a dissolution-diffusion mechanism.

The polyimide may be selected from the group consisting of polyimide represented by the following Chemical Formulae 1 to 4, polyimide copolymers represented by the following Chemical Formulae 5 to 8, copolymers thereof, and blends thereof, but is not limited thereto.

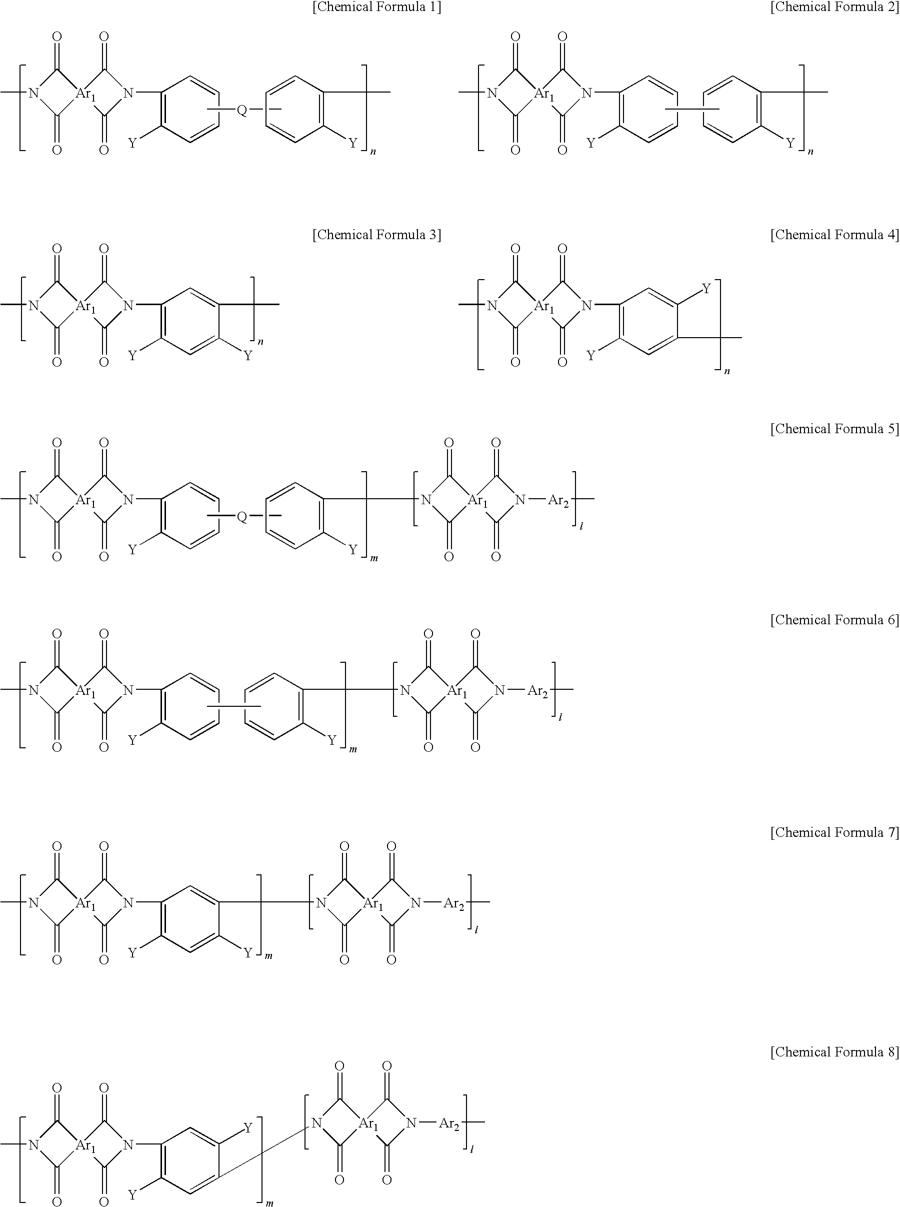

In the above Chemical Formulae 1 to 8,

Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different from each other in each repeating unit and independently selected from OH, SH, or NH₂,

n is an integer ranging from 20 to 200,

m is an integer ranging from 10 to 400, and

l is an integer ranging from 10 to 400.

Examples of the copolymers of the polyimide represented by the above Chemical Formula 1 to 4 include polyimide copolymers represented by the following Chemical Formulae 9 to 18.

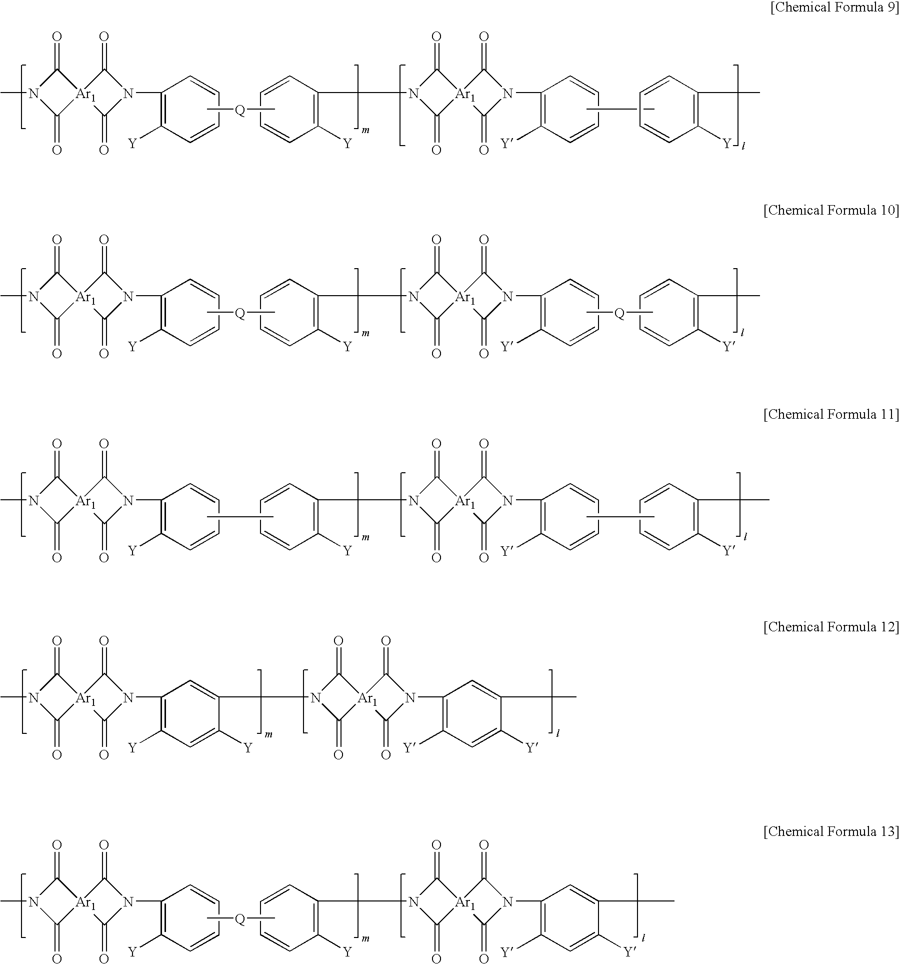

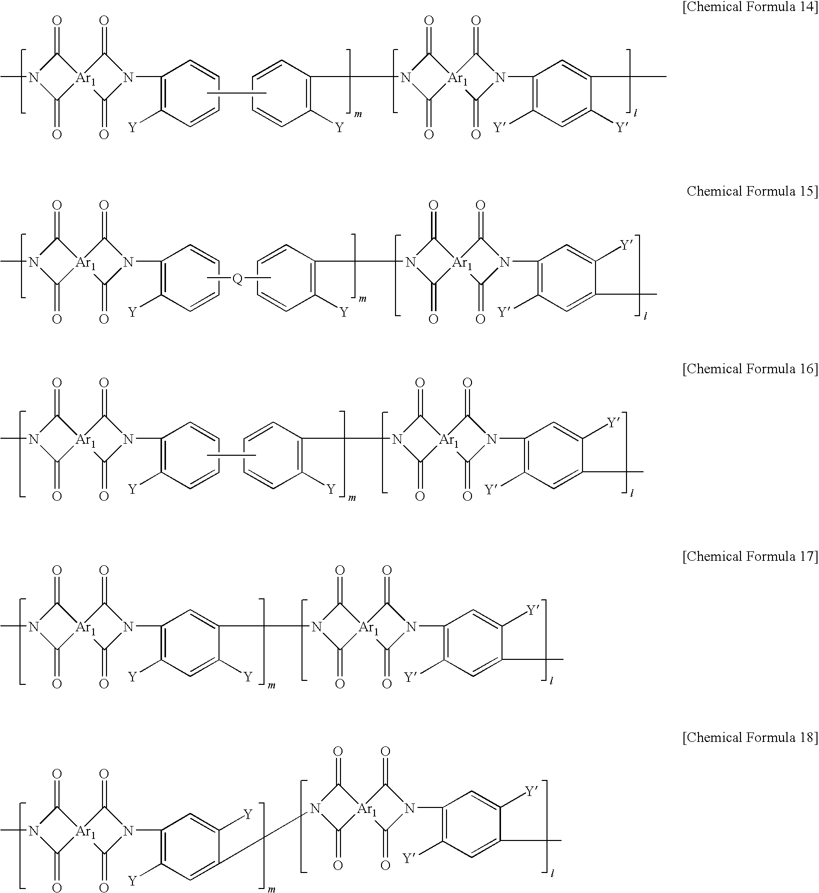

In the above Chemical Formulae 9 to 18,

Ar₁, Q, n, m, and l are the same as defined in the above Chemical Formulae 1 to 8,

Y and Y′ are the same or different, and are independently OH, SH, or NH₂.

In the above Chemical Formulae 1 to 18, Ar₁ may be selected from one of the following Chemical Formulae.

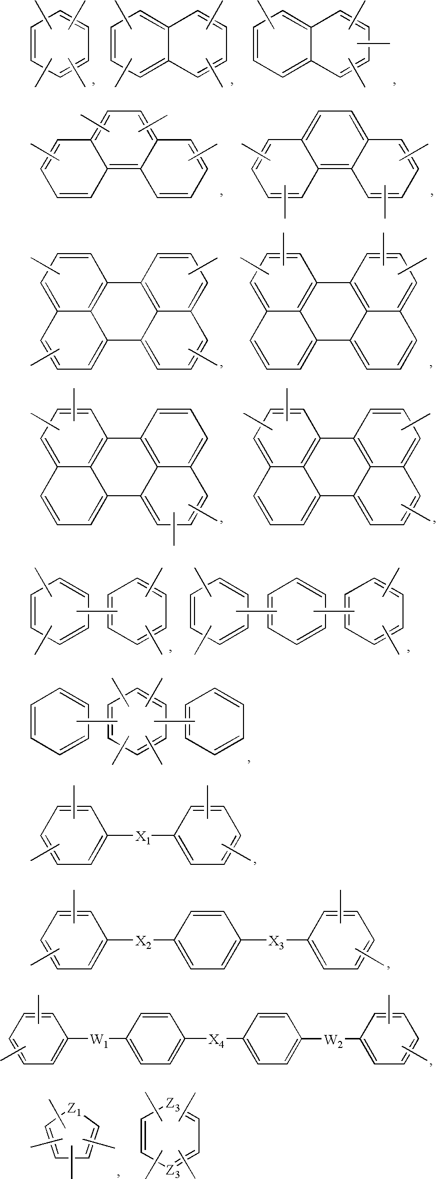

In the above Chemical Formulae,

X₁, X₂, X₃, and X₄ are the same or different, and independently O, S, C(═O), CH(OH), S(═O)₂, Si CH₃₂, CH₂ₚ (where, 1≦p≦10), (CF₂), (where, 1≦q≦10), CCH₃₂, CCF₃₂, or C(═O)NH,

W₁ and W₂ are the same or different, and independently O, S, or C(═O),

Z₁ is O, S, CR₁R₂ or NR₃, where R₁, R₂, and R₃ are the same or different from each other and independently hydrogen or a C1 to C5 alkyl group, and

Z₂ and Z₃ are the same or different from each other and independently N or CR₄ (where, R₄ is hydrogen or a C1 to C5 alkyl group), provided that both Z₂ and Z₃ are not CR₄.

In the above Chemical Formulae 1 to 18, specific examples of Ar₁ may be selected from one of the following Chemical Formulae, but are not limited thereto.

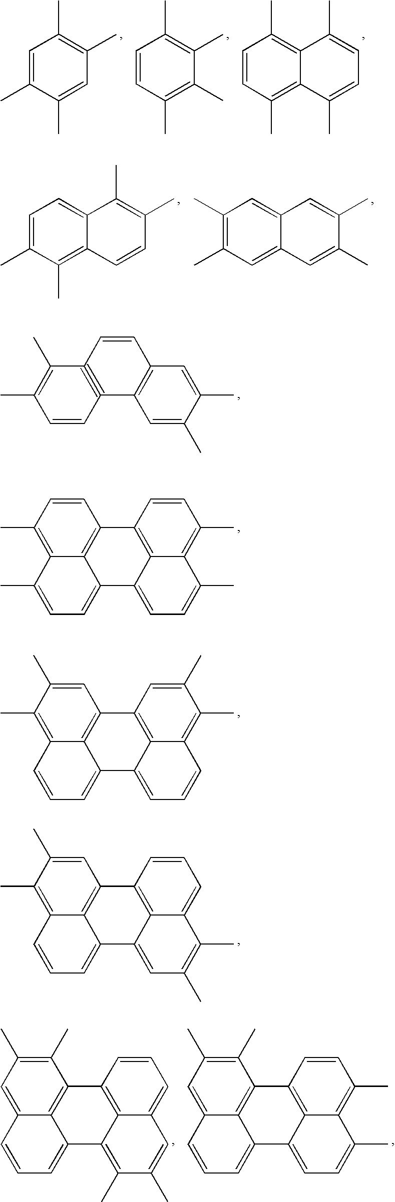

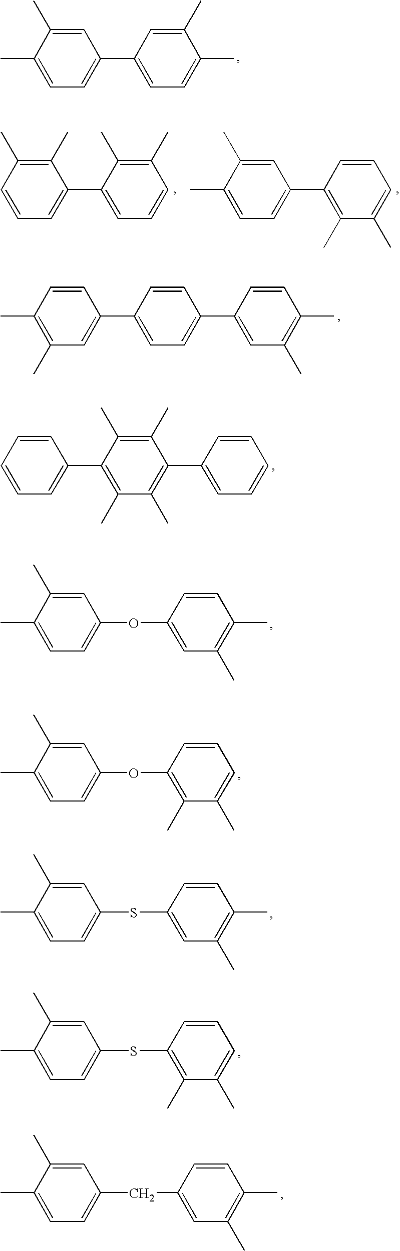

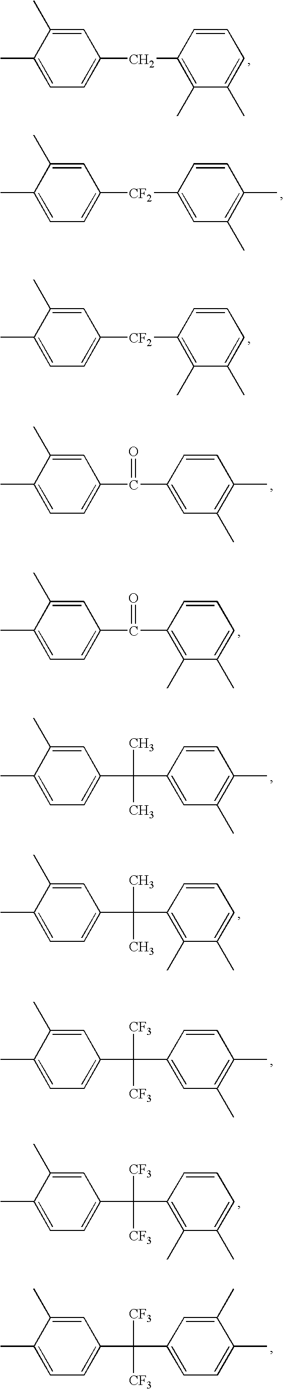

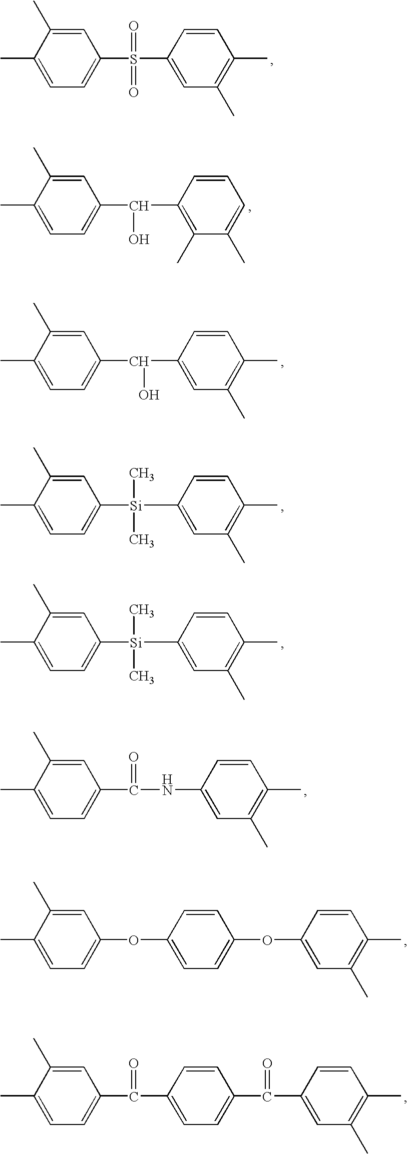

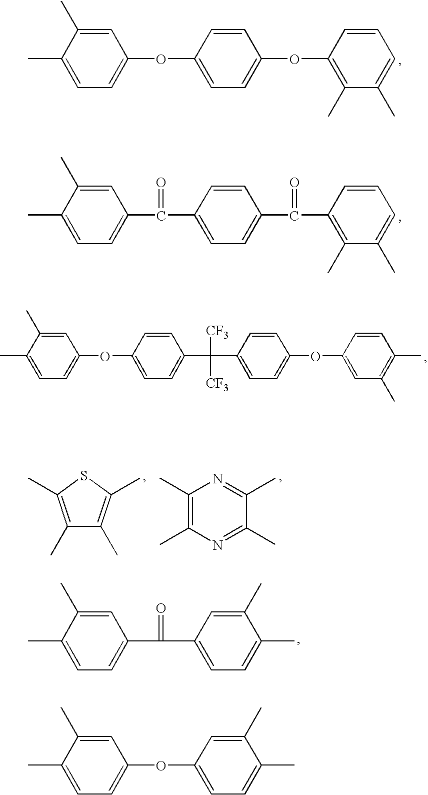

In the above Chemical Formulae 1 to 18, Ar₂ may be selected from one of the following Chemical Formulae, but is not limited thereto.

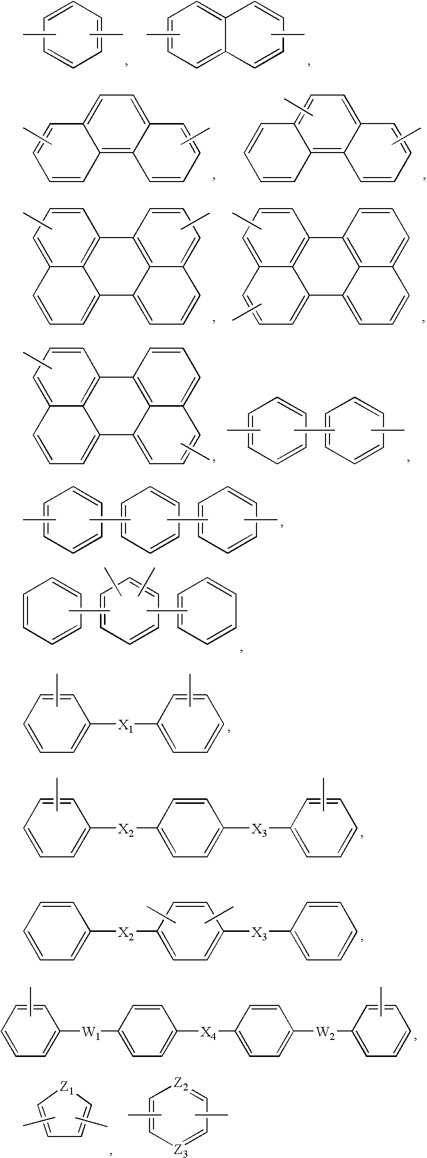

In the above Chemical Formulae,

X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different, and independently O, S, or C(═O),

Z₁ is O, S, CR₁R₂ or NR₃, where R₁, R₂ and R₃ are the same or different from each other and independently hydrogen or a C1 to C5 alkyl group, and

Z₂ and Z₃ are the same or different from each other and independently N or CR₄ (where, R₄ is hydrogen or a C1 to C5 alkyl group), provided that both Z₂ and Z₃ are not CR₄.

In the above Chemical Formulae 1 to 18, specific examples of Ar₂ may be selected from one of the following Chemical Formulae, but are not limited thereto.

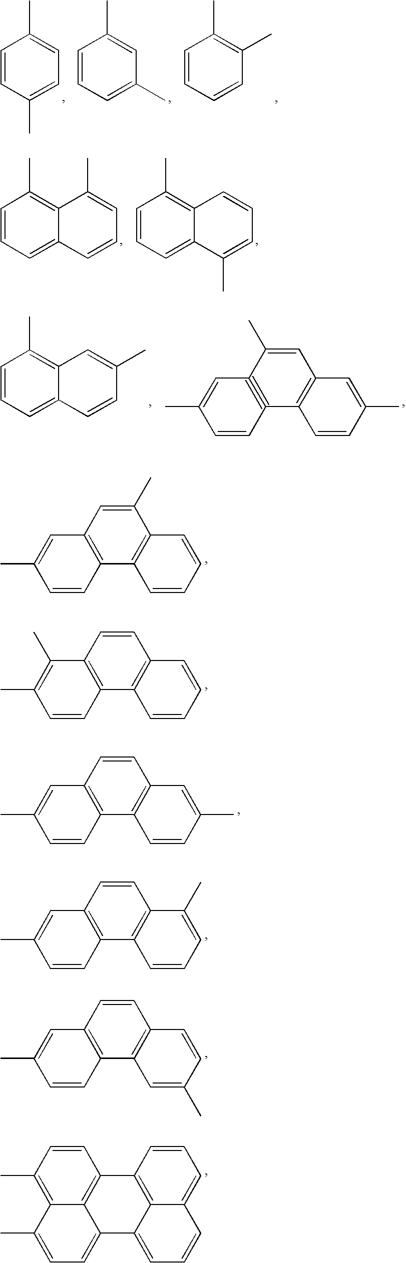

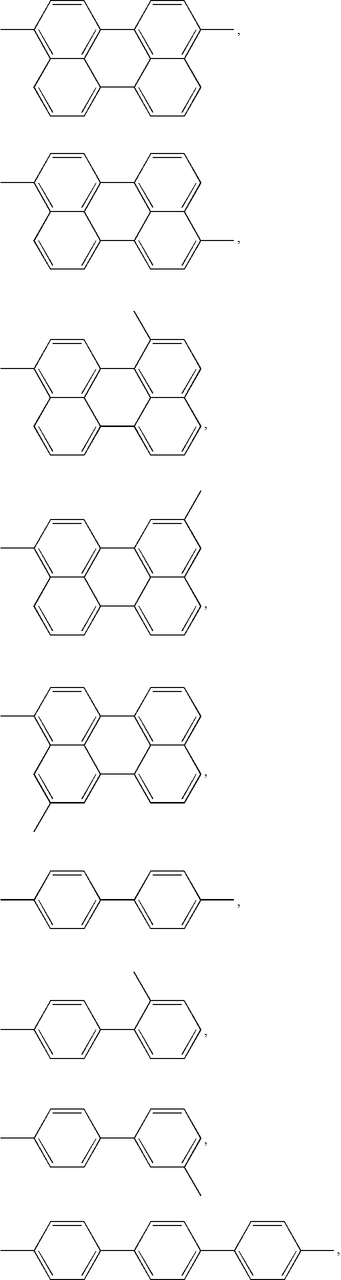

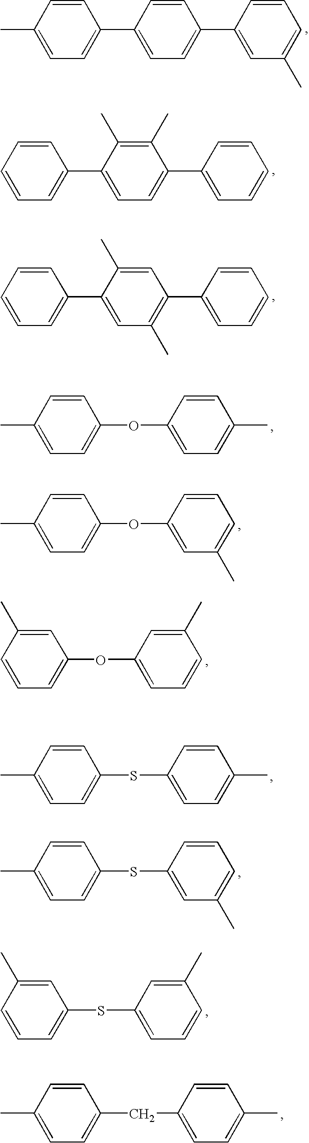

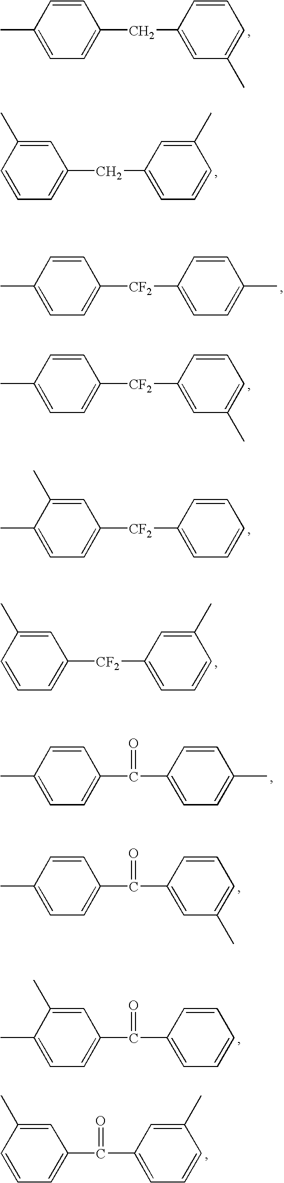

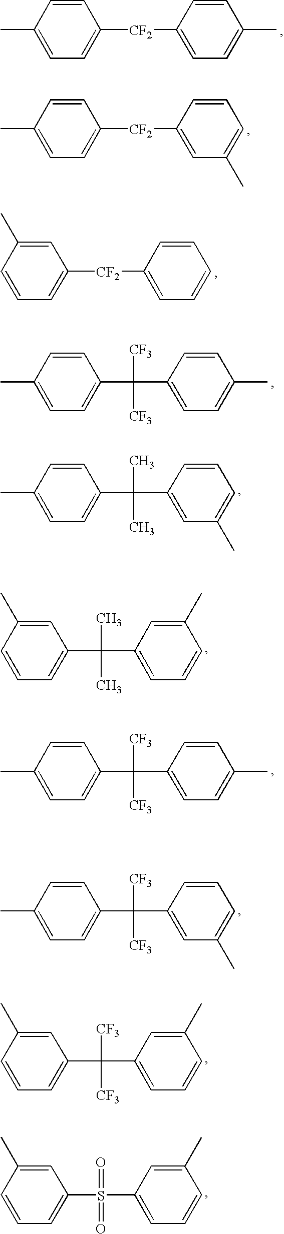

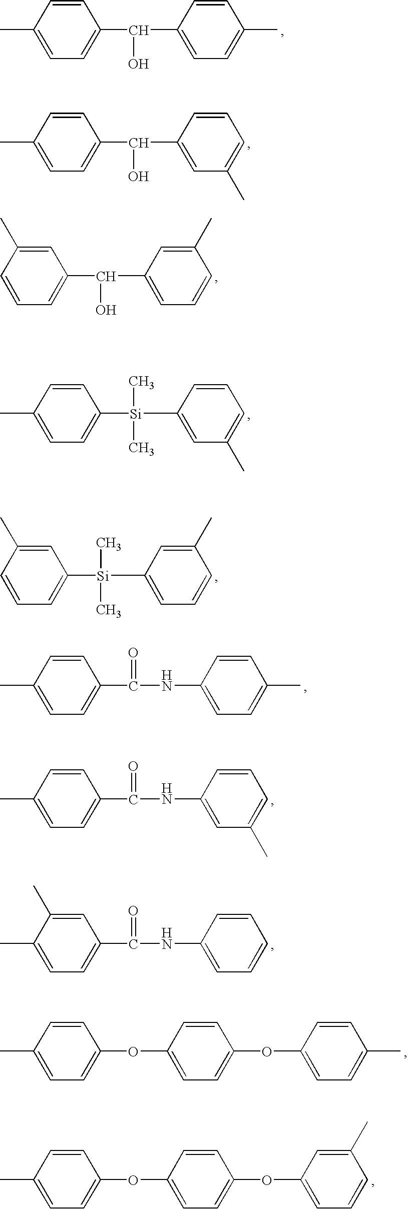

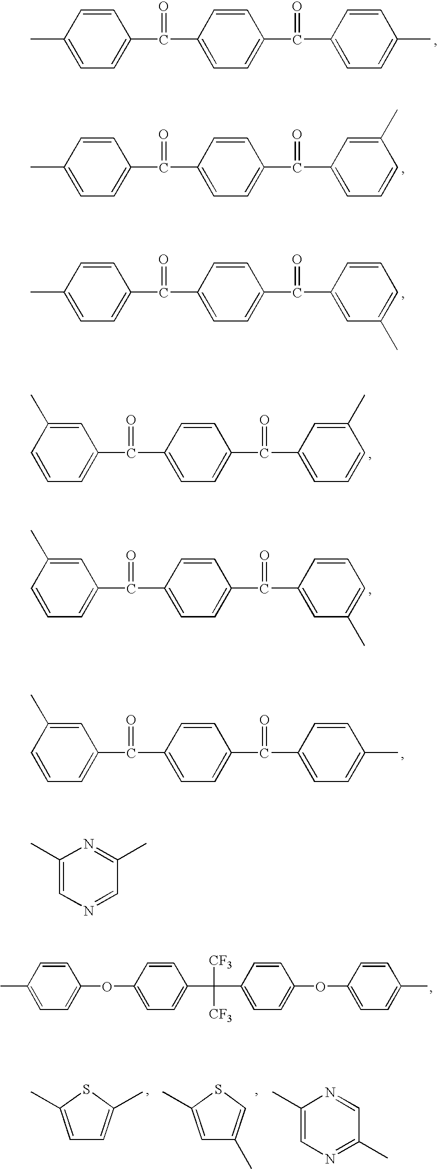

In the above Chemical Formulae 1 to 18, Q is selected from C(CH₃)₂, C(CF₃)₂, O, S, S(═O)₂, and C(═O), but is not limited thereto.

In the above Chemical Formulae 1 to 18, Ar₁ may be a functional group represented by the following Chemical Formula A, B, or C, Ar₂ may be a functional group represented by the following Chemical Formula D or E, and Q may be C(CF₃)₂.

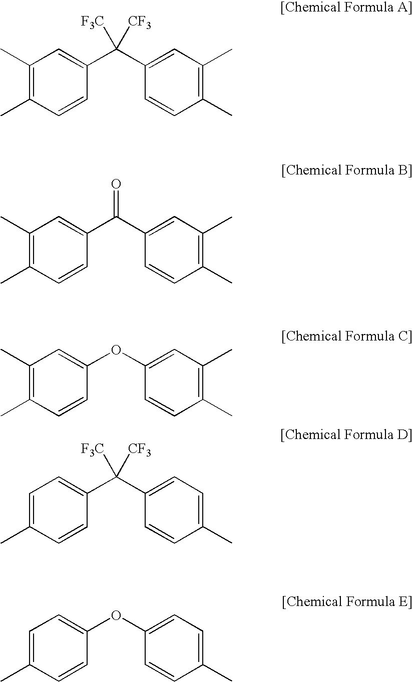

The polyimides represented by the above Chemical Formulae 1 to 4 are respectively thermally-rearranged into polybenzoxazole, polybenzthiazole, or polypyrrolone having high fractional free volume in accordance with a method that will be described below. For example, polybenzoxazole is derived from polyhydroxyimide where Y is OH in the Chemical Formulae 1 to 4, polybenzthiazole is derived from polythiolimide where Y is SH in the Chemical Formulae 1 to 4, and polypyrrolone is derived from polyaminoimide where Y is NH₂ in the Chemical Formulae 1 to 4.

The polyimide copolymers represented by the above Chemical Formulae 5 to 8 are respectively thermally-rearranged into a poly(benzoxazole-imide) copolymer, a poly(benzthiazole-imide) copolymer, or a poly(pyrrolone-imide) copolymer having high fractional free volume in accordance with a method that will be described below. It is possible to control physical properties of the prepared hollow fibers by controlling the copolymerization ratio (mole ratio) between blocks which will be thermally rearranged into polybenzoxazole, polybenzothiazole and polybenzopyrrolone through intramolecular and intermolecular conversion, and blocks which will be thermally rearranged into polyimides.

The polyimide copolymer represented by Chemical Formulae 9 to 18 are respectively thermally-rearranged to form hollow fibers made of copolymers of polybenzoxazole, polybenzothiazole and polybenzopyrrolone, each having a high fractional free volume in accordance with a method that will be described below. It is possible to control the physical properties of hollow fibers thus prepared may be controlled by controlling the copolymerization ratio (mole ratio) between blocks which are thermally rearranged into polybenzoxazole, polybenzothiazole and polybenzopyrrolone.

The copolymerization ratio (m:l) between the blocks of the polyimide copolymers represented by the above Chemical Formula 5 to 18 ranges from about 0.1:9.9 to about 9.9:0.1, and in one embodiment from about 2:8 to about 8:2, and in another embodiment, about 5:5. The copolymerization ratio affects the morphology of the hollow fibers thus prepared. Such morphologic change is associated with gas permeability and selectivity. When the copolymerization ratio between the blocks is within the above range, the prepared hollow fiber has excellent gas permeability and selectivity.

In the above hollow fiber, the polymer derived from polyimide may include a polymer represented by one of the following Chemical Formulae 19 to 32, or copolymers thereof, but is not limited thereto.

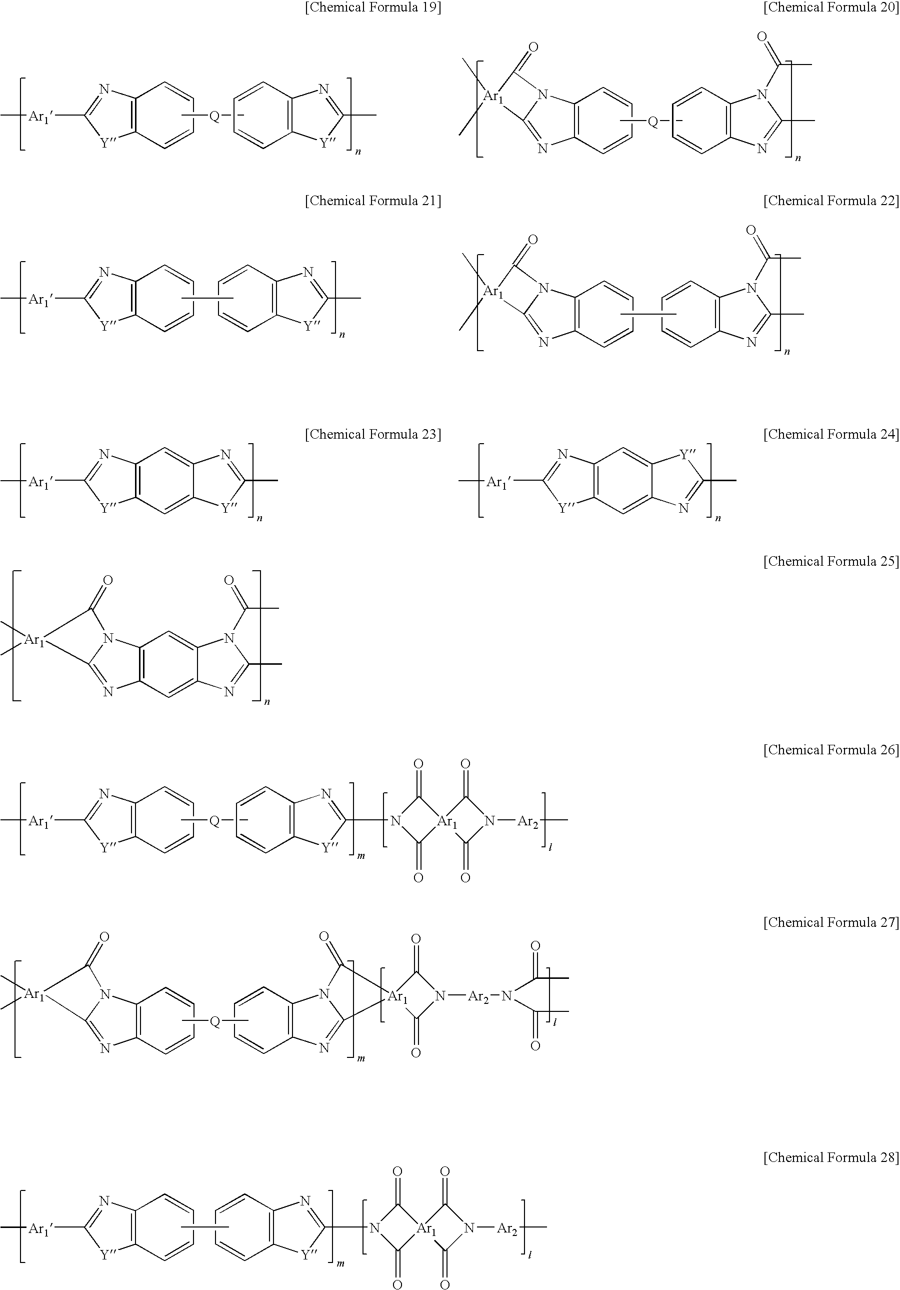

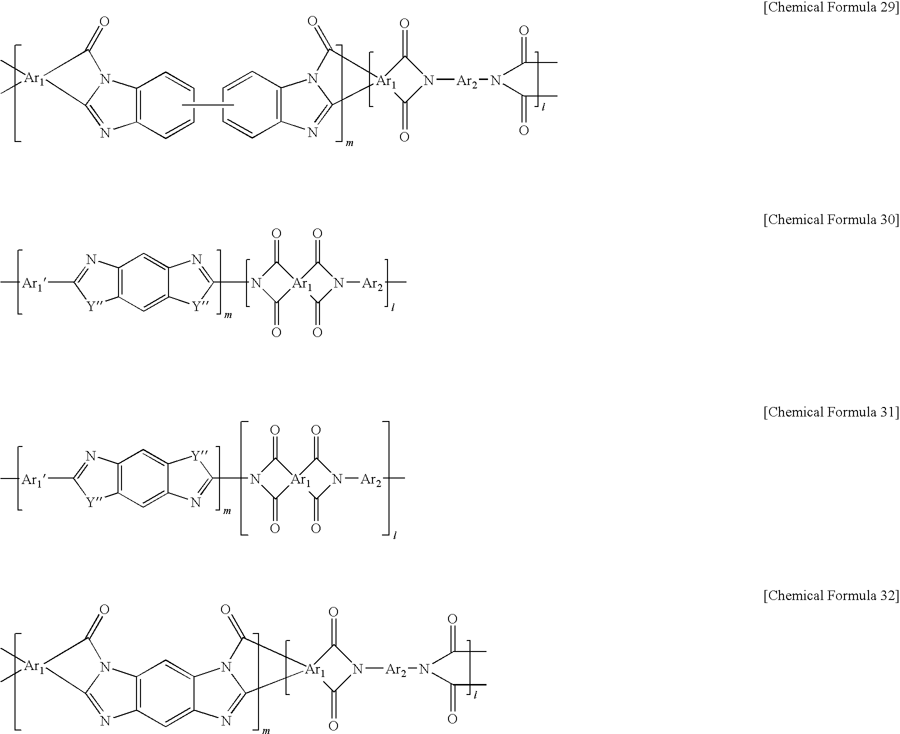

In the above Chemical Formulae 19 to 32,

Ar₁, Ar₂, Q, n, m, and l are the same as defined in the above Chemical Formulae 1 to 8,

Ar₁′ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH, and

Y″ is O or S.

In the above Chemical Formulae 19 to 32, examples of Ar₁, Ar₂, and Q are the same as in those of the above Chemical Formulae 1 to 18.

In the above Chemical Formulae 19 to 32, examples of Ar₁′ are the same as in those of the above Chemical Formulae 1 to 18.

In the above Chemical Formulae 19 to 32, Ar₁ may be a functional group represented by the following Chemical Formula A, B, or C, Ar₁′ may be a functional group represented by the following Chemical Formula F, G, or H, Ar₂ may be a functional group represented by the following Chemical Formula D or E, and Q may be C(CF₃)₂, but they are not limited thereto.

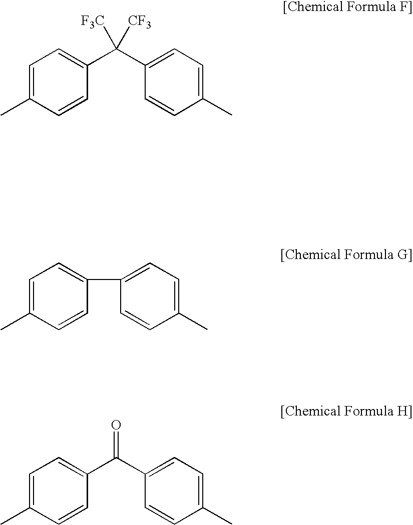

The hollow fiber may be applicable for separating at least one gases selected from the group consisting of He, H₂, N₂, CH₄, O₂, N₂, CO₂, and combinations thereof. The hollow fiber may be used as a gas separation membrane. Examples of the mixed gases include O₂/N₂, CO₂/CH₄, H₂/N₂, H₂/CH₄, CO₂/N₂, and He/N₂, but are not limited thereto.

The hollow fiber may have O₂/N₂ selectivity of 4 or more, for example 4 to 20, CO₂/CH₄ selectivity of 30 or more, for example 30 to 80, H₂/N₂ selectivity of 30 or more, for example 30 to 80, H₂/CH₄ selectivity of 50 or more, for example 50 to 90, CO₂/N₂ selectivity of 20 or more, for example 20 to 50, and He/N₂ selectivity of 40 or more, for example 40 to 120.

The dope solution composition for forming a hollow fiber according to another embodiment includes polyimide including a repeating unit obtained from aromatic diamine including at least one ortho-positioned functional group with respect to an amine group, an organic solvent, and an additive.

The organic solvent includes one selected from the group consisting of dimethylsulfoxide; N-methyl-2-pyrrolidone; N-methylpyrrolidone; N,N-dimethyl formamide; ketones selected from the group consisting of N,N-dimethyl acetamide; 7-butyrolactone, cyclohexanone, 3-hexanone, 3-heptanone, 3-octanone; and combinations thereof, but is not limited thereto. In one embodiment, for the organic solvent, dimethylsulfoxide; N-methyl-2-pyrrolidone; N,N-dimethyl formamide; N,N-dimethyl acetamide; or combinations thereof are preferable. The organic solvent can dissolve polymers, and is mixable with the additive to form a meta-stable state, and thereby hollow fiber having thin effective layer can be provided.

The additive includes one selected from the group consisting of water; alcohols selected from the group consisting of methanol, ethanol, 2-methyl-1-butanol, 2-methyl-2-butanol, glycerol, ethylene glycol, diethylene glycol, and propylene glycol; ketones selected from the group consisting of acetone and methyl ethyl ketone; polymer compounds selected from the group consisting of polyvinyl alcohol, polyacrylic acid, polyacryl amide, polyethylene glycol, polypropylene glycol, chitosan, chitin, dextran, and polyvinylpyrrolidone; salts selected from the group consisting of lithium chloride, sodium chloride, calcium chloride, lithium acetate, sodium sulfate, and sodium hydroxide; tetrahydrofuran; trichloroethane; and mixtures thereof, but is not limited thereto. In one embodiment, for the additive, water, glycerol, propyleneglycol, polyethyleneglycol, polyvinylpyrrolidone, and combination thereof may be preferable. The additive can make a meta-stable dope solution composition along with the organic solvent even though it has good solubility for polyamic acid polymers and thus it can not be used singularly. It can also help non-solvent in a coagulation bath be diffused into the dope solution composition to form a uniform thin layer and help macropores in a sublayer effectively.

In the dope solution composition for forming a hollow fiber, the ortho-positioned a functional group with respect to the amine group includes OH, SH, or NH₂.

The dope solution composition for forming a hollow fiber includes about 10 to about 45 wt % of the polyimide, about 25 to about 70 wt % of the organic solvent, and about 2 to about 30 wt % of the additive.

When the amount of the polyimide is within the above range, hollow fiber strength and gas permeability may be maintained excellently.

The organic solvent dissolves the polyimide. When the organic solvent is used in the above ranged amount, the dope solution composition for forming a hollow fiber has an appropriate viscosity and thus hollow fiber may be easily made while improving permeability of the hollow fiber.

The dope solution composition for forming a hollow fiber has a viscosity ranging from about 2 Pa·s to 200 Pa·s. When the dope solution composition for forming a hollow fiber is within the above range, the dope solution composition for forming a hollow fiber can be spun through nozzles, and hollow fiber is coagulated in to solid phase by a phase inversion.

The additive controls phase separation temperatures or viscosity of a dope solution composition for forming a hollow fiber.

When the additive is used in the above ranged amount, a hollow fiber can be made easily, and also surface pore sizes of a hollow fiber can be appropriately controlled to easily form a dense layer.

In the dope solution composition for forming a hollow fiber, the polyimide has a weight average molecular weight (Mw) of about 10,000 to about 200,000. When the polyimide has the above ranged weight average molecular weight, it can be synthesized easily, the dope solution composition for forming a hollow fiber including the same can be appropriately controlled resulting in processability, and the polymer derived from polyimide has good mechanical strength and performances.

In the dope solution composition for forming a hollow fiber, the polyimide may be selected from the group consisting of polyimide represented by the following Chemical Formulae 1 to 4, polyimide copolymers represented by the following Chemical Formulae 5 to 8, copolymers thereof, and blends thereof.

Another embodiment of the present invention, a method of preparing a hollow fiber is provided that includes spinning a dope solution composition for forming a hollow fiber to prepare a polyimide hollow fiber, and heat-treating the polyimide hollow fiber to obtain a hollow fiber including thermally rearranged polymer. The hollow fiber made according to the above method includes a hollow positioned at the center of the hollow fiber, macropores positioned at adjacent to the hollow, and mesopores and picopores positioned at adjacent to macropores, and the picopores are three dimensionally connected to each other to form a three dimensional network structure.

The thermally rearranged polymer may include polymers represented by one of the above Chemical Formulae 19 to 32 or copolymers thereof, but is not limited thereto.

For example, the polyimide hollow fiber may include polyimides represented by the above Chemical Formulae 1 to 8, copolymers thereof, and blends thereof.

The polyimide represented by one of the above Chemical Formulae 1 to 8 may be obtained from imidization of polyamic acid represented by one of the following Chemical Formulae 33 to 40.

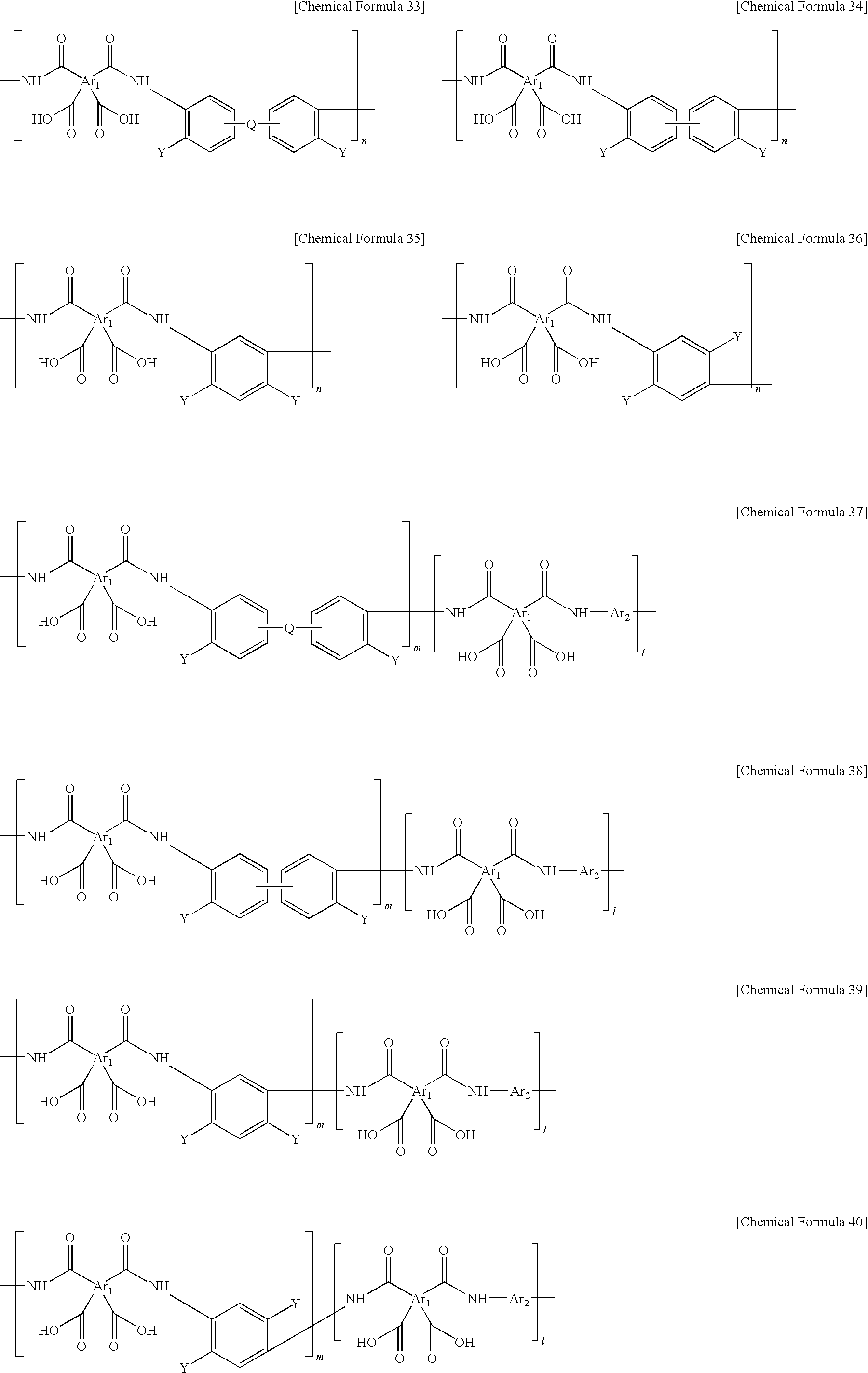

In the above Chemical Formulae 33 to 40,

Ar₁, Ar₂, Q, Y, n, m, and l are the same as in above Chemical Formulae 1 to 8.

Copolymers of the above polyamic acid represented by Chemical Formulae 33 to 36 include polyamic acid copolymers represented by the following Chemical Formulae 41 to 50.

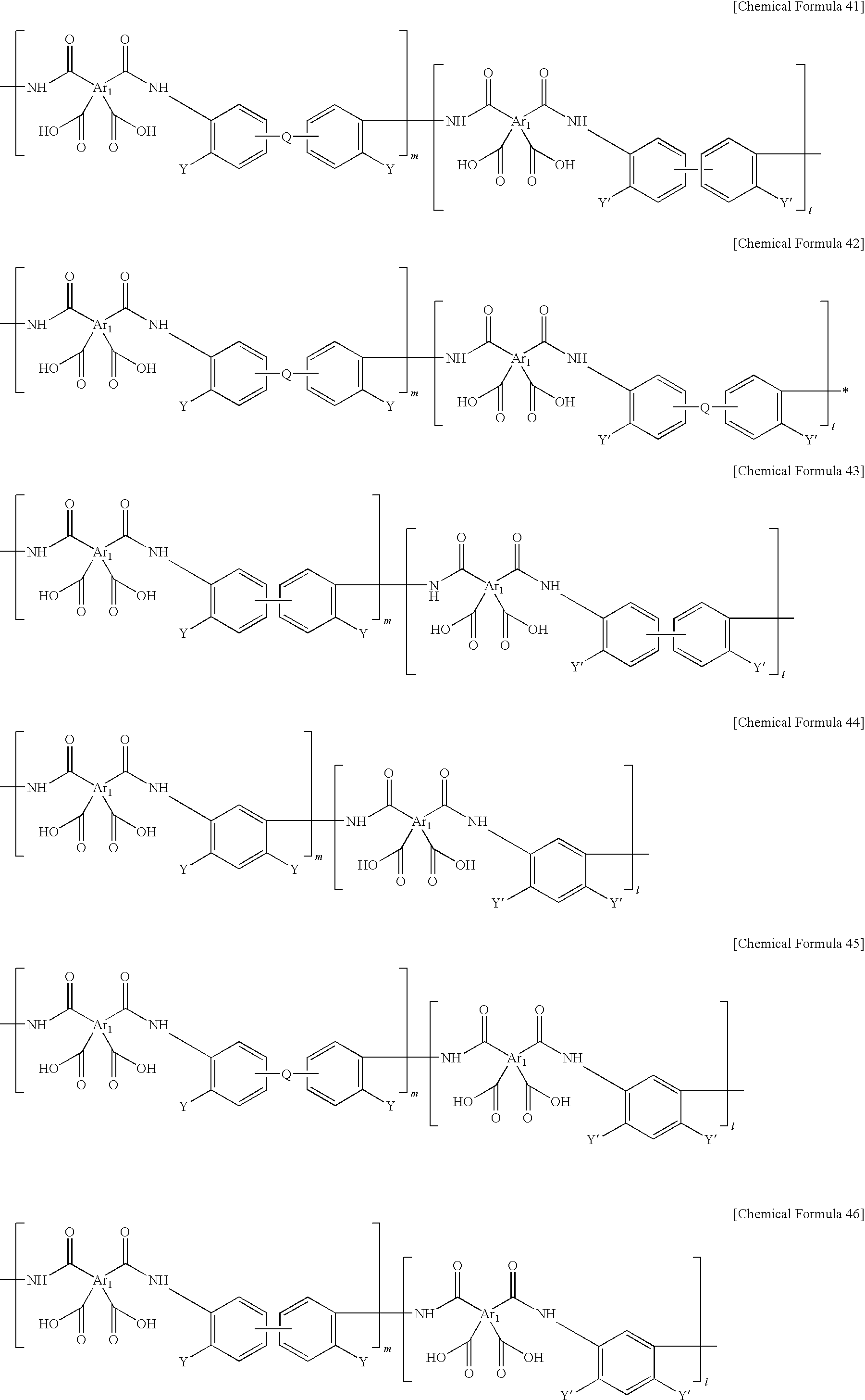

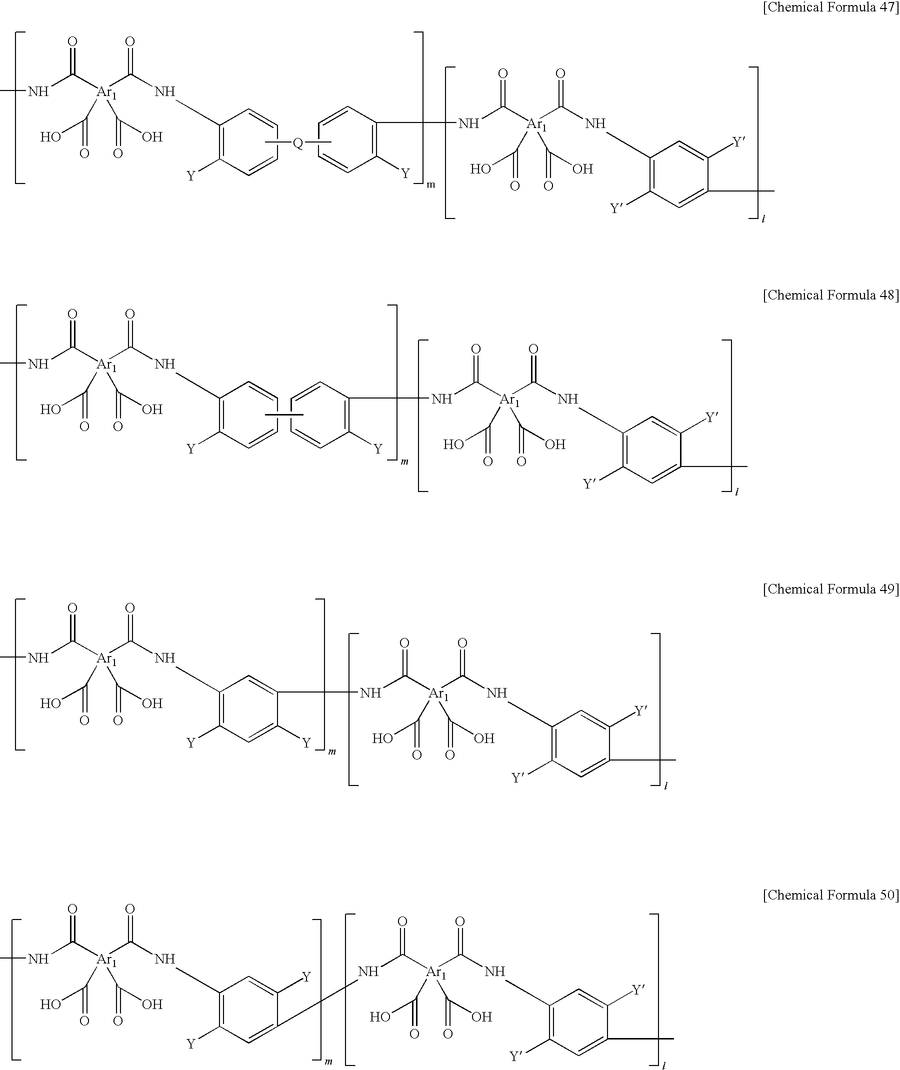

In the above Chemical Formulae 41 to 50, Ar₁, Q, Y, Y′, n, m and l are the same as in the above Chemical Formulae 1 to 18.

The imidization include chemical imidization and solution-thermal imidization, but is not limited thereto.

The chemical imidization is carried out at about 20 to about 180° C. for about 4 to about 24 hours. For a catalyst, pyridine and acetic anhydride to remove produced water may be used. When the chemical imidization is preformed at the above temperature, imidization of polyamic acid can be performed sufficiently.

The chemical imidization may be performed after protecting ortho-positioned functional groups, OH, SH, and NH₂ with respect to the amine group. That is, a protecting group for a functional group, OH, SH, and NH₂ is introduced, and the protecting group is removed after imidization. The protecting group may be introduced by chlorosilane such as trimethylchlorosilane ((CH₃)₃SiCl), triethylchlorosilane ((C₂H₅)₃SiCl), tributyl chlorosilane ((C₄H₉)₃SiCl), tribenzyl chlorosilane ((C₆H₅)₃SiCl), triethoxy chlorosilane ((OC₂H₅)₃SiCl), and the like, or hydrofuran such as tetrahydrofurane (THF). For the base, tertiary amines such as trimethyl amine, triethyl amine, tripropyl amine, pyridine, and the like may be used. For removing the protecting group, diluted hydrochloric acid, sulfuric acid, nitric acid, acetic acid, and the like may be used. The chemical imidization using the protecting group may improve yield and molecular weight of the polymer for forming a hollow according to one embodiment of the present invention.

The solution-thermal imidization may be performed at about 100 to about 180° C. for about 2 to about 30 hours in a solution. When the solution-thermal imidization is preformed within the above temperature range, polyamic acid imidization can be realized sufficiently.

The solution-thermal imidization may be performed after protecting ortho-positioned functional groups, OH, SH, and NH₂ with respect to the amine group. That is, a protecting group for a functional group, OH, SH, and NH₂ is introduced, and the protecting group is removed after imidization. The protecting group may be introduced by chlorosilane such as trimethylchlorosilane, triethylchlorosilane, tributyl chlorosilane, tribenzyl chlorosilane, triethoxy chlorosilan, and the like or hydrofuran such as tetrahydrofurane. For the base, tertiary amines such as trimethyl amine, triethyl amine, tripropyl amine, pyridine, and the like may be used. For removing the protecting group, diluted hydrochloric acid, sulfuric acid, nitric acid, acetic acid, and the like may be used. The solution-thermal imidization may be performed using an azeotropic mixture that further includes benzenes such as benzene, toluene, xylene, cresol, and the like; aliphatic organic solvents such as hexane; alicyclic organic solvents such as cyclohexane, and the like.

The chemical imidization using the protecting group and azeotropic mixture may also improve yield and molecular weight of the polymer for forming a hollow according to one embodiment of the present invention.

The imidization condition can be controlled in accordance with the functional groups, Ar₁, Ar₂, Q, Y, and Y′ of the polyamic acid.

The imidization reaction will be described in more detail referring to the following Reaction Schemes 1 and 2.

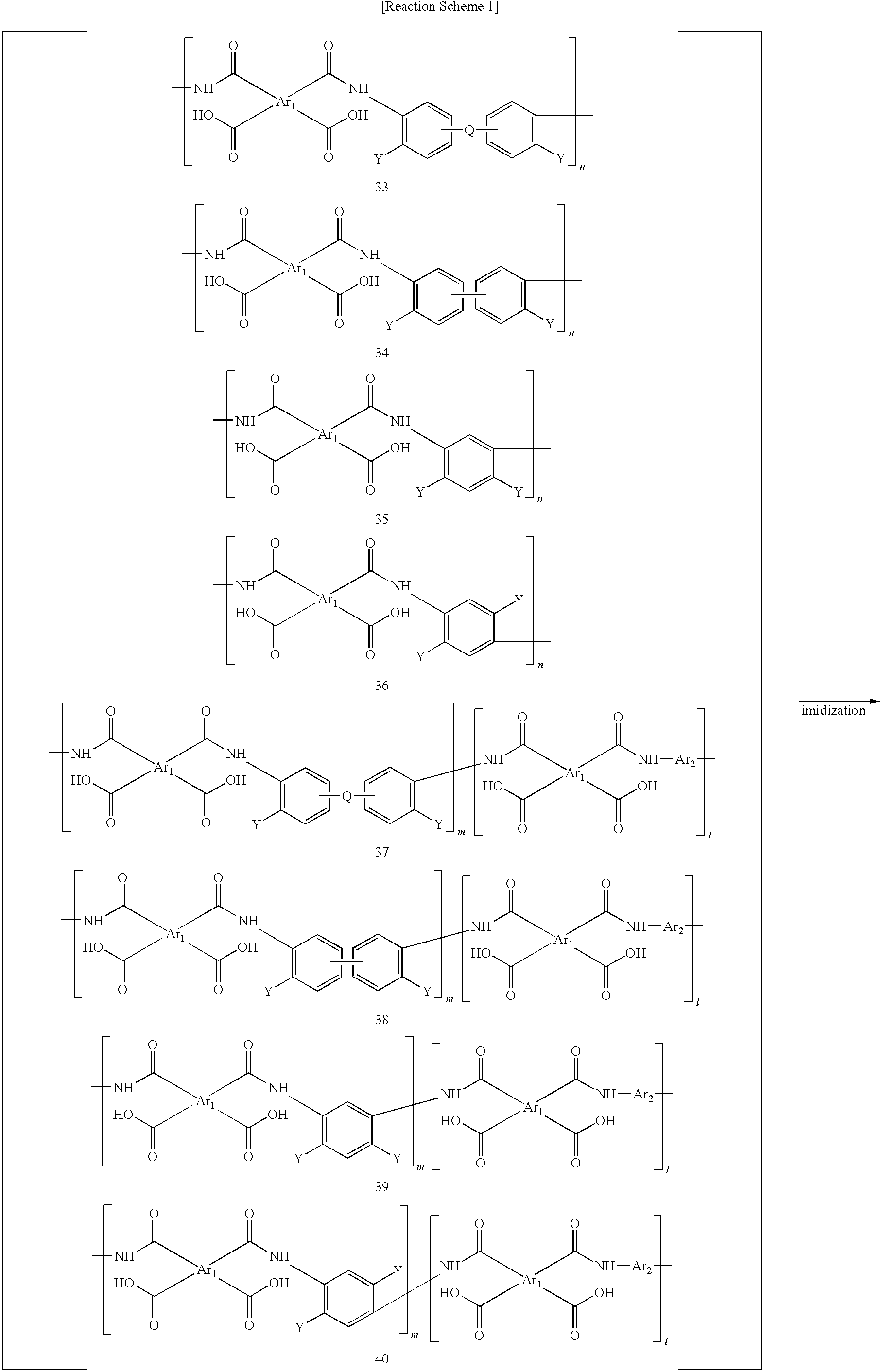

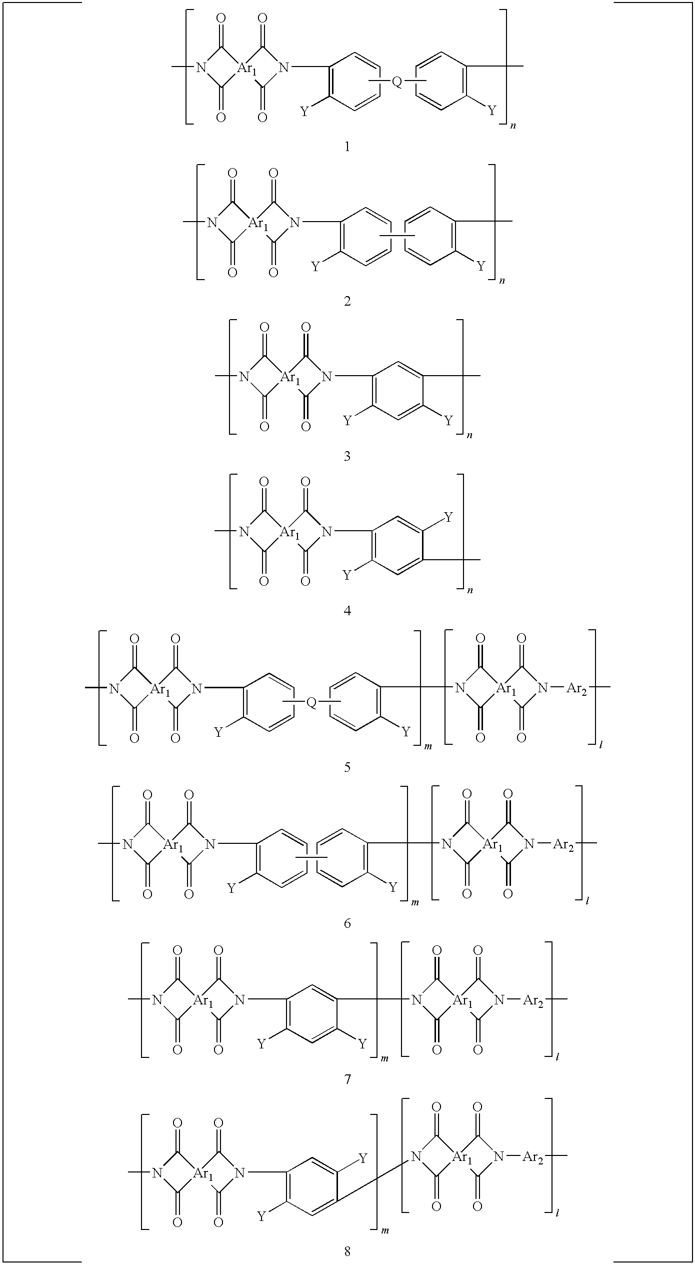

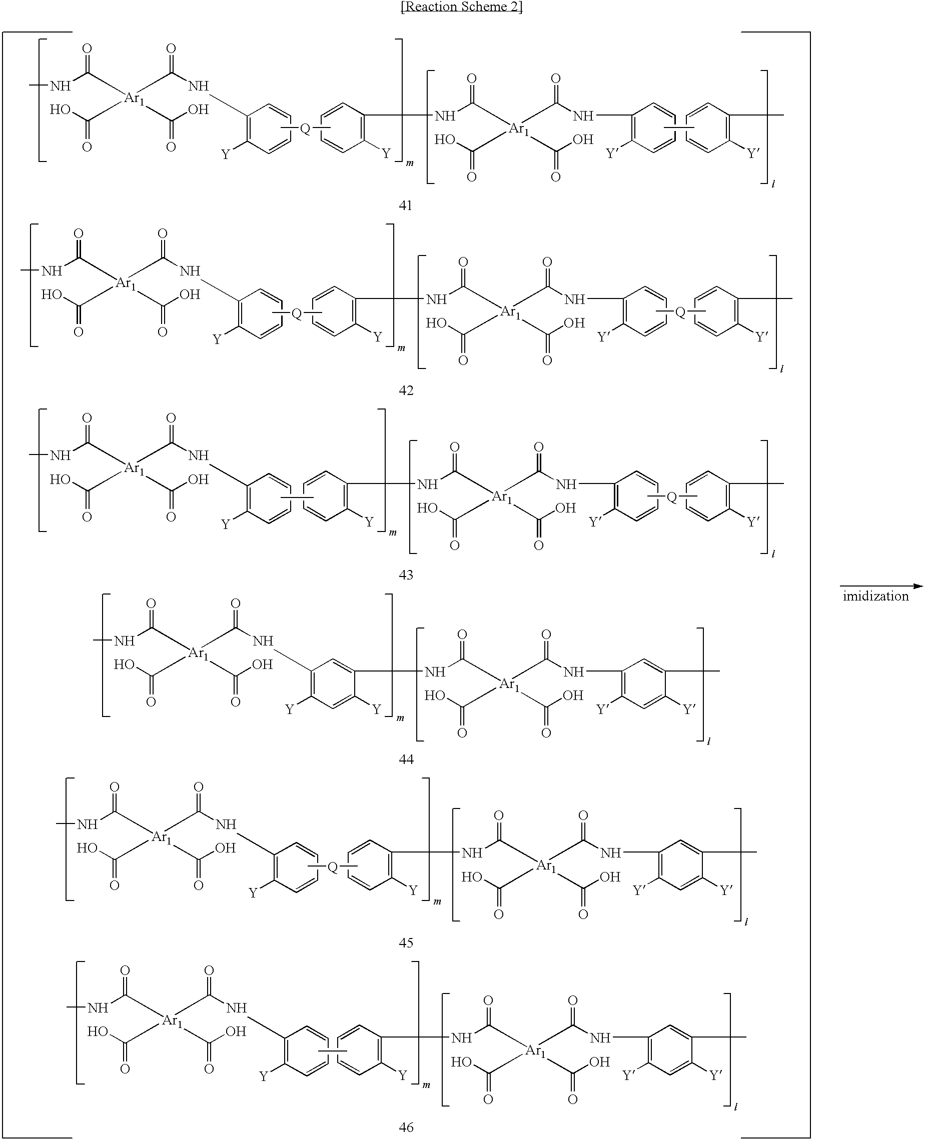

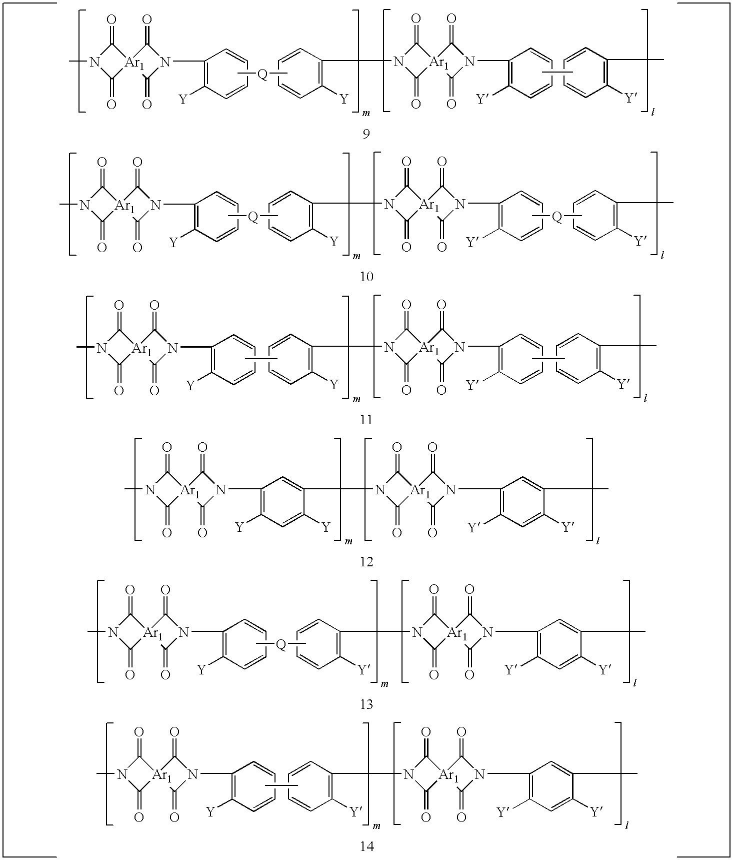

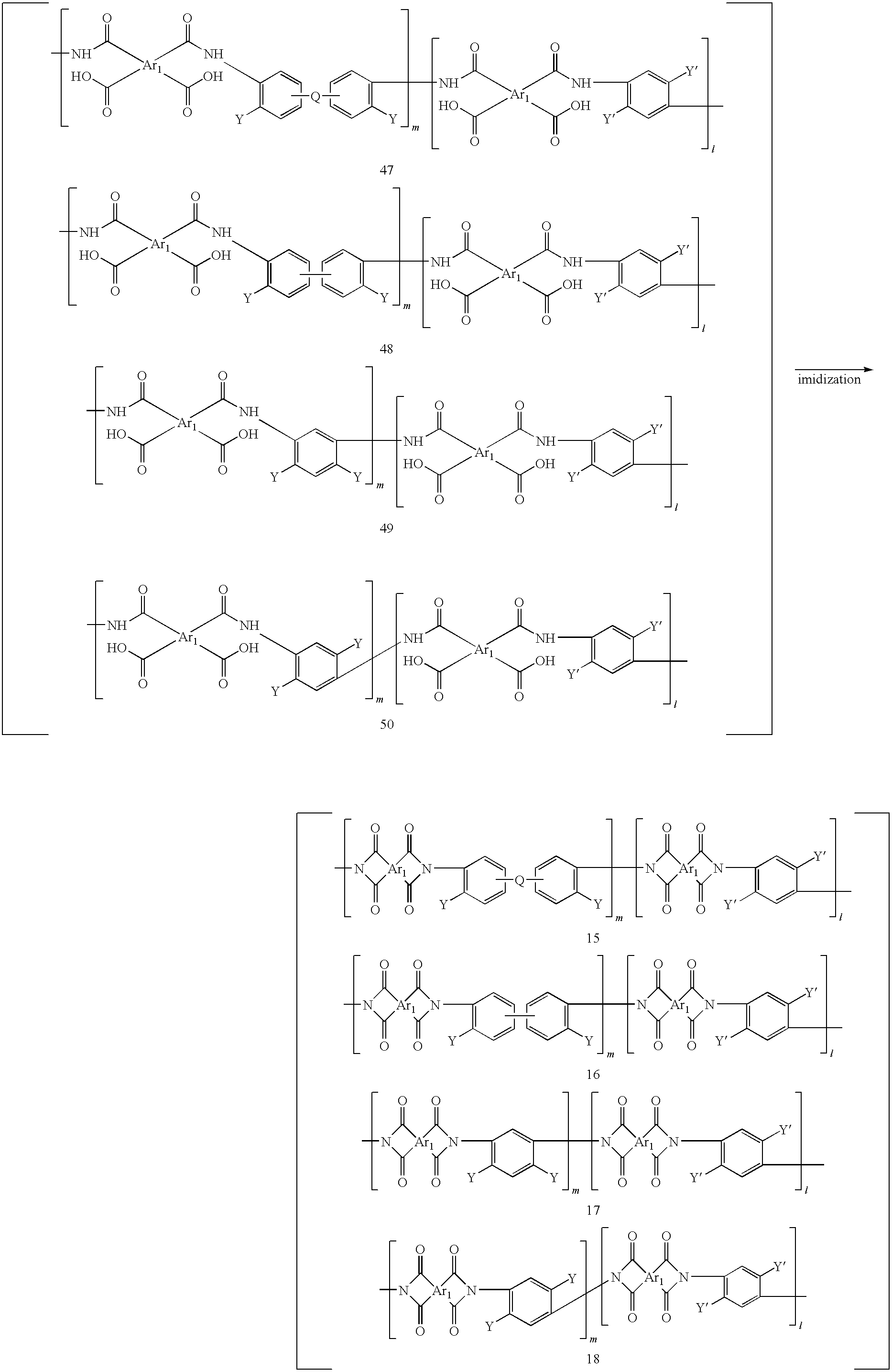

In the Reaction Schemes 1 and 2,

Ar₁, Ar₂, Q, Y, Y′, n, m, and l are the same as in the above Chemical Formulae 1 to 18.

As shown in the Reaction Scheme 1, polyamic acids (polyhydroxyamic acid, polythiolamic acid, or polyaminoamic acid) represented by the Chemical Formula 33, Chemical Formula 34, Chemical Formula 35 and Chemical Formula 36 are converted through imidization i.e., cyclization reaction into polyimides represented by Chemical Formula 1, Chemical Formula 2, Chemical Formula 3 and Chemical Formula 4, respectively.

In addition, polyamic acid copolymers represented by the Chemical Formula 37, Chemical Formula 38, Chemical Formula 39 and Chemical Formula 40 are converted through imidization into polyimide copolymers represented by Chemical Formula 5, Chemical Formula 6, Chemical Formula 7 and Chemical Formula 8, respectively.

As shown in the Reaction Scheme 2, polyamic acid copolymers represented by the Chemical Formulae 41 to 50 are converted through imidization into polyimide copolymers represented by Chemical Formulae 9 to 18.

The spinning process of the dope solution composition for forming a polyimide hollow fiber may be carried out in accordance with a generally-used method in the art and is not particularly limited. In the present invention, dry or dry-jet-wet spinning is used for the preparation of hollow fibers.

A solvent-exchange method using solution-spinning is generally used as the hollow fiber preparation method. In accordance with the solvent exchange method, after a dope solution composition for forming a hollow fiber is dissolved in a solvent and spun using a dry or dry-jet-wet spinning method, the solvent and the non-solvent are exchanged in the presence of the non-solvent to form picopores. In the process in which the solvent is diffused into a coagulation bath as the non-solvent, an asymmetric membrane or a symmetric membrane in which the interior is identical to the exterior was formed.

For example, in a case where dry-jet-wet spinning is used for the preparation of hollow fibers, the dry-jet-wet spinning is achieved through the steps of: a1) preparing a dope solution composition for forming a hollow fiber; a2) bringing the dope solution composition into contact with an internal coagulant, and spinning the composition in air, while coagulating an inside of hollow fiber to form a polyimide hollow fiber; a3) coagulating the hollow fiber in a coagulation bath; a4) washing the hollow fiber with a cleaning solution, followed by drying; and a5) heat-treating the polyimide hollow fiber to obtain a thermally rearranged polymer.

A flow rate of internal coagulant discharged through an inner nozzle ranges from 1 to 10 ml/min, and in one embodiment, 1 to 3 ml/min. In addition, a double nozzle has an outer diameter of 0.1 to 2.5 mm. The flow rate of the internal coagulant and the outer diameter of the double nozzle may be controlled within the range according to the use and conditions of hollow fibers.

In addition, the air gap between the nozzle and the coagulation bath ranges from 1 cm to 100 cm, and in one embodiment, 5 cm to 50 cm.

The phase-inversion is induced in a coagulation bath by passing the hollow fiber through a high-temperature spinning nozzle, while maintaining a spinning temperature of 5 to 120° C. and a spinning rate of 5 to 100 m/min. The spinning temperature and spinning rate may be varied within the range depending upon the use and operation conditions of hollow fibers.

When the spinning temperature is within the above range, the viscosity of the dope solution composition can be appropriately controlled, thus making it easy to perform rapid spinning, and solvent evaporation can be prevented, thus disadvantageously making it impossible to continuously prepare hollow fibers. In addition, when the spinning rate is within the above range, a flow rate is appropriately maintained, and the mechanical properties and chemical stability of hollow fibers thus produced are improved.

The temperature of the coagulation bath may range from about 0 to about 50° C. When the coagulation bath temperature is within the above range, the solvent volatilization in the coagulation bath may be prevented, thus advantageously making it possible to smoothly prepare hollow fibers.

As the external coagulant present in the coagulation bath, any type may be used so long as it does not dissolve polymeric materials and is compatible with the solvent and additive. Non-limiting examples of useful external coagulants include water, ethanol, methanol, and mixtures thereof. In one embodiment, water is preferred.

To remove the solvent, additive, and the coagulated solution that remain inside the coagulated hollow fibers and on the surface thereof, washing and drying processes may be performed. Water or hot-water may be used as the cleaning solution. The washing time is not particularly limited. In one embodiment, it is preferable that the washing is carried out for 1 to 24 hours.

After the washing, the drying is performed at a temperature ranging from 20 to 100° C. for 3 to 72 hours.

Subsequently, the polyimide hollow fiber is heat-treated to obtain hollow fibers including thermally rearranged polymers. The hollow fiber including the thermally rearranged polymer has a decreased density, an increased fractional free volume (FFV) and an increased interplanar distance (d-spacing) due to an increased picopore size and produced well-connected picopores, and thus exhibit improved gas permeability, as compared with polyimide hollow fibers. Thereby the hollow fiber including the rearranged polymer has excellent gas permeability and selectivity.

The heat treatment is performed by increasing a temperature up to 400 to 550° C., and in one embodiment 450 to 500° C., at a heating rate of 10 to 30° C./min and heat-treating for 1 minute to 1 hour, in one embodiment 10 minutes to 30 minutes at that temperature under an inert atmosphere. Within the above temperature range, thermal rearrangement may be sufficiently realized.

Hereinafter, the heat treatment will be illustrated in detail with reference to the following Reaction Schemes 1 and 2.

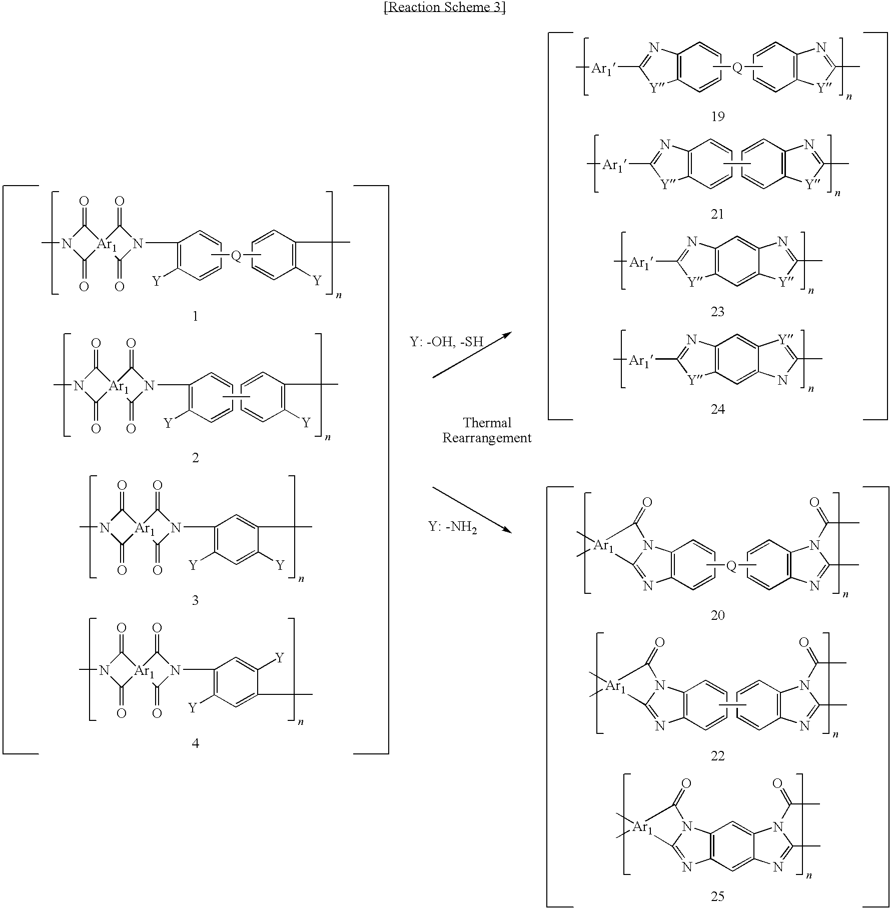

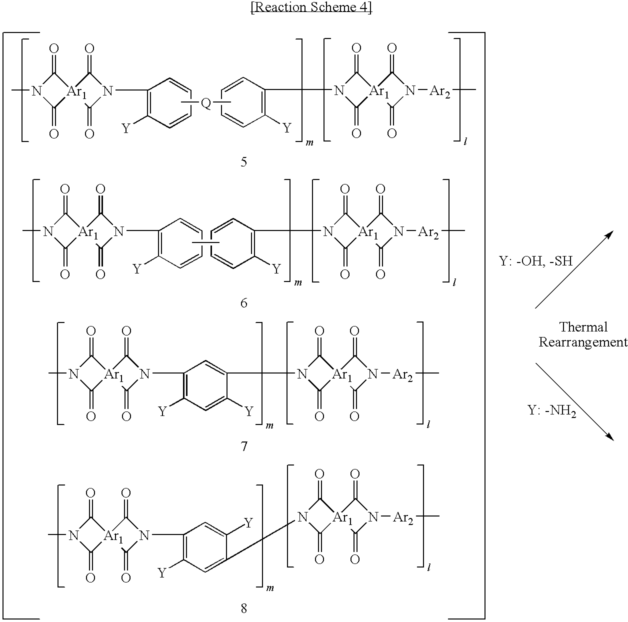

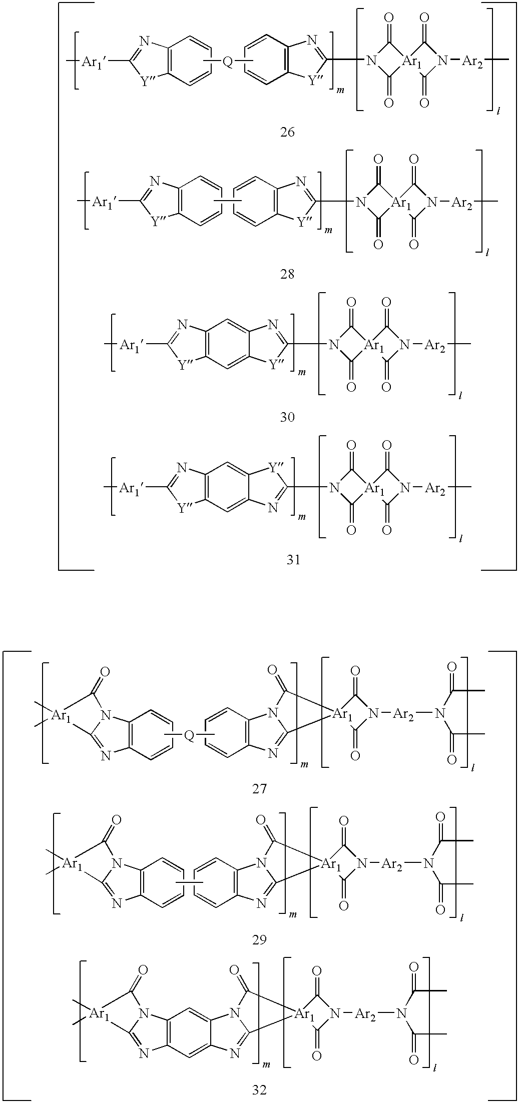

In the Reaction Schemes 3 and 4, Ar₁, Ar₁′, Ar₂, Q, Y, Y″, n, m, and l are the same as defined in the above Chemical Formulae 1 to 50.

Referring to the Reaction Scheme 3, the polyimide hollow fibers including the polyimides represented by the above Chemical Formulae 1 to 4 are converted through thermal treatment into hollow fibers made of polybenzoxazole, polybenzethiazole, or polybenzopyrrolone polymer represented by Chemical Formulae 19 to 25. The conversion of polyimide hollow fibers into the polymers is carried out through the removal reaction of CO₂ present in the polymers of Chemical Formulae 1 to 4.

The polyimides of Chemical Formulae 1 to 4 in which Y is —OH or —SH are thermally rearranged into polybenzoxazoles (Y″═O) or polybenzothiazoles (Y″═S) of Chemical Formula 19, Chemical Formula 21, Chemical Formula 23 and Chemical Formula 24. In addition, polyimides of Chemical Formulae 1 to 4 in which Y is —NH₂ are thermally rearranged into polypyrrolones of Chemical Formulae 20, 22, and 25.

As shown in Reaction Scheme 4, through the aforementioned heat treatment, hollow fibers made of polyimide copolymers of Chemical Formulae 5 to 8 are converted through the removal reaction of CO₂ present in the polyimides into polymers of Chemical Formulae 26 to 32.

Polyhydroxyimides or polythiolimide of Chemical Formulae 5 to 8 in which Y is —OH or —SH are thermally rearranged into benzoxazole (Y″═O)-imide copolymers or benzothiazole (Y″═S)-imide copolymers of Chemical Formulae 26, 28, 30 and 31. In addition, polyaminoimide (Y═NH₂) represented by the above Chemical Formulae 5 to 8 are converted through imidization into poly(pyrrolone-imide) copolymers represented by Chemical Formula 27, 29, and 32, respectively.

The blocks constituting the polyimide hollow fibers made of polyimide copolymers represented by Chemical Formulae 9 to 18 are thermally rearranged into polybenzoxazole, polybenzothiazole and polypyrrolone, depending upon the type of Y to form hollow fibers made of copolymers thereof, i.e., copolymers of polymers represented by Chemical Formulae 19 to 25.

By controlling the preparation process, the hollow fibers are prepared in the form of a macrovoid-formed finger or a sponge that has a macrovoid-free selective layer and thus exhibits stable membrane performance. Alternatively, the hollow fibers may be prepared in a symmetric or asymmetric form by controlling the preparation process. Furthermore, by controlling polymer design while taking into consideration the characteristics of Ar₁, Ar₁′, Ar₂, and Q present in the chemical structure, permeability and selectivity for various gas types can be controlled.

The hollow fiber includes the polymers represented by the above Chemical Formulae 19 to 32 or copolymers thereof.

The hollow fibers of the present invention can endure not only mild conditions, but also stringent condition such as long operation time, acidic conditions and high humidity, due to rigid backbones present in the polymers. The hollow fiber according to the embodiment has chemical stability and mechanical properties.

The polymers represented by Chemical Formulae 19 to 32 or copolymers thereof are designed to have a desired weight average molecular weight, and in one embodiment, a weight average molecular weight of 10,000 to 200,000. When the molecular weight is less than 10,000, the physical properties of the polymers are poor, and when the molecular weight exceeds 200,000, the viscosity of the dope solution composition is greatly increased, thus making it difficult to spin the dope solution composition using a pump.

The hollow fiber according to one embodiment of the present invention includes a hollow positioned at the center of the hollow fiber, macropores positioned at adjacent to the hollow, and mesopores and picopores positioned at adjacent to macropores, and the picopores are three dimensionally connected to each other to form a three dimensional network structure. By this structure, the hollow fiber has high fractional free volume and thus realizes excellent gas selectivity and gas permeability. For example, the hollow fiber has good permeability and selectivity for at least one gases selected from the group consisting of He, H₂, N₂, CH₄, O₂, N₂, CO₂, and combinations thereof.

### EXAMPLES

Hereinafter, preferred examples will be provided for a further understanding of the invention. These examples are for illustrative purposes only and are not intended to limit the scope of the present invention.

### Example 1

As shown in Reaction Scheme 5, a hollow fiber including polybenzoxazole represented by Chemical Formula 51 is prepared from the polyhydroxyimide-containing dope solution composition for forming a hollow fiber.

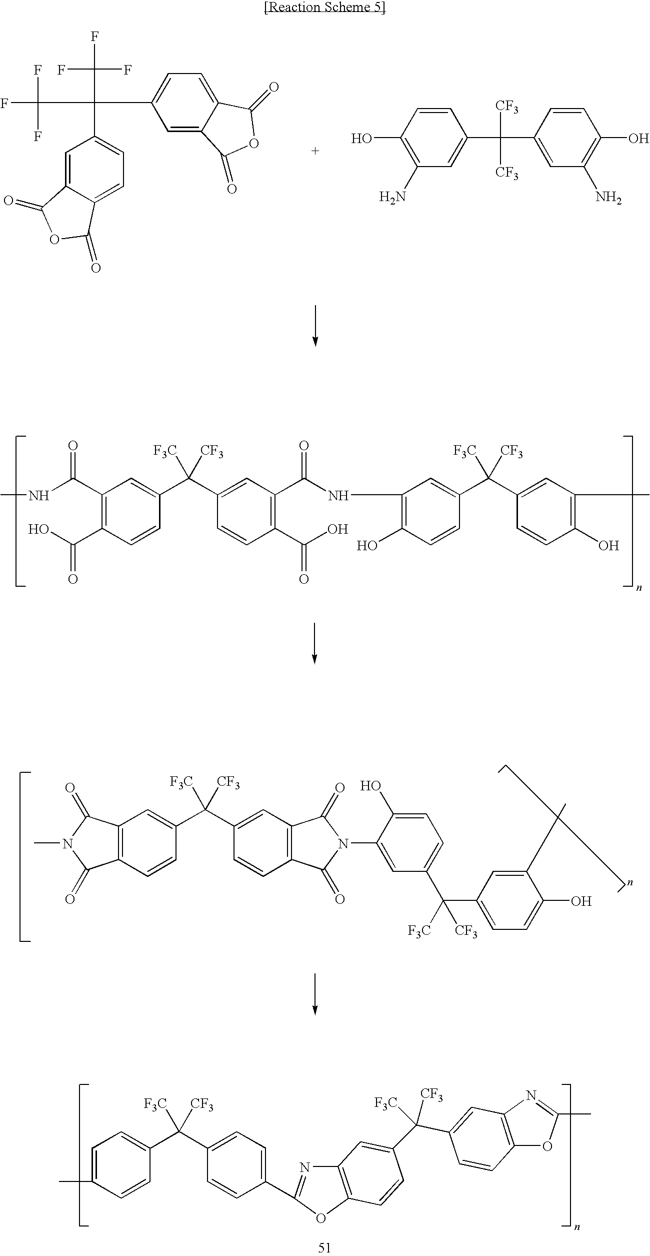

(1) Preparation of Polyhydroxyimide

36.6 g (0.1 mol) of 2,2-bis(3-amino-4-hydroxyphenyl)hexafluoropropane was a 1000 ml nitrogen-purged reactor and N-methylpyrrolidone (NMP) solvent was added. The reactor was placed in an oil bath to constantly maintain the reaction temperature at −15° C. 44.4 g (0.1 mol) of 4,4′-(hexafluoroisopropylidene)diphthalic anhydride was injected to the resulting solution slowly. Then, the solution was allowed to react for about 4 hours to prepare a pale yellow viscous polyhydroxyamic acid solution.

300 ml of toluene was added to the polyhydroxyamic acid solution. While the temperature of the reactor was increasing up to 150° C., polyhydroxyimide was obtained by performing reaction for 12 hours through thermally solution imidization using azeotropic mixture.

(2) Preparation of a Dope Solution Composition for Forming a Hollow Fiber

The resulting polyimide was added to 243 g (75 wt %) of NMP and then and 10 wt % of ethanol as an additive was added to prepare a homogeneous dope solution composition for forming a hollow fiber.

(3) Preparation of Hollow Fiber

The dope solution composition for forming a hollow fiber was defoamed at ambient temperature under reduced pressure for 24 hours, and foreign materials were removed using a glass filter (pore diameter: 60 μm). Subsequently, the resulting solution was allowed to stand at 25° C. and was then spun through a double-ring nozzle. Distilled water was used as an internal coagulating solution and an air gap was set at 50 cm. The spun hollow fiber was coagulated in a coagulation bath including water at 25° C. and was then wound at a rate of 20 m/min. The resulting hollow fiber was washed, air-dried at ambient temperature for 3 days. Then the dried hollow fiber was heat-treated under an inert atmosphere at 500° C. for 10 minutes at a heating rate of 15° C./min using heating furnace to prepare a hollow fiber thermally rearranged into polybenzoxazole represented by Chemical Formula 51.

The hollow fiber thus prepared had a weight average molecular weight of 48,960. As a result of FT-IR analysis, characteristic bands of polybenzoxazole at 1620 cm⁻¹ (C═N), and 1058 cm⁻¹ (C—N). The hollow fiber has a fractional free volume of 0.33, and interplanar distance (d-spacing) of 720 pm. The interplanar distance (d-spacing) was measured by X-ray diffraction (XRD, CuKα ray, 10 to 40 degrees at 0.05 degree intervals, a film sample)

### Example 2

A hollow fiber including polybenzoxazole was prepared in the same manner as in Example 1, except that polyimide was prepared by reacting 2,2-bis(3-amino-4-hydroxyphenyl)hexafluoropropane and 4,4′-(hexafluoroisopropylidene)diphthalic anhydride in a solution without toluene at 180° C. for 24 hours.

The hollow fiber had a weight average molecular weight of 9,240 and was identified to have a band of 1620 cm⁻¹ (C═N), 1058 cm⁻¹ (C—N), a polybenzoxazole characteristic band, which polyimide did not have, as a result of FT-IR analysis. In addition, the hollow fiber had a fractional free volume of 0.34 and interplanar distance (d-spacing) of 680 pm. The interplanar distance (d-spacing) was measured by X-ray diffraction (XRD, CuKα ray, 10 to 40 degrees at 0.05 degree intervals, a film sample)

### Example 3

A hollow fiber including polybenzthiazole represented by the following Chemical Formula 52 was prepared through the following reaction.

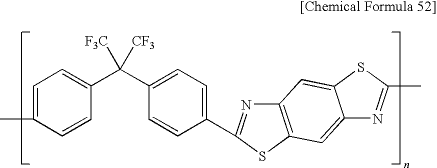

The hollow fiber including polybenzthiazole represented by the above Chemical Formula 52 was prepared according to the same method as Example 1 except for preparing polyimide having a thiol group (—SH) by reacting 20.8 g (0.1 mol) of 2,5-diamino-1,4-benzenedithiol dihydrochloride as starting materials with 44.4 g (0.1 mol) of 4,4′-(hexafluoroisopropylidene)diphthalic anhydride.

The hollow fiber had a weight average molecular weight of 32,290 and was identified to have a polybenzthiazole characteristic band of 1484 cm⁻¹ (C—S), 1404 cm⁻¹ (C—S), which does not exist in polyimide, as a result of FT-IR analysis. In addition, it had a fractional free volume of 0.28, interplanar distance (d-spacing) of 640 pm. The interplanar distance (d-spacing) was measured by X-ray diffraction (XRD, CuKα ray, 10 to 40 degrees at 0.05 degree intervals, a film sample)

### Example 4

A hollow fiber including polypyrrolone represented by the following Chemical Formula 53 was prepared through the following reaction.

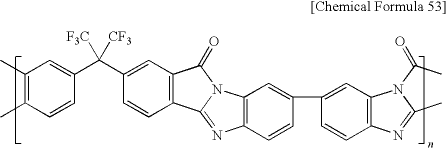

The hollow fiber including polypyrrolone represented by the above Chemical Formula 53 was prepared according to the same method as Example 1 except for preparing polyimide having an amine group (—NH₂) by reacting 21.4 g (0.1 mol) of 3,3′-diaminobenzidine as a starting materials with 44.4 g (0.1 mol) of 4,4′-(hexafluoroisopropylidene)diphthalic anhydride.

The hollow fiber had a weight average molecular weight of 37,740 and was identified to have a polypyrrolone characteristic band of 1758 cm⁻¹ (C═O), 1625 cm⁻¹ (C═N), which does not exist in polyimide, as a result of FT-IR analysis. In addition, the hollow fiber had a fractional free volume of 0.25 and interplanar distance (d-spacing) of 650 pm. The interplanar distance (d-spacing) was measured by X-ray diffraction (XRD, CuKα ray, 10 to 40 degrees at 0.05 degree intervals, a film sample)

### Example 5

A hollow fiber including polybenzoxazole represented by the following Chemical Formula 54 was prepared through the following reaction.

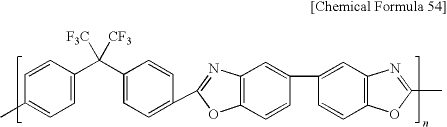

The hollow fiber including polybenzoxazole represented by the above Chemical Formula 54 was prepared according to the same method as Example 1 except for preparing polyimide by reacting 21.6 g (0.1 mol) of 3,3′-dihydroxyaminobenzidine as starting materials with 44.4 g (0.1 mol) of 4,4′-(hexafluoroisopropylidene)diphthalic anhydride.

The hollow fiber had a weight average molecular weight of 21,160 and was identified to have a polybenzoxazole characteristic band of 1595 cm⁻¹ (C═N), 1052 cm⁻¹ (C═O), which does not exist in polyimide as a result of FT-IR analysis. The hollow fiber had fractional free volume of 0.21 and interplanar distance (d-spacing) of 610 pm. The interplanar distance (d-spacing) was measured by X-ray diffraction (XRD, CUKα ray, 10 to 40 degrees at 0.05 degree intervals, a film sample)

### Example 6

A hollow fiber including polypyrrolone represented by the following Chemical Formula 55 was prepared through the reaction.

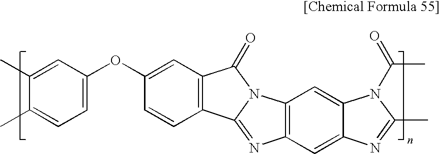

The hollow fiber including polypyrrolone represented by the above Chemical Formula 55 was prepared according to the same method as Example 1 except for preparing polyimide powder by reacting 28.4 g (0.1 mol) of benzene-1,2,4,5-tetraamine tetrahydrochloride as starting materials with 31.0 g (0.1 mol) of oxydiphthalic anhydride.

It had a weight average molecular weight of 33,120 and a polypyrrolone characteristic band of 1758 cm⁻¹ (C═O), 1625 cm⁻¹ (C═N) which were not detected in polyimide as a result of FT-IR analysis. It had a fractional free volume of 0.27 and interplanar distance (d-spacing) of 650 pm. The interplanar distance (d-spacing) was measured by X-ray diffraction (XRD, CuKα ray, 10 to 40 degrees at 0.05 degree intervals, a film sample)

### Example 7

A hollow fiber including a poly(benzoxazole-benzoxazole) copolymer represented by the following Chemical Formula 56 was prepared through the following reaction.

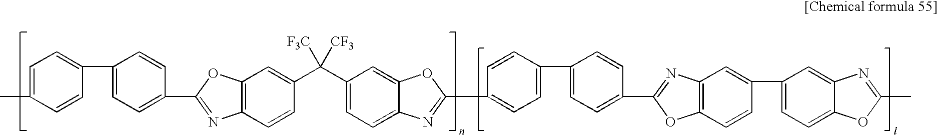

The hollow fiber including a poly(benzoxazole-benzoxazole) copolymer including m:l in a mole ratio of 5:5 represented by the above Chemical Formula 56 was prepared according to the same method as Example 1 except for preparing polyimide powder by reacting 36.6 g (0.1 mol) of 2,2-bis(3-amino-4-hydroxyphenyl)hexafluoropropane as starting materials and 21.6 g (0.1 mol) of 3,3′-dihydroxybenzidine with 58.8 g (0.2 mol) of 4,4′-biphthalic anhydride.

It had a weight average molecular weight of 24,860 and a polybenzoxazole characteristic band of 1620 cm⁻¹ (C═N), 1058 cm⁻¹ (C—N) which were not detected in polyimide as a result of FT-IR analysis. It had fractional free volume of 0.24 and interplanar distance (d-spacing) of 550 pm. The interplanar distance (d-spacing) was measured by X-ray diffraction (XRD, CuKα ray, 10 to 40 degrees at 0.05 degree intervals, a film sample)

### Example 8

A hollow fiber including a poly(benzoxazole-imide) copolymer represented by the following Chemical Formula 57 was prepared through the following reaction.

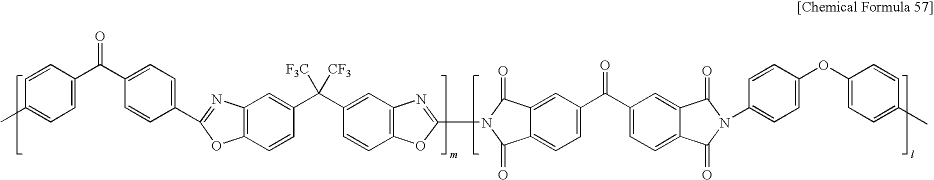

The hollow fiber including a poly(benzoxazole-imide) copolymer (the mole ratio of m:l is 8:2) represented by the above Chemical Formula 57 was prepared according to the same method as Example 1 except for preparing polyimide by reacting 58.60 g (0.16 mol) of 2,2-bis(3-amino-4-hydroxyphenyl)hexafluoropropane and 8.01 g (0.04 mol) of 4,4′-diaminodiphenylether as starting materials with 64.45 g (20 mol) of 3,3,4,4′-benzophenonetetracarboxylic dianhydride.

The hollow fiber had a weight average molecular weight of 35,470 and was identified to have a polybenzoxazole characteristic band of 1620 cm⁻¹ (C═N), 1058 cm⁻¹ (C—N) and a polyimide characteristic band of 1720 cm⁻¹ (C═O), 1580 cm⁻¹ (C═O) from the result of FT-IR analysis which were not detected in polyimide. In addition, it had a fractional free volume of 0.22 and interplanar distance (d-spacing) of 620 pm. The interplanar distance (d-spacing) was measured by X-ray diffraction (XRD, CuKα ray, 10 to 40 degrees at 0.05 degree intervals, a film sample)

### Example 9

A hollow fiber including a poly(pyrrolone-imide) copolymer represented by the following Chemical Formula 58 was prepared through the following reaction.

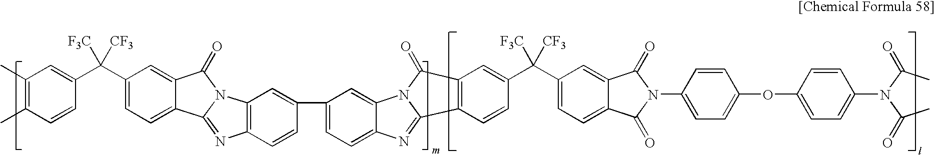

The hollow fiber poly including a (pyrrolone-imide) copolymer (the mole ratio of m:l is 8:2) represented by the above Chemical Formula 58 was prepared according to the same method as Example 1 except for preparing polyimide by reacting 17.1 g (0.08 mol) of 3,3′-diaminobenzidine and 4.0 g (0.02 mol) of 4,4′-diaminodiphenylether as starting materials with 44.4 g (0.1 mol) of 4,4′-(hexafluoroisopropylidene)diphthalic anhydride.

The hollow fiber had a weight average molecular weight of 52,380 and a polypyrrolone characteristic band of 1758 cm⁻¹ (C═O), 1625 cm⁻¹ (C═N) and a polyimide characteristic band of 1720 cm⁻¹ (C═O), 1580 cm⁻¹ (C═O) from the result of FT-IR analysis which were not detected in polyimide. In addition, the hollow fiber had a fractional free volume of 0.23 and interplanar distance (d-spacing) of 630 pm. The interplanar distance (d-spacing) was measured by X-ray diffraction (XRD, CuKα ray, 10 to 40 degrees at 0.05 degree intervals, a film sample)

### Example 10

A hollow fiber including a poly(benzthiazole-imide) copolymer represented by the following Chemical Formula 59 was prepared through the following reaction.

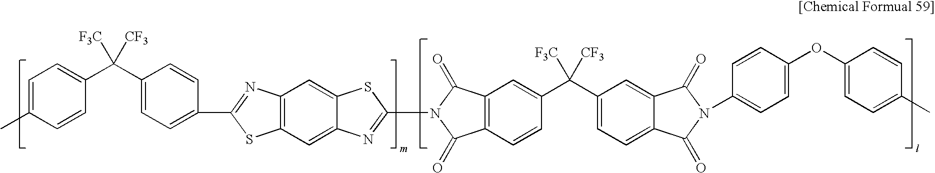

The hollow fiber including a poly(benzthiazole-imide) copolymer (the mole ratio of m:l is 8:2) represented by the above Chemical Formula 59 was prepared according to the same method as Example 1 except for preparing a polyimide-based copolymer by reacting 33.30 g (0.16 mol) of 2,5-diamino-1,4-benzenedithiol dihydrochloride and 8.0 g (0.04 mol) of 4,4′-diamino diphenylether as starting materials with 88.8 g (0.1 mol) of 4,4′-(hexafluoroisopropylidene)diphthalic anhydride.

It had a weight average molecular weight of 18,790 and a polybenzthiazole characteristic band of 1484 cm⁻¹ (C—S), 1404 cm⁻¹ (C—S) and a polyimide characteristic band of 1720 cm⁻¹ (C═O), 1580 cm⁻¹ (C═O) from the result of FT-IR analysis which were not detected in polyimide. In addition, the hollow fiber had a fractional free volume of 0.22 and interplanar distance (d-spacing) of 640 pm. The interplanar distance (d-spacing) was measured by X-ray diffraction (XRD, CuKα ray, 10 to 40 degrees at 0.05 degree intervals, a film sample)

### Example 11

A hollow fiber including a poly(benzoxazole-benzthiazole) copolymer represented by the following Chemical Formula 60 was prepared through the following reaction.

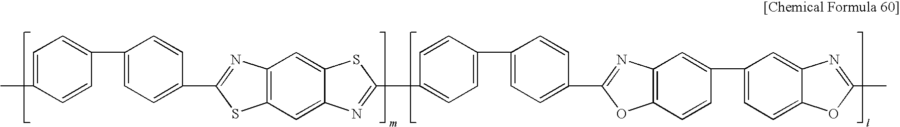

The hollow fiber including a poly(benzoxazole-benzthiazole) copolymer (the mole ratio of m:l is 5:5) represented by the above Chemical Formula 60 was prepared according to the same method as Example 1 except for preparing a polyimide-based copolymer by reacting 10.8 g (0.05 mol) of 3,3′-dihydroxybenzidine and 10.9 g (0.05 mol) of 2,5-diamino-1,4-benzenedithiol dihydrochloride as starting materials with 44.4 g (10 mmol) of 4,4′-(hexafluoroisopropylidene)diphthalic anhydride.

It had a weight average molecular weight of 13,750 and a polybenzoxazole characteristic band of 1595 cm⁻¹ (C═N), 1052 cm⁻¹ (C—N) and a polybenzthiazole characteristic band of 1484 cm⁻¹ (C—S), 1404 cm⁻¹ (C—S) from the result of FT-IR analysis which were not detected in polyimide. In addition, it had a fractional free volume of 0.16 and interplanar distance (d-spacing) of 580 pm. The interplanar distance (d-spacing) was measured by X-ray diffraction (XRD, CuKα ray, 10 to 40 degrees at 0.05 degree intervals, a film sample)

### Example 12

A hollow fiber including a poly(pyrrolone-pyrrolone) copolymer according to the following Chemical Formula 61 was prepared through the following reaction.

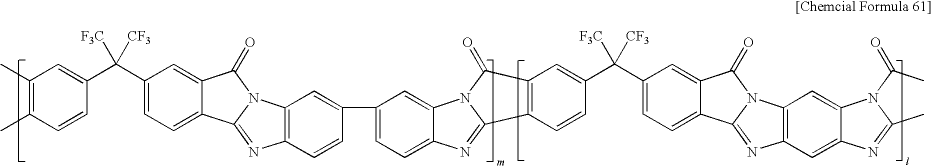

The hollow fiber including a poly(pyrrolone-pyrrolone) copolymer (the mole ratio of m:l is 8:2) represented by the above Chemical Formula 61 was prepared according to the same method as Example 1 except for preparing 34.2 g (0.16 mol) of 3,3′-diaminobenzidine and 11.4 g (0.04 mol) of benzene-1,2,4,5-tetraamine tetrahydrochloride a starting material with 88.8 g (20 mmol) of 4,4′-(hexafluoroisopropylidene)diphthalic anhydride.

The hollow fiber had a weight average molecular weight of 64,820 and a polypyrrolone characteristic band of 1758 cm⁻¹ (C═O), 1625 cm⁻¹ (C═N) from the result of FT-IR analysis which were not detected in polyimide. In addition, it had a fractional free volume of 0.23 and interplanar distance (d-spacing) of 590 pm. The interplanar distance (d-spacing) was measured by X-ray diffraction (XRD, CuKα ray, 10 to 40 degrees at 0.05 degree intervals, a film sample)

### Example 13

A hollow fiber including a poly(benzoxazole-benzthiazole) copolymer represented by the following Chemical Formula 62 was prepared through the following reaction.

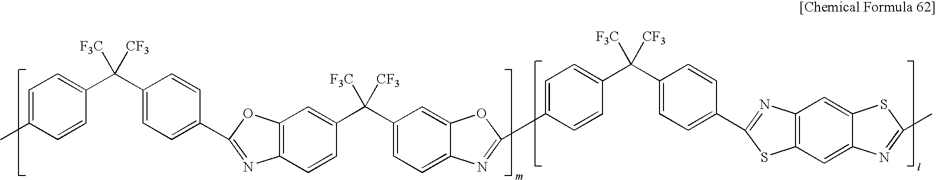

The hollow fiber including a poly(benzoxazole-benzthiazole) copolymer (herein, m:l in a mol ratio of 8:2) represented by the above Chemical Formula 62 was prepared according to the same method as Example 1 except for preparing a poly(hydroxyimide-thiolimide) copolymer by reacting 21.8 g (0.1 mol) of 2,5-diamino-1,4-benzenedithiol dihydrochloride as starting materials 36.6 g (0.16 mol) of 2,2-bis(3-amino-4-hydroxyphenyl)hexafluoropropane with 88.8 g (20 mmol) of 4,4′-(hexafluoroisopropylidene)diphthalic anhydride.

It had a weight average molecular weight of 46,790 and was identified to have a polybenzthiazole characteristic band of 1484 cm⁻¹ (C—S) 1404 cm⁻¹ (C—S) as well as a polybenzoxazole characteristic band of 1620 cm⁻¹ (C═N), 1058 cm⁻¹ (C—N) which were not detected in polyimide as a result of FT-IR analysis. The hollow fiber had a fractional free volume of 0.31 and interplanar distance (d-spacing) of 740 pm. The interplanar distance (d-spacing) was measured by X-ray diffraction (XRD, CuKα ray, 10 to 40 degrees at 0.05 degree intervals, a film sample)

### Example 14

A hollow fiber was prepared according to the same method as Example 1 except for preparing a homogenous solution by adding 5 wt % of tetrahydrofuran and 15 wt % of propyleneglycol as additives.

The hollow fiber had a weight average molecular weight of 48,960 and was identified to have a polybenzoxazole characteristic band of 1620 cm⁻¹ (C═N), 1058 cm⁻¹ (C—N) which were not detected in polyimide as a result of FT-IR analysis. The hollow fiber had fractional free volume of 0.32 and interplanar distance (d-spacing) of 730 pm. The interplanar distance (d-spacing) was measured by X-ray diffraction (XRD, CuKα ray, 10 to 40 degrees at 0.05 degree intervals, a film sample)

### Example 15

A hollow fiber was prepared according to the same method as Example 1 except for preparing a homogenous solution by adding 5 wt % of tetrahydrofuran and 15 wt % of ethanol as an additive to prepare a homogenous solution.

The hollow fiber had a weight average molecular weight of 48,960 and was identified to have a polybenzoxazole characteristic band of 1620 cm⁻¹ (C═N), 1058 cm⁻¹ (C—N) which were not detected in polyimide from a result of FT-IR analysis. The hollow fiber had a fractional free volume of 0.33 and interplanar distance (d-spacing) of 740 pm. The interplanar distance (d-spacing) was measured by X-ray diffraction (XRD, CuKα ray, 10 to 40 degrees at 0.05 degree intervals, a film sample)

### Example 16

A hollow fiber was prepared according to the same method as Example 1 except for preparing a homogenous solution by adding and mixing 15 wt % of polyethyleneglycol additive (Aldrich, molecular weight 2000) as a pore-controlling agent.

The hollow fiber had a weight average molecular weight of 48,960 and a polybenzoxazole characteristic band of 1620 cm⁻¹ (C═N), 1058 cm⁻¹ (C—N) from the result of FT-IR analysis which were not detected in polyimide. In addition, it had a fractional free volume of 0.33 and interplanar distance (d-spacing) of 720 pm. The interplanar distance (d-spacing) was measured by X-ray diffraction (XRD, CuKα ray, 10 to 40 degrees at 0.05 degree intervals, a film sample)

### Example 17

A hollow fiber was prepared according to the same method as in Example 1 except for heat treatment at 450° C. for 30 minutes heat treatment.

The hollow fiber had a weight average molecular weight of 48,960 and a polybenzoxazole characteristic band of 1620 cm⁻¹ (C═N), 1058 cm⁻¹ (C—N) from the result of FT-IR analysis which were not detected in polyimide. In addition, the hollow fiber had a fractional free volume of 0.33 and interplanar distance (d-spacing) of 720 pm. The interplanar distance (d-spacing) was measured by X-ray diffraction (XRD, CuKα ray, 10 to 40 degrees at 0.05 degree intervals, a film sample)

### Example 18

A hollow fiber was prepared according to the same method as Example except for heat treatment at 400° C. for 30 minutes.

The hollow fiber had a weight average molecular weight of 48,960 and a polybenzoxazole characteristic band of 1620 cm⁻¹ (C═N), 1058 cm⁻¹ (C—N) from the result of FT-IR analysis which were not detected in polyimide. The interplanar distance (d-spacing) was measured by X-ray diffraction (XRD, CuKα ray, 10 to 40 degrees at 0.05 degree intervals, a film sample)

In addition, the hollow fiber had a fractional free volume of 0.33 and interplanar distance (d-spacing) of 720 pm. The interplanar distance (d-spacing) was measured by X-ray diffraction (XRD, CuKα ray, 10 to 40 degrees at 0.05 degree intervals, a film sample)

### Comparative Example 1

As disclosed in Korean Patent laid open No. 2002-0015749, 35 wt % of polyethersulfone (Sumitomo, sumikaexcel) was dissolved in 45 wt % of NMP, and 5 wt % of tetrahydrofuran and 15 wt % of ethanol as an additive were added thereto to prepare a homogenous solution. The solution was spun through a double nozzle with a 10 cm-wide air gap. It was washed with flowing water for 2 days and dried under vacuum for 3 hours or more, preparing a hollow fiber.

### Comparative Example 2

A hollow fiber was prepared according to the same method as Example 1 except for not performing heat treatment process.

### Comparative Example 3

According to the PCT publication No. WO2005/007277, 4,4′-diaminodiphenylether (ODA) was reacted with benzophenone tetracarboxylic acid dianhydride (BTDA) to prepare polyamic acid (PAA). 19 wt % of the polyamic acid (PAA) was dissolved in N-methylpyrrolidone (NMP) to prepare a solution. Next, 50 wt % of polyvinylpyrrolidone (PVP) was dissolved in N-methylpyrrolidone to prepare an additive solution and added to the polyamic acid (PAA) solution. Then, glycerol (GLY) and N-methylpyrrolidone (NMP) were added to the solution. The final solution included polyamic acid/polyvinylpyrrolidone/glycerol/N-methylpyrrolidone (PAA/PVP/GLY/NMP) respectively in an amount ratio of 13/1/17/69 wt %. The spinning solution was mixed for 12 hours before spinning.

Next, 20° C. water was used as an internal coagulant, and then, the spinning solution was discharged through spinnerette. The internal coagulant was injected at a flow rate of 12 ml/min. Then, a hollow fiber was spinned at a speed of 4 cm/s, so that it can just stay for 6 seconds in an air cap. Herein, a membrane was solidified in 30° C. 100% water. Next, it was washed with water for 2 to 4 hours until a remaining solvent and glycerol were completely extracted at a room temperature. Then, it was dried in air. It was imidized in a nitrogen purged oven. Next, it was heated up to 150° C. for 3 hours, heated at 150° C. for 1 hour, heated up to 250° C. for 2 hours, kept being heated at 250° C. for 2 hours, and slowly cooled down at a room temperature for 4 hours. The polyimide/PVP membrane had an exterior diameter of 2.2 mm and a thickness of 0.3 mm.

### Experimental Example 1

### Electron-Scanning Microscope Analysis

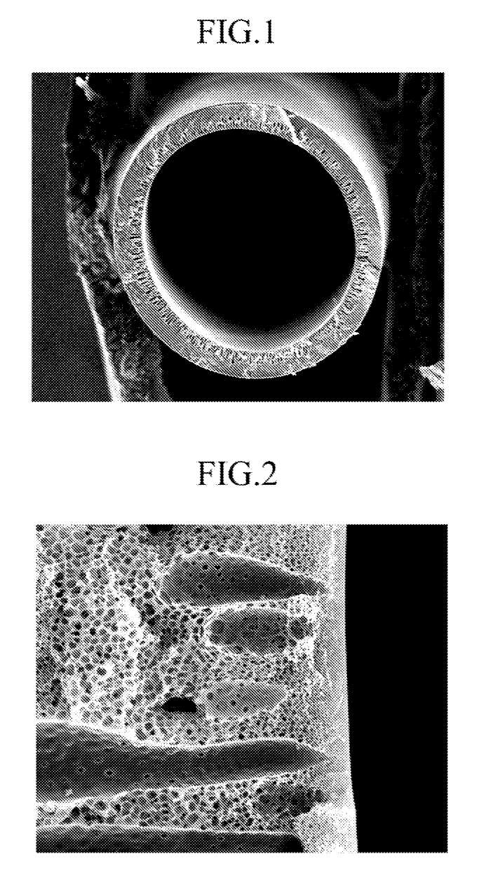

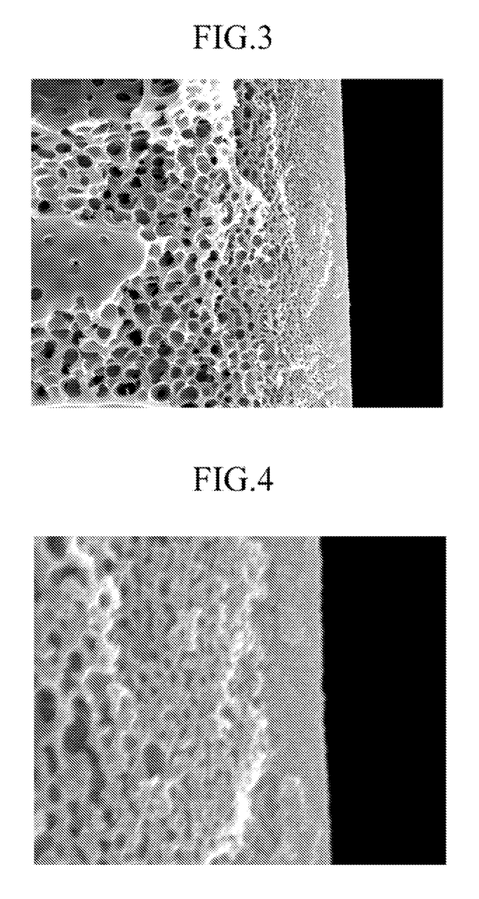

FIGS. 1, 2, and 3 show 300×, 1,500×, and 5,000× magnification electron-scanning microscope photographs of the partial cross-section of the hollow fiber according to Example 1.

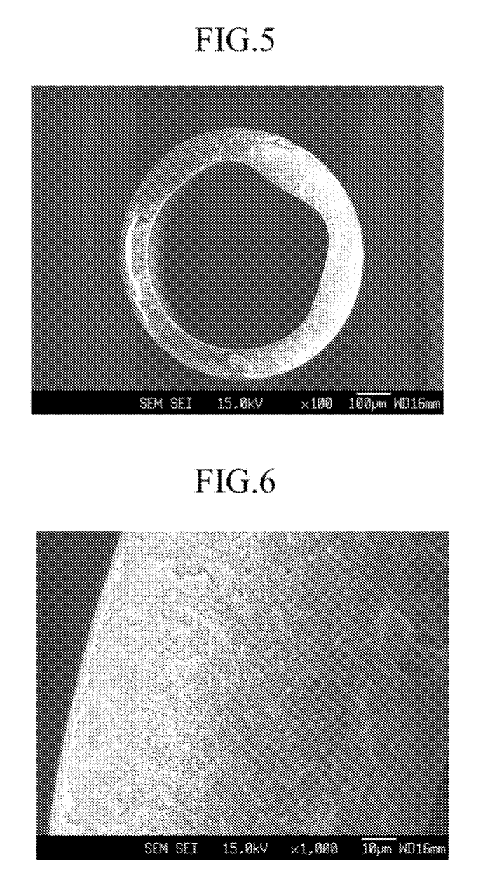

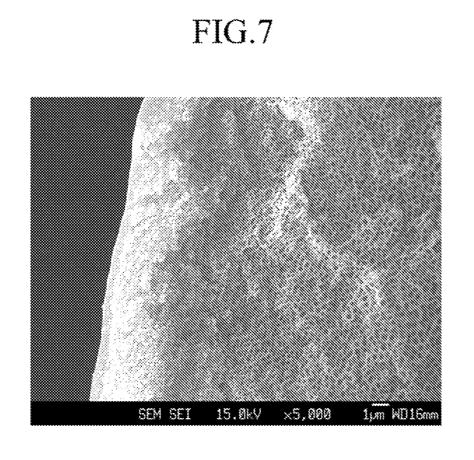

FIGS. 4, 5, and 6 show 120×, 600×, and 2,000× magnification electron-scanning microscope photographs of the partial cross-section of the hollow fiber according to Example 8.

Referring to FIGS. 1 to 6, the hollow fiber according to one embodiment of the present invention had no defect on the surface of the separation layer.

### Experimental Example 2

### Measurement of Gas Permeability and Selectivity

The hollow fibers according to Example 1 to 18 and Comparative Example 1 to 3 were evaluated as follows regarding gas permeability and selectivity. The results are provided in Table 1.

The gas permeability is a gas permeability speed against a membrane measured by fabricating a separation membrane module for gas permeability with a hollow fiber and measuring a gas permeability amount by the following Equation 1. As for a gas permeability unit, used is GPU (Gas Permeation Unit, 1×10⁻⁶ cm³/cm²·sec·cmHg).

The selectivity was indicated as a permeability ratio obtained by measuring an individual gas against the same membrane.

$$P = \frac{d p}{d t} [ \frac{{VT}_{0}}{{P}_{0} {TP}_{f} {A}_{eff}} ] \qquad [ Equation 1 ]$$

In the Equation 1,

P indicates gas permeability, dp/dt indicates a pressure increase rate, V indicates a lower volume, and P_{f} indicates difference between upper and lower pressures.

T indicates a temperature during the measurement, A_{eff} indicates an effective area, and P₀ and T₀ indicate standard pressure and temperature.

TABLE 1

| | H₂ permeability | O₂ permeability | CO₂ permeability | O₂/N₂ | CO₂/CH₄ |
|---|---|---|---|---|---|
| | (GPU) | (GPU) | (GPU) | selectivity | selectivity |
| Example 1 | 542 | 136 | 619 | 5.9 | 37.7 |
| Example 2 | 1680 | 630 | 2280 | 4.0 | 20.2 |
| Example 3 | 1270 | 286 | 985 | 5.8 | 20.1 |
| Example 4 | 116 | 59 | 115 | 4.5 | 35.9 |
| Example 5 | 131 | 19.2 | 86 | 7.7 | 41.0 |
| Example 6 | 292 | 61 | 216 | 5.2 | 24.3 |
| Example 7 | 165 | 31 | 167 | 6.0 | 40.7 |
| Example 8 | 215 | 37 | 138 | 6.0 | 35.4 |
| Example 9 | 85 | 19 | 97 | 4.6 | 34.6 |
| Example 10 | 615 | 119 | 227 | 4.6 | 26.1 |
| Example 11 | 86 | 27 | 48 | 7.1 | 30.0 |
| Example 12 | 419 | 95 | 519 | 5.3 | 37.1 |
| Example 13 | 1320 | 368 | 1125 | 5.3 | 27.4 |
| Example 14 | 875 | 151 | 516 | 4.7 | 22.7 |
| Example 15 | 1419 | 227 | 1619 | 4.0 | 34.4 |
| Example 16 | 1824 | 418 | 2019 | 4.3 | 28.4 |
| Example 17 | 211 | 41 | 211 | 4.7 | 50.2 |
| Example 18 | 35 | 2.6 | 10 | 7.0 | 29.7 |
| Comparative | 65 | 16 | 52 | 5.0 | 31.1 |
| Example 1 | | | | | |
| Comparative | 21.7 | 1.42 | 23.6 | 4.9 | 20.7 |
| Example 2 | | | | | |
| Comparative | 12.1 | 0.66 | 2.47 | 6.0 | 30.9 |
| Example 3 | | | | | |

Referring to Table 1, a hollow fiber according to Examples 1 to 18 of the present invention had excellent gas permeability against gas such as H₂, O₂, CO₂, and the like compared with the one of Comparative Examples 1 to 3.

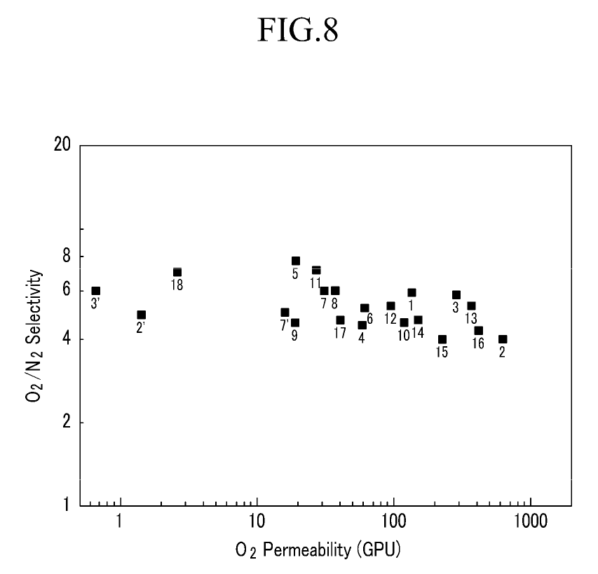

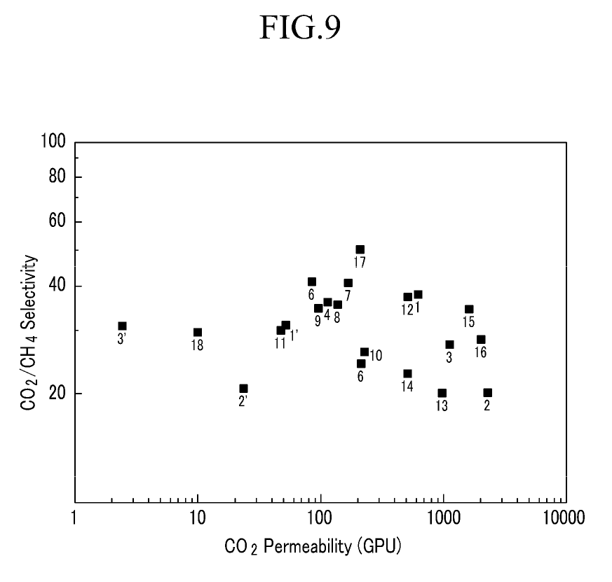

FIG. 8 is a graph showing oxygen permeability and oxygen/nitrogen selectivity comparison of GPU units of the hollow fibers according to Example 1 to 18 and Comparative Example 1 to 3.

FIG. 9 is a graph showing carbon dioxide permeability and carbon dioxide/methane selectivity comparison of GPU units of the hollow fibers according to Example 1 to 18 and Comparative Examples 1 to 3.

Referring to FIGS. 8 and 9, the hollow fiber according to Examples of the present invention had similar oxygen/nitrogen selectivity or carbon dioxide/methane selectivity to those of Comparative Examples but excellent permeability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hollow fiber comprising:
a hollow positioned at the center of the hollow fiber,
macropores positioned at adjacent to the hollow, and
mesopores and picopores positioned at adjacent to macropores
wherein the picopores are three dimensionally connected to each other to form a three dimensional network structure,
the hollow fiber comprises a polymer derived from polyimide, and
the polyimide comprises a repeating unit obtained from aromatic diamine including at least one ortho-positioned functional group with respect to an amine group and dianhydride.

2. The hollow fiber of claim 1, wherein the hollow fiber comprises a dense layer including picopores at a surface portion.

3. The hollow fiber of claim 2, wherein the dense layer has a structure where the number of the picopores increases as near to the surface of the hollow fiber.

4. The hollow fiber of claim 1, wherein the three dimensional network structure where at least two picopores are three-dimensionally connected comprises an hourglass shaped structure forming a narrow valley at connection parts.

5. The hollow fiber of claim 1, wherein the ortho-positioned functional group comprises OH, SH, or NH₂.

6. The hollow fiber of claim 1, wherein the polymer has a fractional free volume (FFV) of about 0.15 to about 0.40.

7. The hollow fiber of claim 1, wherein the polymer has interplanar distance (d-spacing) of about 580 pm to about 800 pm measured by X-ray diffraction (XRD).

8. The hollow fiber of claim 1, wherein the polymer comprises picopores, and
the picopores has a full width at half maximum (FWHM) of about 10 pm to about 40 pm measured by positron annihilation lifetime spectroscopy (PALS).

9. The hollow fiber of claim 1, wherein the polymer has a BET (Brunauer, Emmett, Teller) surface area of about 100 to about 1,000 m²/g.

10. The hollow fiber of claim 1, wherein the polyimide is selected from the group consisting of polyimide represented by the following Chemical Formulae 1 to 4, polyimide copolymers represented by the following Chemical Formulae 5 to 8, copolymers thereof, and blends thereof: 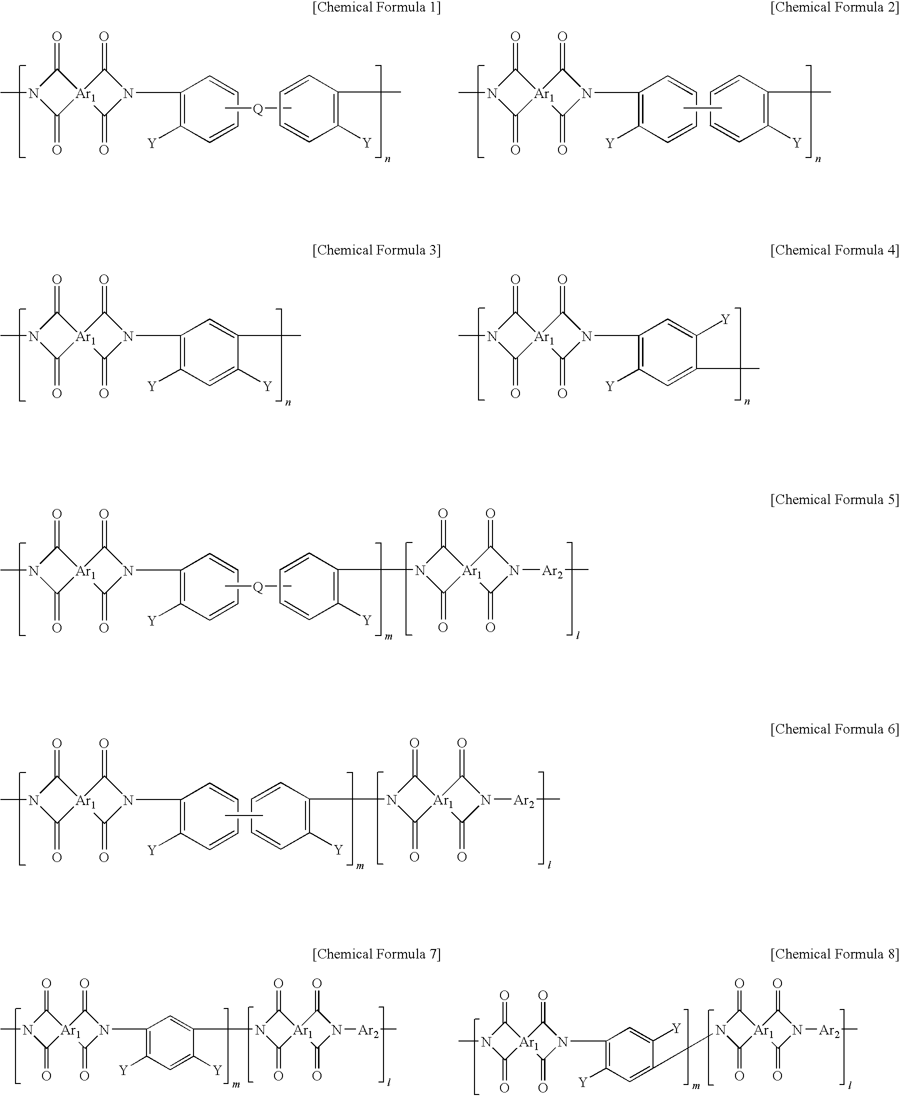
wherein in the above Chemical Formulae 1 to 8,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different from each other in each repeating unit and independently selected from OH, SH, or NH₂,
n is an integer ranging from 20 to 200,
m is an integer ranging from 10 to 400, and
l is an integer ranging from 10 to 400.

11. The hollow fiber of claim 10, wherein Ar₁ is selected from one of the following Chemical Formulae: 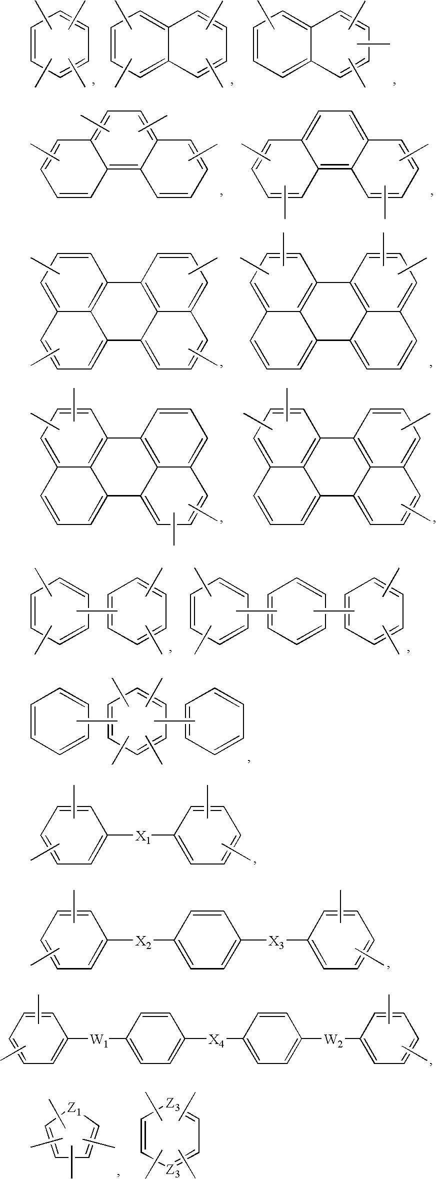
wherein, in the above Chemical Formulae,
X₁, X₂, X₃, and X₄ are the same or different and independently O, S, C(═O), CH(OH), S(═O)₂, Si(CH₃)₂, (CH₂)ₚ (where 1≦p≦10), (CF₂)ₚ (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂, and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

12. The hollow fiber of claim 11, wherein Ar₁ is selected from one of the following Chemical Formulae:

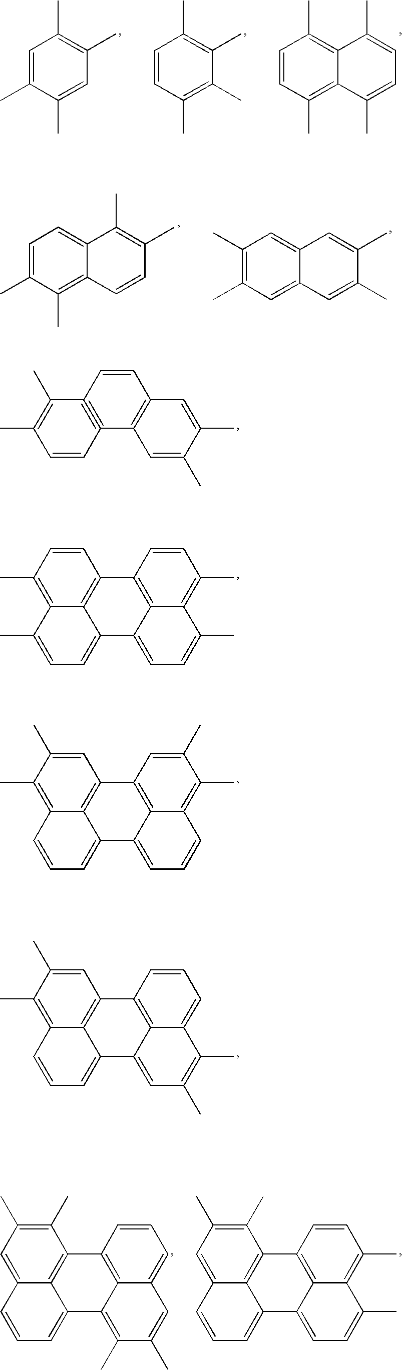

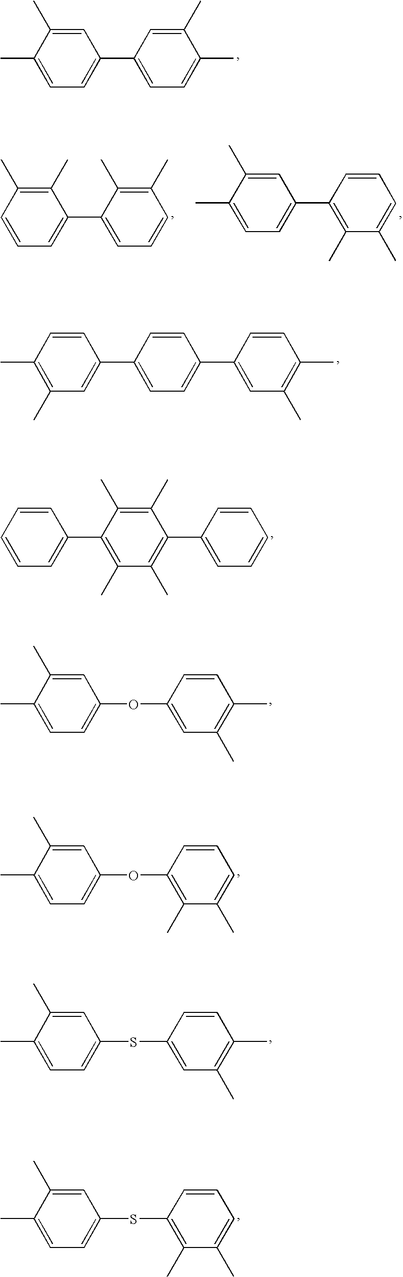

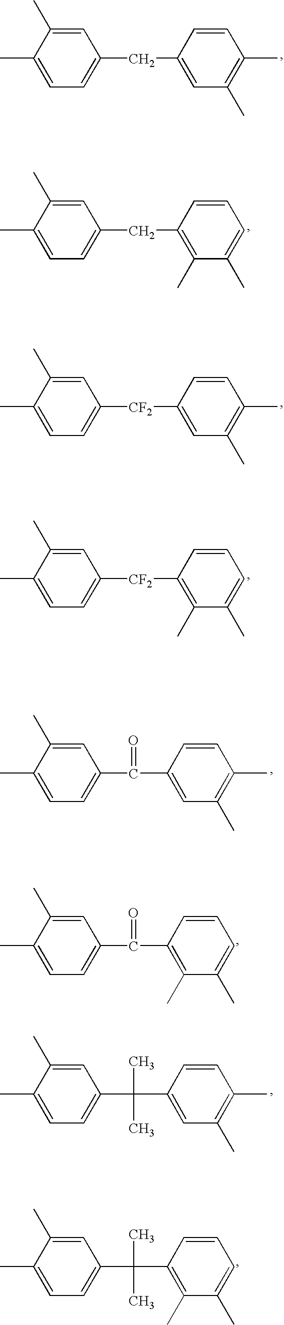

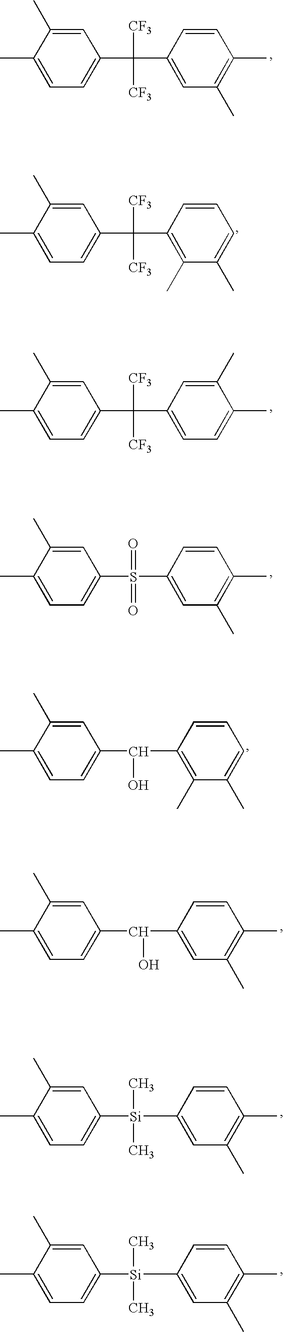

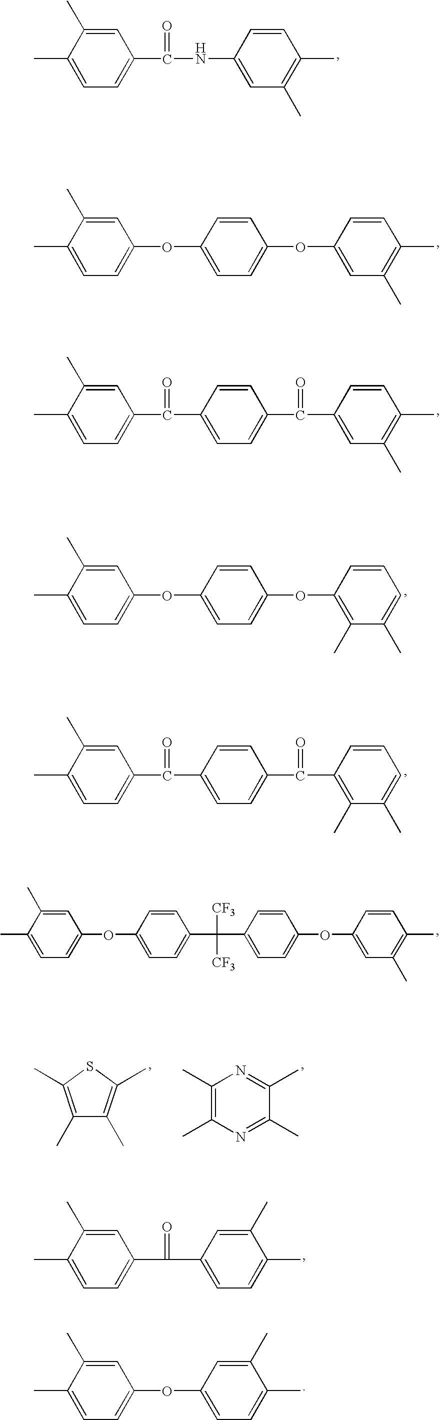

13. The hollow fiber of claim 10, wherein Ar₂ is selected from one of the following Chemical Formulae: 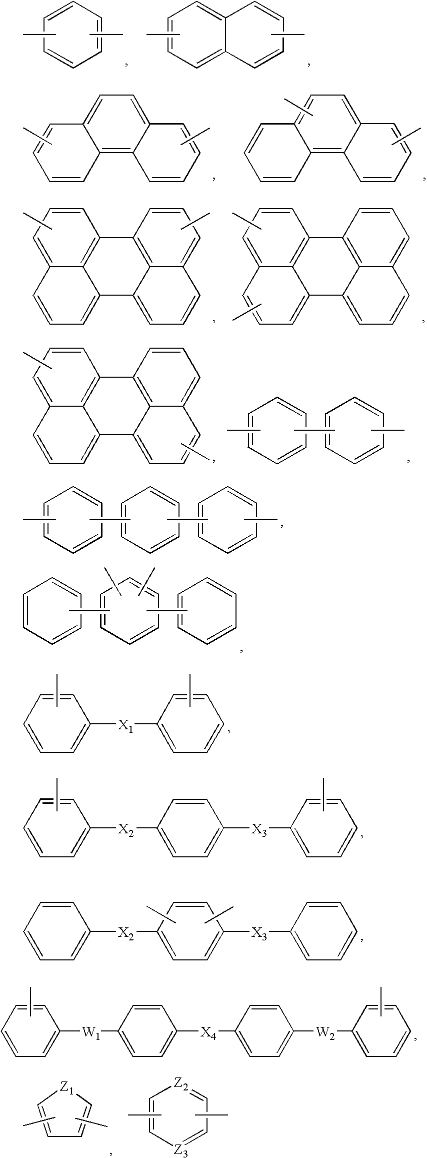
wherein, in the above Chemical Formulae,
X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂ and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

14. The hollow fiber of claim 13, wherein Ar₂ is selected from one of the following Chemical Formulae:

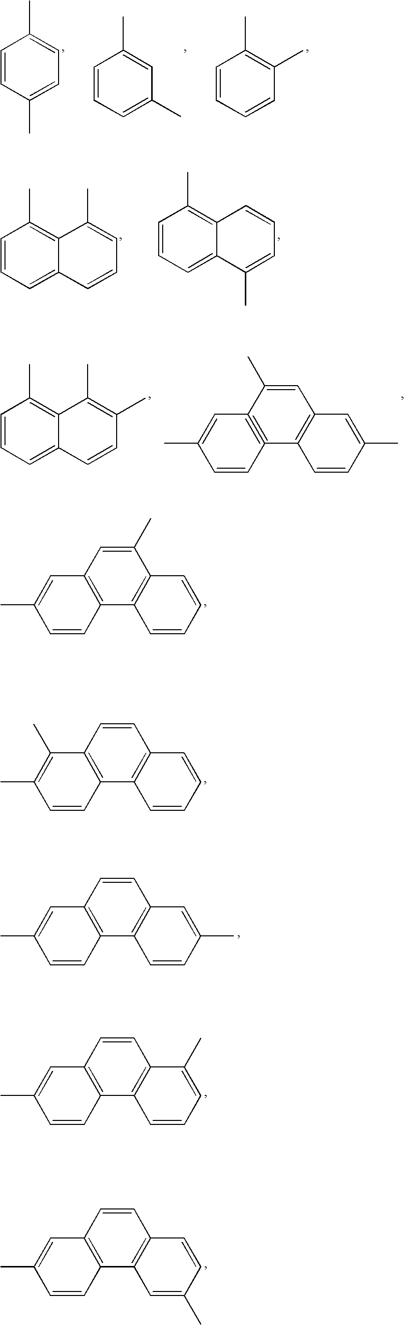

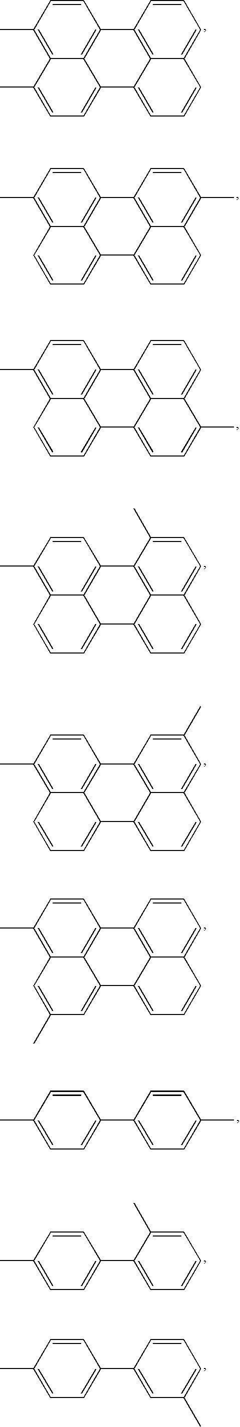

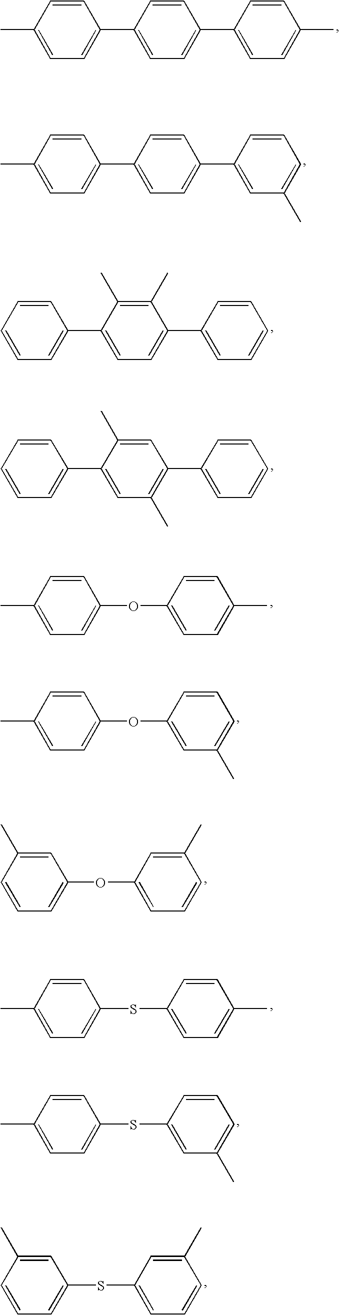

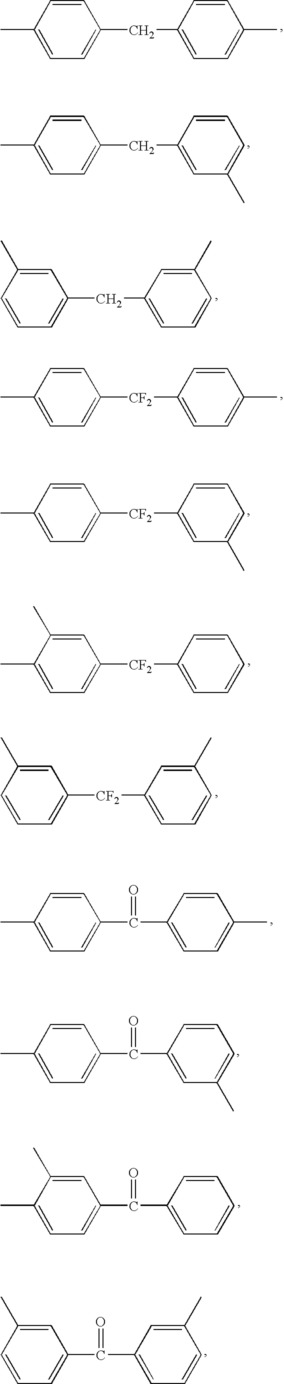

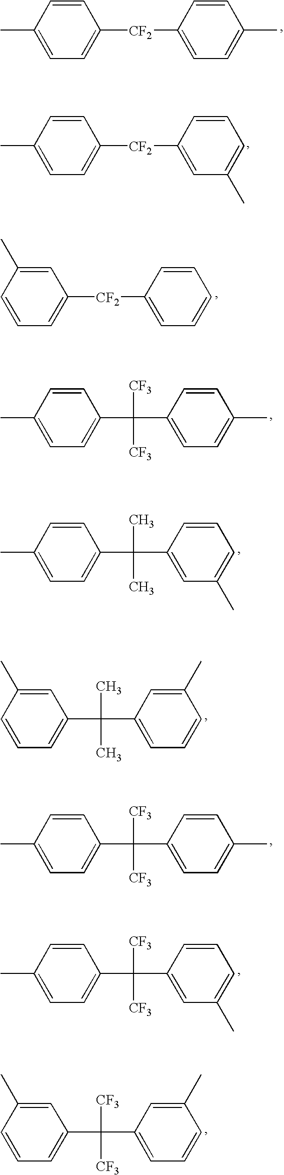

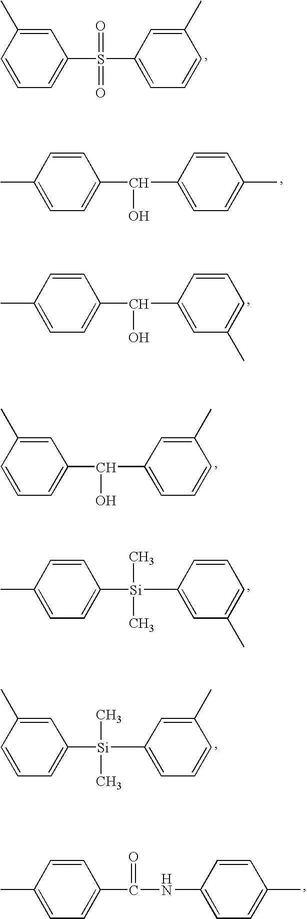

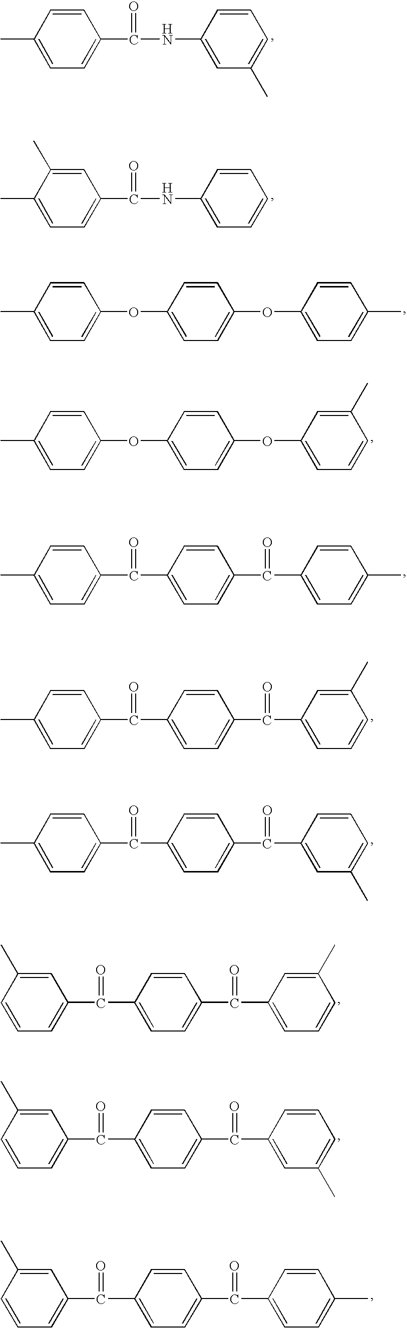

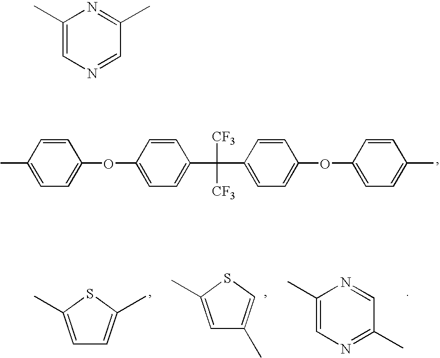

15. The hollow fiber of claim 10, wherein Q is selected from C(CH₃)₂, C(CF₃)₂, O, S, S(═O)₂, or C(═O).

16. The hollow fiber of claim 10, wherein Ar₁ is a functional group represented by the following Chemical Formula A, B, or C, Ar₂ is a functional group represented by the following Chemical Formula D or E, and Q is C(CF₃)₂:

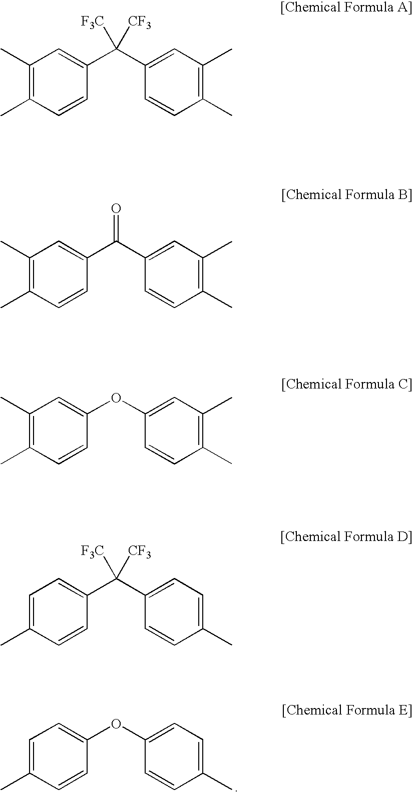

17. The hollow fiber of claim 10, wherein a mole ratio of each repeating unit represented by the above Chemical Formulae 1 to 4 in the polyimide copolymers or a m:l mole ratio in the above Chemical Formula 5 to Chemical Formula 8 ranges from 0.1:9.9 to 9.9:0.1.

18. The hollow fiber of claim 1, wherein the polymer comprises a polymer represented by one of the following Chemical Formulae 19 to 32, or copolymers thereof: 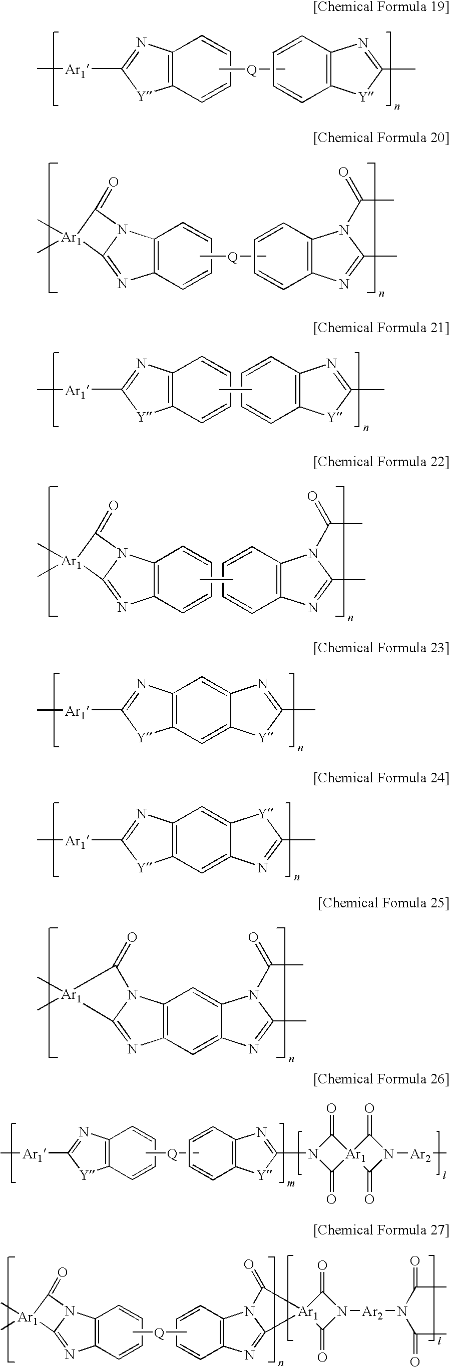 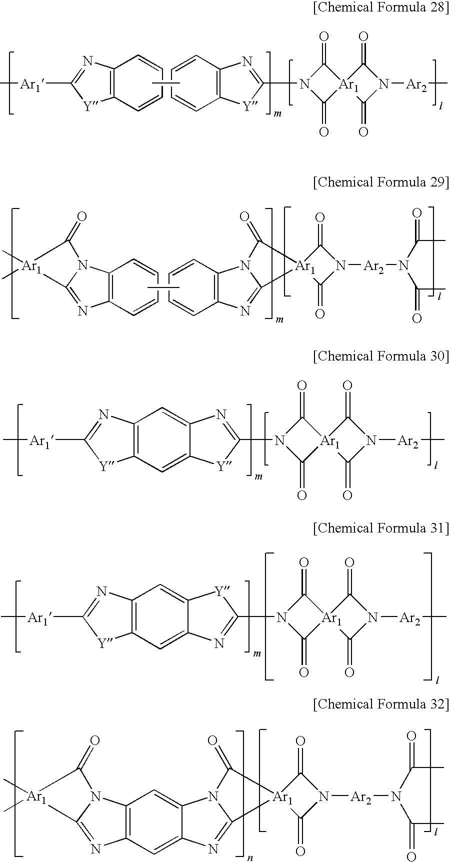
wherein in the above Chemical Formulae 19 to 32,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Ar₁′ and Ar₂ are the same or different, and independently an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y″ is O or S,
n is an integer ranging from 20 to 200,
m is an integer ranging from 10 to 400, and
l is an integer ranging from 10 to 400.

19. The hollow fiber of claim 18, wherein Ar₁ is selected from the following Chemical Formulae: 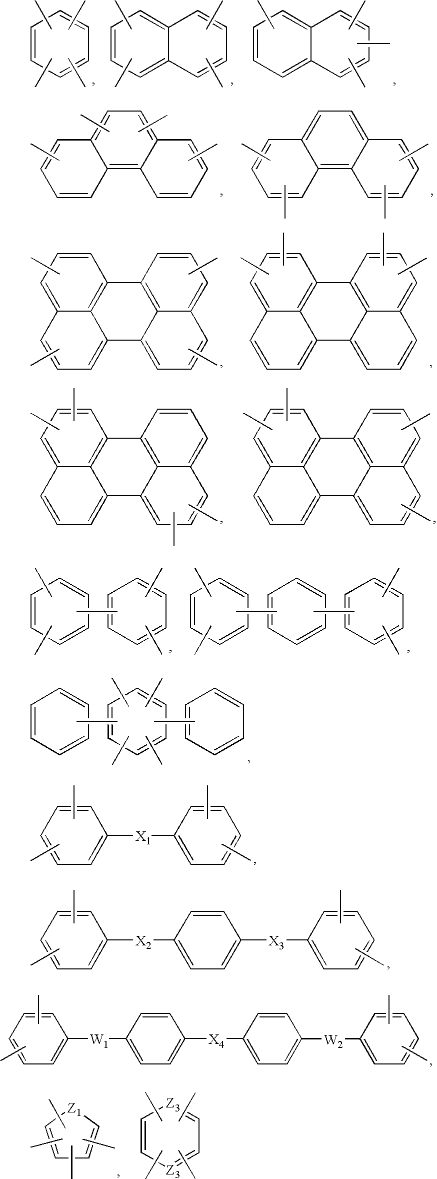
wherein, in the above Chemical Formulae,
X₁, X₂, X₃, and X₄ are the same or different and independently O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂, and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

20. The hollow fiber of claim 19, wherein Ar₁ is selected from one of the following Chemical Formulae:

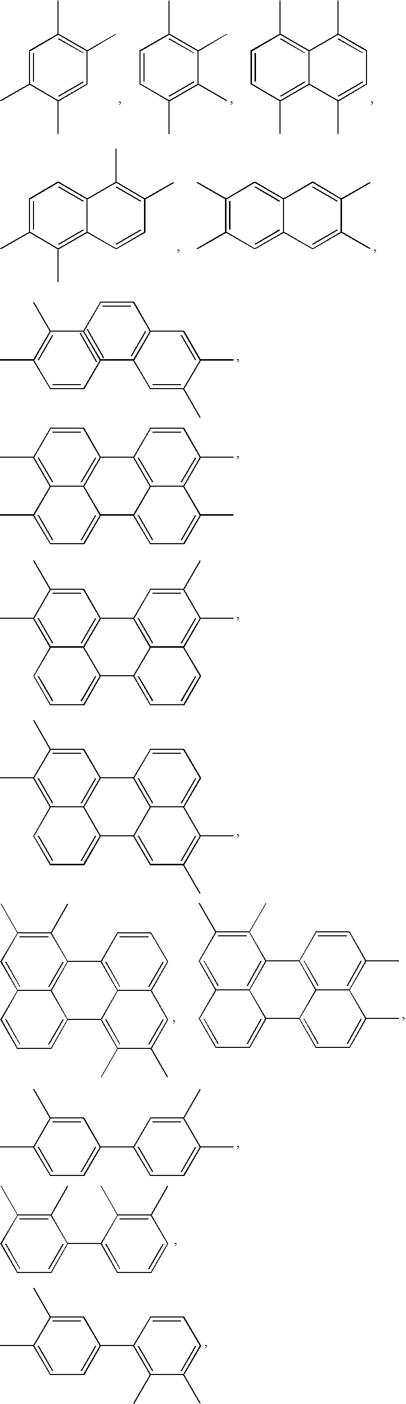

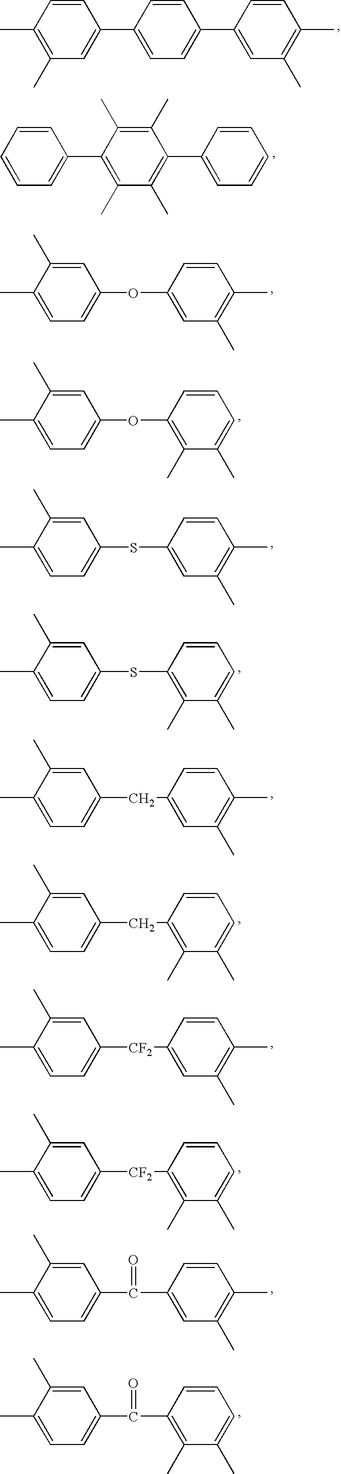

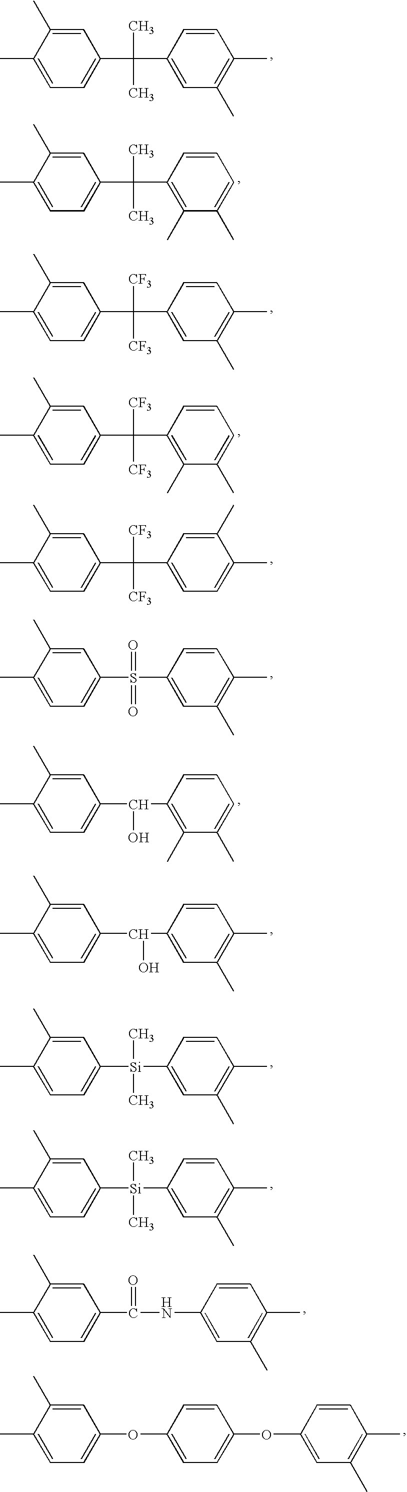

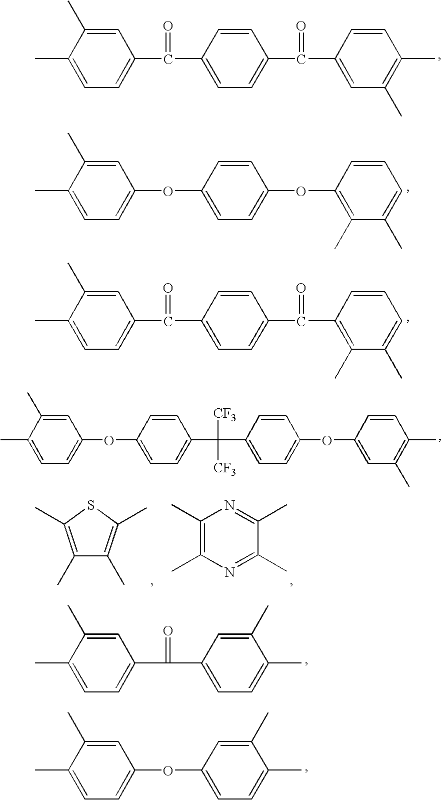

21. The hollow fiber of claim 18, wherein Ar₁′ and Ar₂ are selected from one of the following Chemical Formulae: 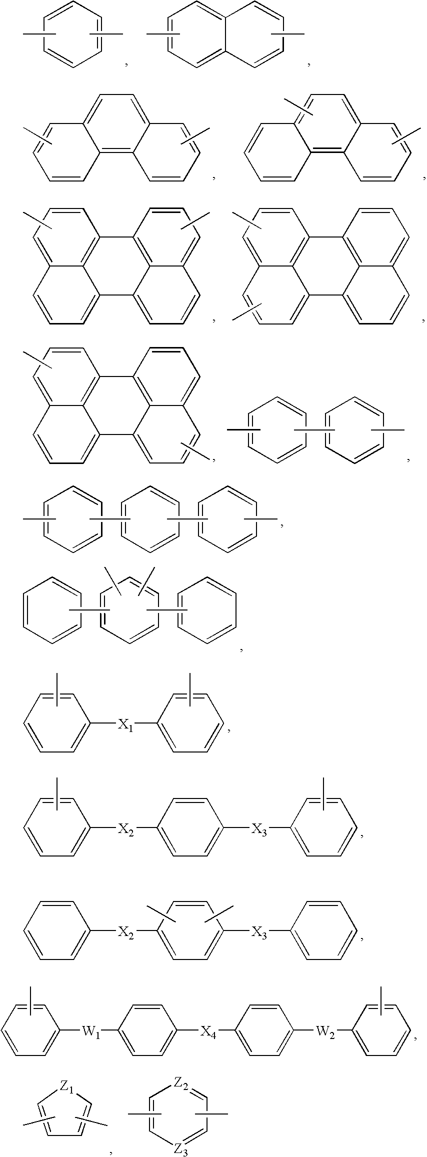
wherein, in the above Chemical Formulae,
X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂ and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

22. The hollow fiber of claim 21, wherein Ar₁′ and Ar₂ are selected from one of the following Chemical Formulae:

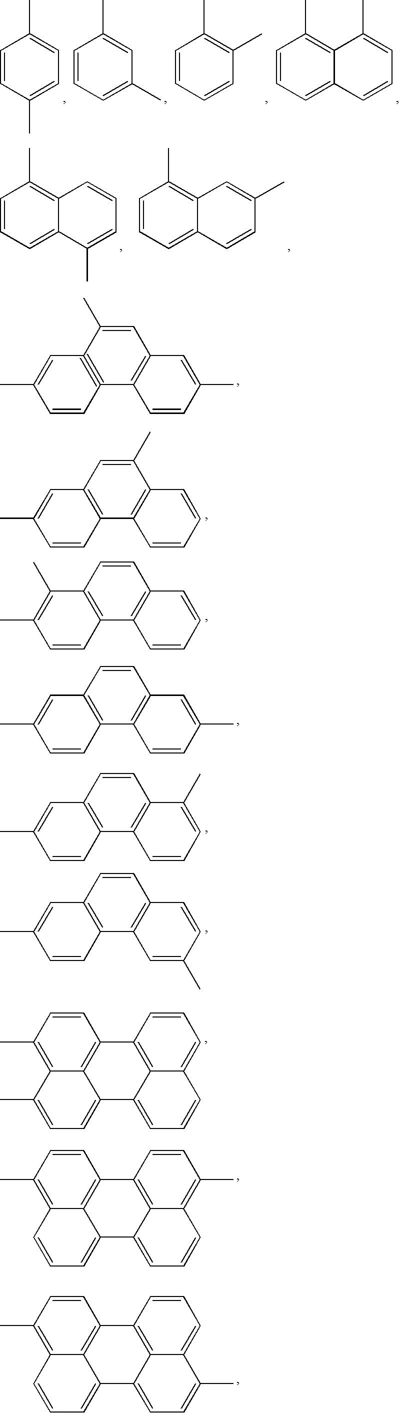

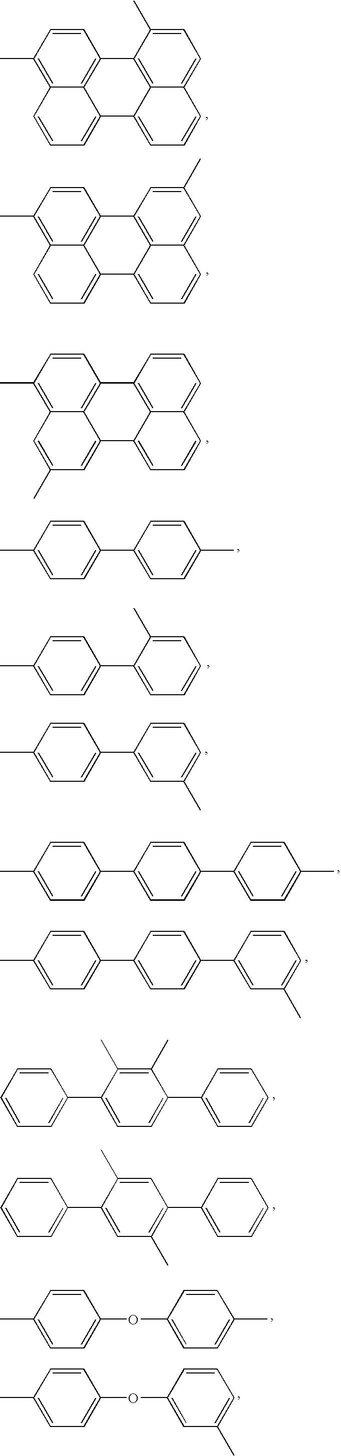

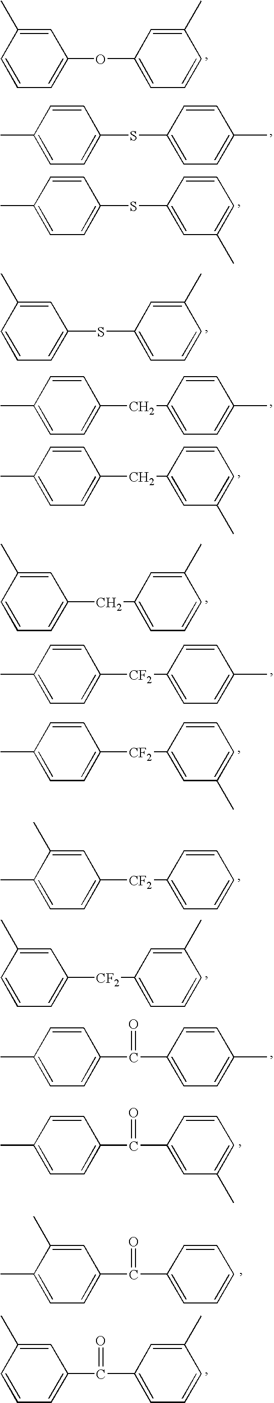

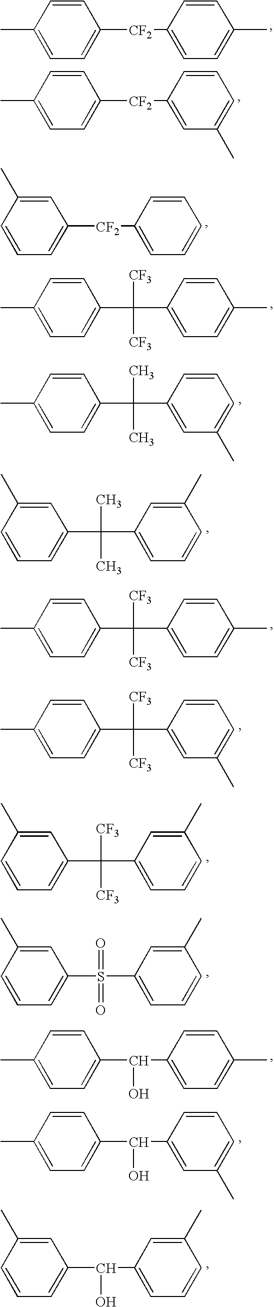

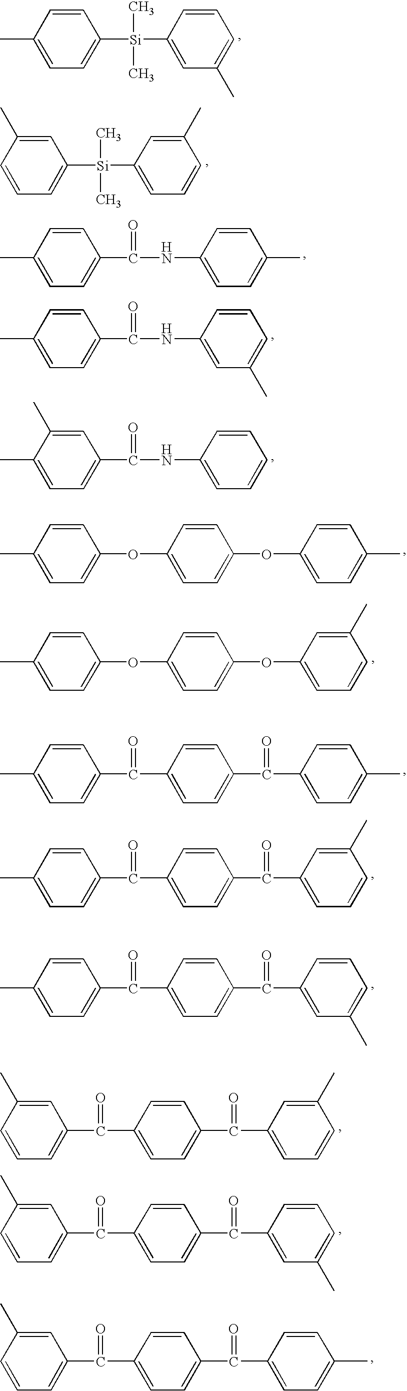

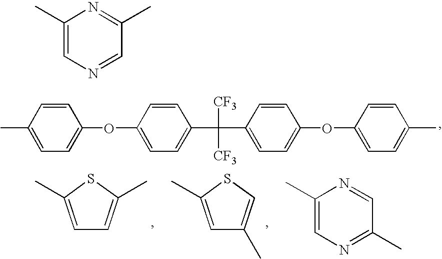

23. The hollow fiber of claim 18, wherein Q is selected from C(CH₃)₂, C(CF₃)₂, O, S, S(═O)₂, or C(═O).

24. The hollow fiber of claim 18, wherein Ar₁ is a functional group represented by the following Chemical Formula A, B, or C, Ar₁′ is a functional group represented by the following Chemical Formula F, G, or H, Ar₂ is a functional group represented by the following Chemical Formula D or E, and Q is C(CF₃)₂:

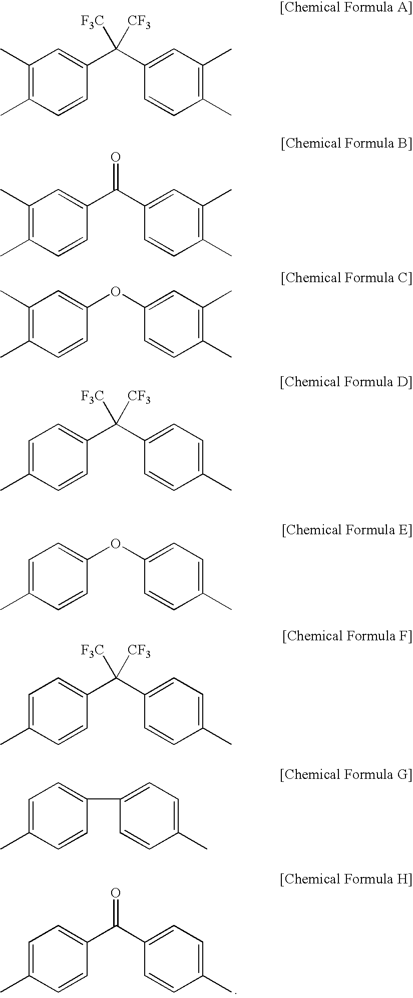

25. The hollow fiber of claim 1, wherein the hollow fiber is applicable for separating at least one gas selected from the group consisting of He, H₂, N₂, CH₄, O₂, N₂, CO₂, and combinations thereof.

26. The hollow fiber of claim 25, wherein the hollow fiber has O₂/N₂ selectivity of 4 or more, CO₂/CH₄ selectivity of 30 or more, H₂/N₂ selectivity of 30 or more, H₂/CH₄ selectivity of 50 or more, CO₂/N₂ selectivity of 20 or more, and He/N₂ selectivity of 40 or more.

27. The hollow fiber of claim 26, wherein the hollow fiber has O₂/N₂ selectivity of 4 to 20, CO₂/CH₄ selectivity of 30 to 80, H₂/N₂ selectivity of 30 to 80, H₂/CH₄ selectivity of 50 to 90, CO₂/N₂ selectivity of 20 to 50, and He/N₂ selectivity of 40 to 120.

28. A dope solution composition for forming a hollow fiber comprising:
polyimide including a repeating unit prepared from aromatic diamine including at least one ortho-positioned functional group and dianhydride;
an organic solvent; and
an additive,
wherein the organic solvent is selected from the group consisting of dimethylsulfoxide; N-methyl-2-pyrrolidone; N-methylpyrrolidone; N,N-dimethyl formamide; N,N-dimethyl acetamide; ketone selected from the group consisting of 7-butyrolactone, cyclohexanone, 3-hexanone, 3-heptanone, and 3-octanone; and combinations thereof, and
the additive is water; alcohols selected from the group consisting of methanol, ethanol, 2-methyl-1-butanol, 2-methyl-2-butanol, glycerol, ethyleneglycol, diethyleneglycol and propyleneglycol; ketones selected from the group consisting of acetone and methyl ethyl ketone; polymer compounds selected from the group consisting of polyvinyl alcohol, polyacrylic acid, polyacryl amide, polyethylene glycol, polypropylene glycol, chitosan, chitin, dextran, and polyvinylpyrrolidone; salts selected from the group consisting of lithium chloride, sodium chloride, calcium chloride, lithium acetate, sodium sulfate, and sodium hydroxide; tetrahydrofuran; trichloroethane; and mixtures thereof.

29. The dope solution composition of claim 28, wherein the ortho-positioned functional group comprises OH, SH, or NH₂.

30. The dope solution composition of claim 28, wherein the composition comprises 10 to 45 wt % of the polyimide, 25 to 70 wt % of the organic solvent, and 2 to 30 wt % of the additive.

31. The dope solution composition of claim 28, wherein the dope solution composition has a viscosity of about 2 Pa·s to about 200 Pa·s.

32. The dope solution composition of claim 28, wherein the polyimide has a weight average molecular weight (Mw) of about 10,000 to about 200,000.

33. The dope solution composition of claim 28, wherein the polyimide is selected from the group consisting of polyimide represented by the following Chemical Formulae 1 to 4, polyimide copolymers represented by the following Chemical Formulae 5 to 8, copolymers thereof, and blends thereof: 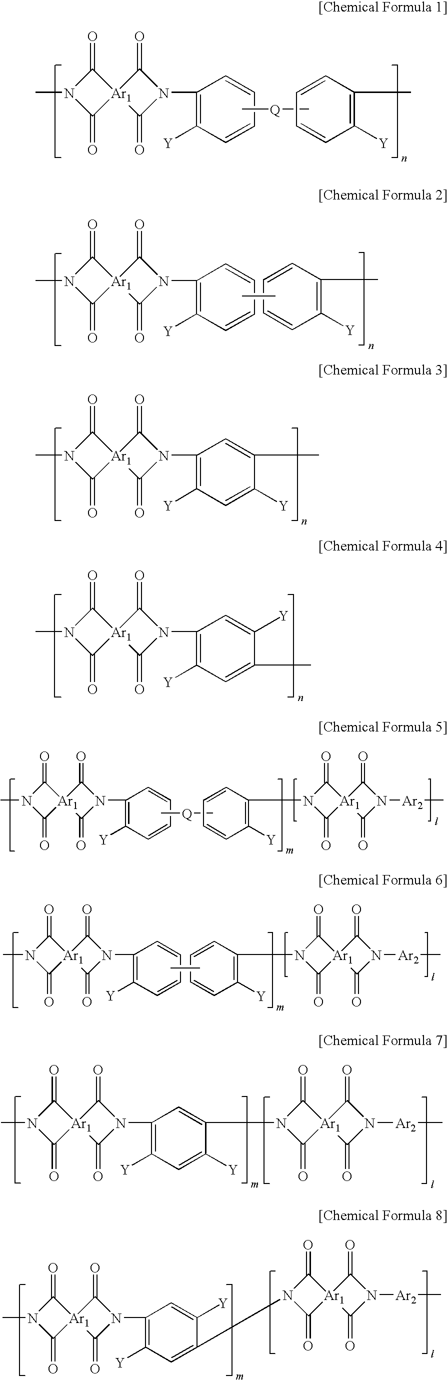
wherein in the above Chemical Formulae 1 to 8,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different from each other in each repeating unit and independently selected from OH, SH, or NH₂,
n is an integer ranging from 20 to 200,
m is an integer ranging from 10 to 400, and
l is an integer ranging from 10 to 400.

34. The dope solution composition of claim 33, wherein Ar₁ is selected from one of the following Chemical Formulae: 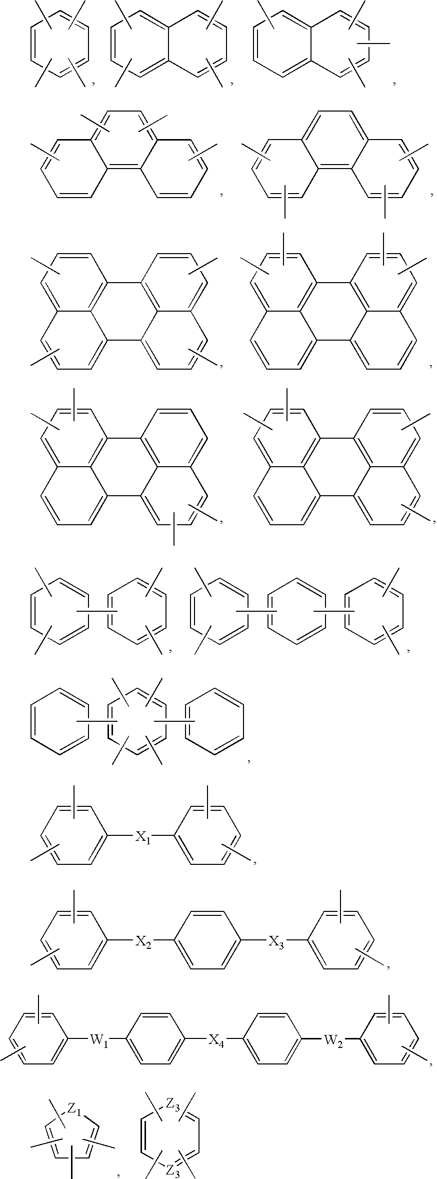
wherein, in the above Chemical Formulae,
X₁, X₂, X₃, and X₄ are the same or different and independently O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂, and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

35. The dope solution composition of claim 34, wherein Ar₁ is selected from one of the following Chemical Formulae:

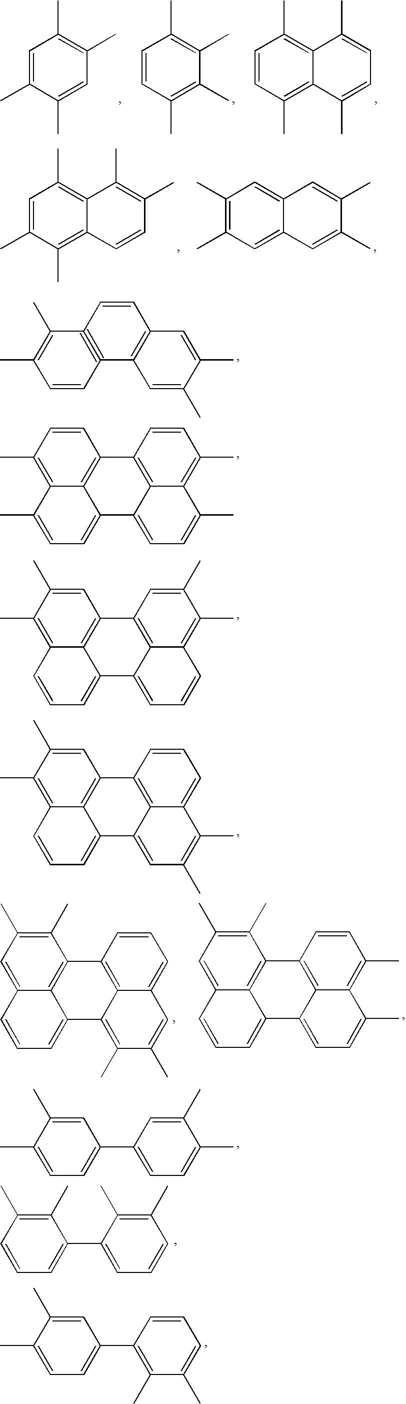

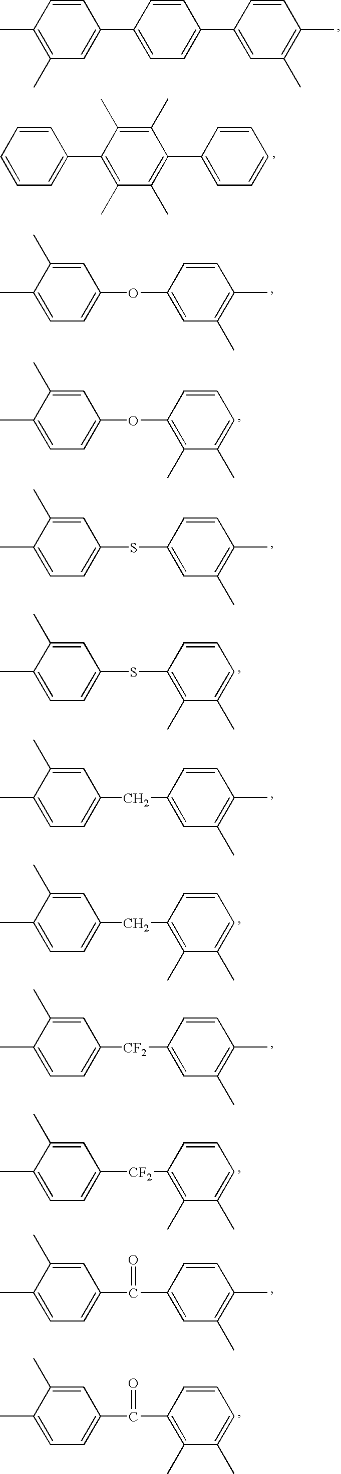

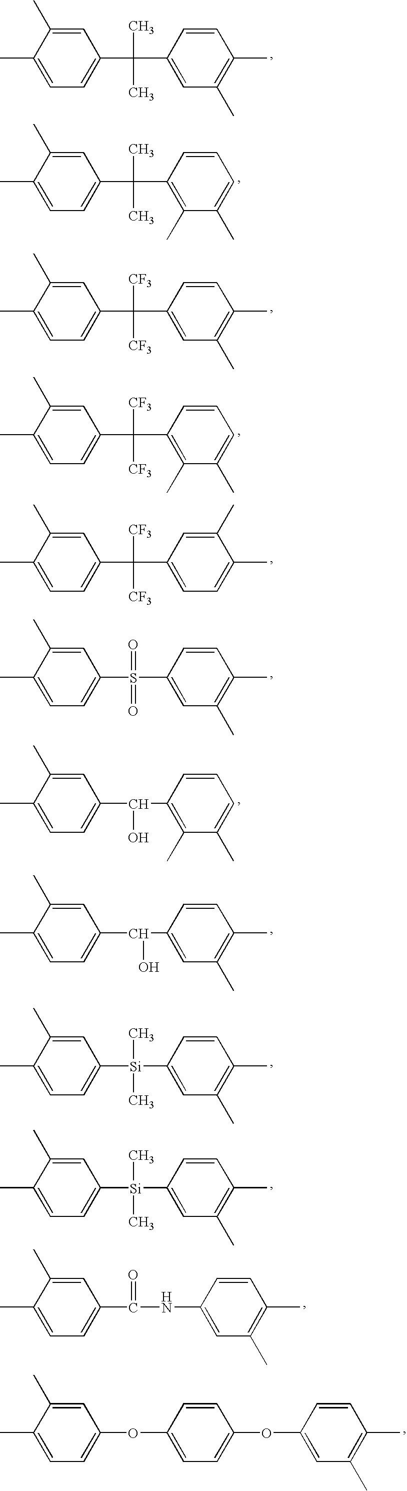

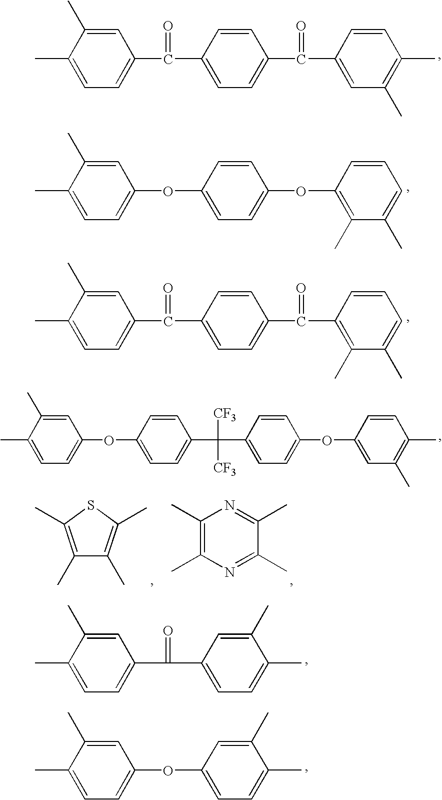

36. The dope solution composition of claim 33, wherein Ar₂ is selected from one of the following Chemical Formulae: 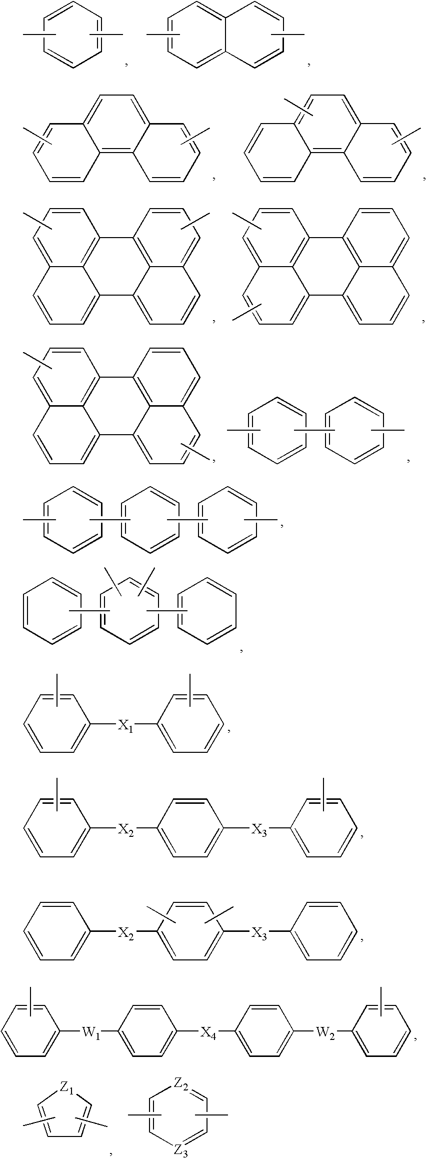
wherein, in the above Chemical Formulae,
X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different, and independently O, S, or C(═O),
Z₁ is O, S, CR₁R₂ or NR₃, where R₁, R₂ and R₃ are the same or different from each other and independently hydrogen or a C1 to C5 alkyl group, and
Z₂ and Z₃ are the same or different from each other and independently N or CR₄ (where, R₄ is hydrogen or a C1 to C5 alkyl group), provided that both Z₂ and Z₃ are not CR₄.

37. The dope solution composition of claim 36, wherein Ar₂ is selected from one of the following Chemical Formulae:

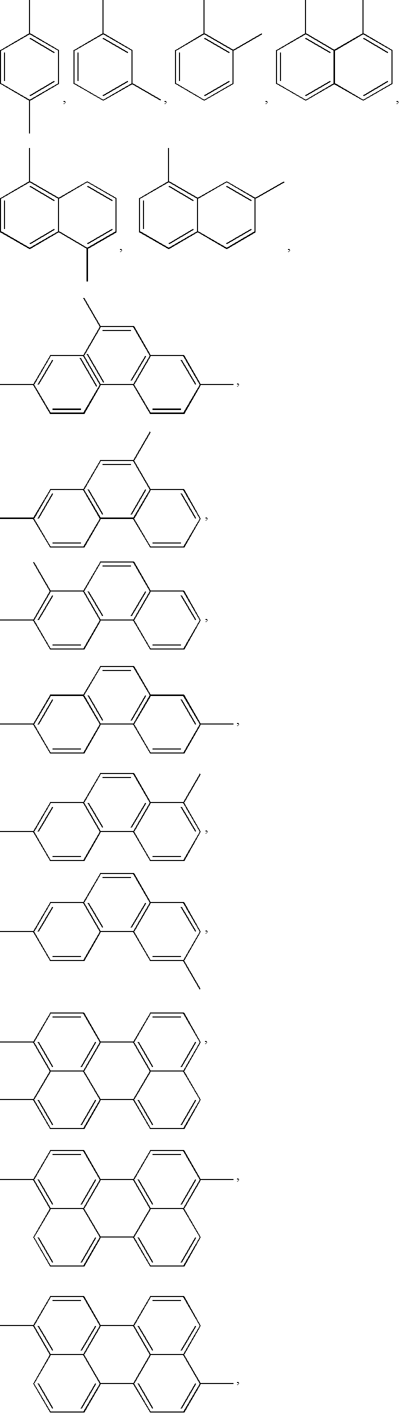

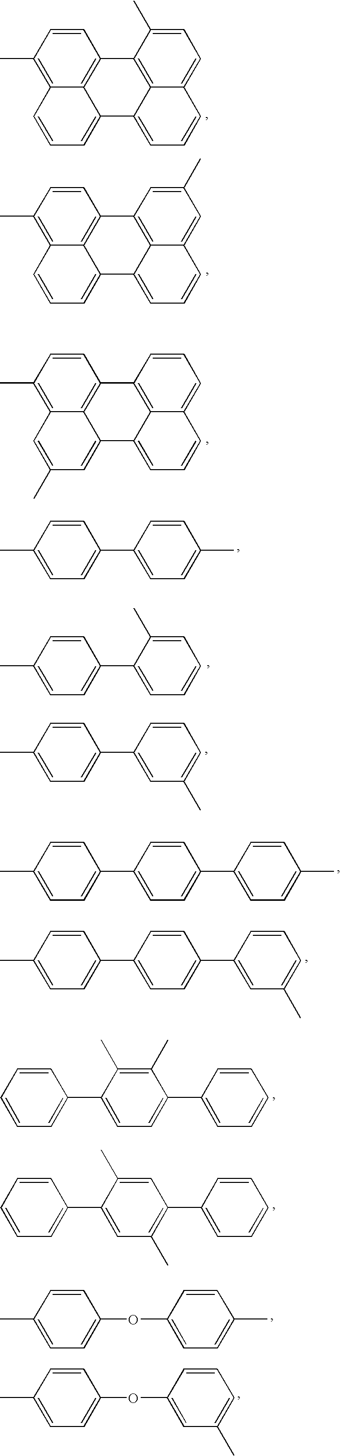

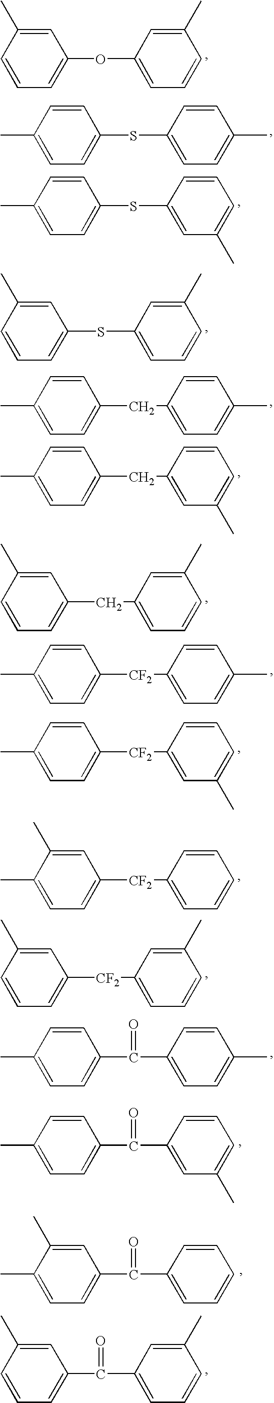

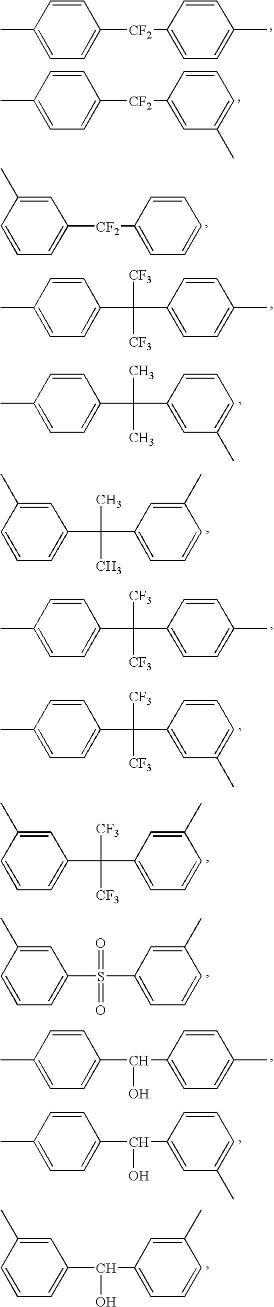

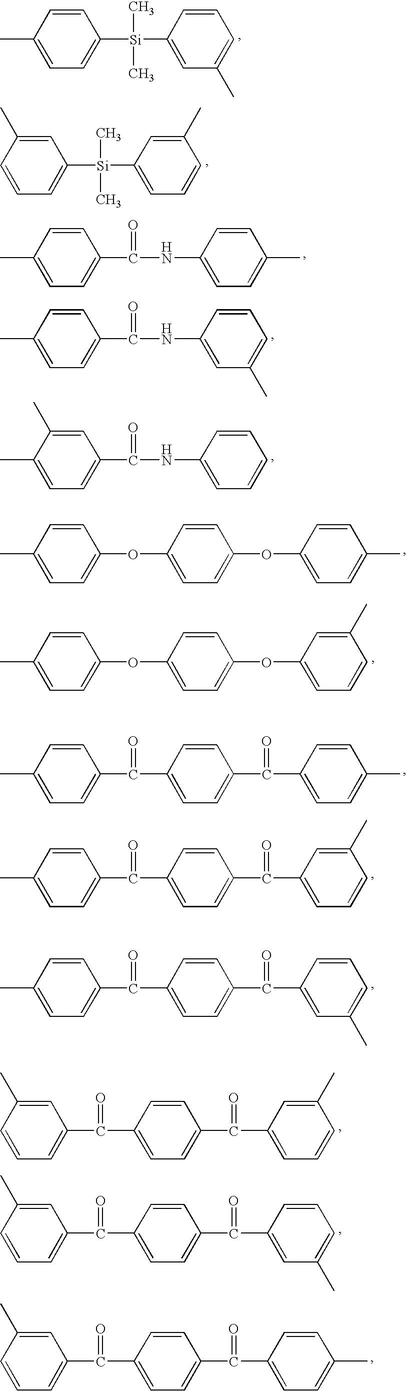

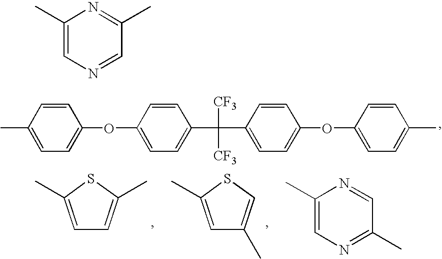

38. The dope solution composition of claim 33, wherein Q is selected from C(CH₃)₂, C(CF₃)₂, O, S, S(═O)₂, or C(═O).

39. The dope solution composition of claim 33, wherein Ar₁ is a functional group represented by the following Chemical Formula A, B, or C, Ar₂ is a functional group represented by the following Chemical Formula D or E, and Q is C(CF₃)₂:

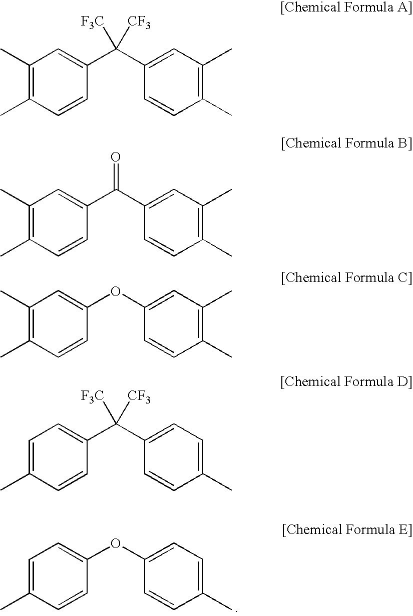

40. The dope solution composition of claim 33, wherein a mole ratio of each repeating unit represented by the above Chemical Formulae 1 to 4 in the polyimide copolymers or a m:l mole ratio in the above Chemical Formula 5 to Chemical Formula 8 ranges from 0.1:9.9 to 9.9:0.1.

41. A method of preparing a hollow fiber, comprising
spinning a dope solution composition for forming a hollow fiber according to claim 28 to prepare a polyimide hollow fiber; and
heat-treating the polyimide hollow fiber to obtain a hollow fiber including thermally rearranged polymer,
wherein the hollow fiber comprises
a hollow positioned at the center of the hollow fiber,
macropores positioned at adjacent to the hollow, and
mesopores and picopores positioned at adjacent to macropores, and
the picopores are three dimensionally connected to each other to form a three dimensional network structure.

42. The method of claim 41, wherein the thermally rearranged polymer comprises a polymer represented by one of the following Chemical Formulae 19 to 32, or copolymers thereof: 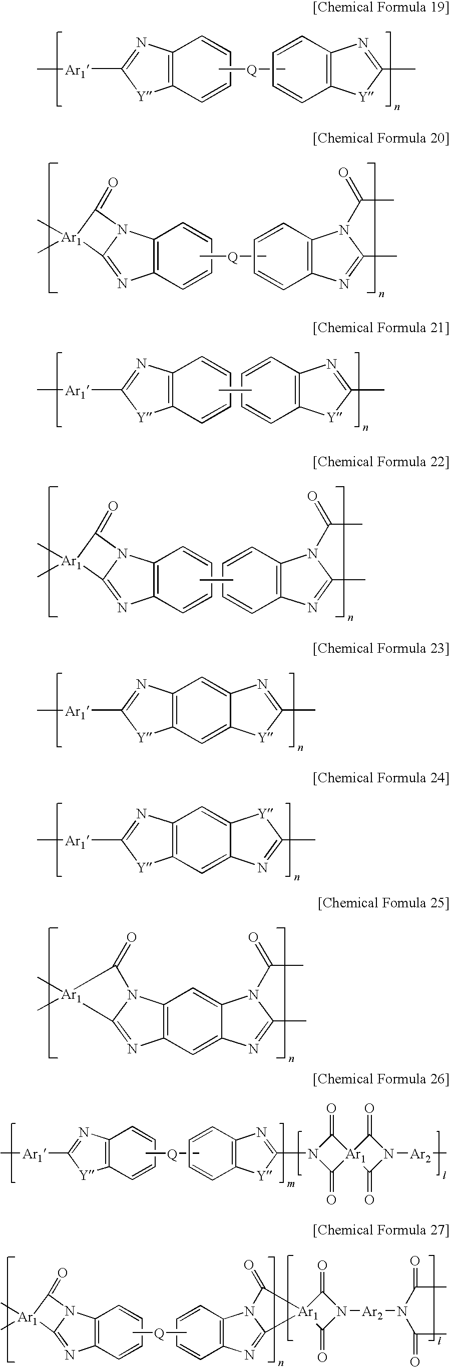 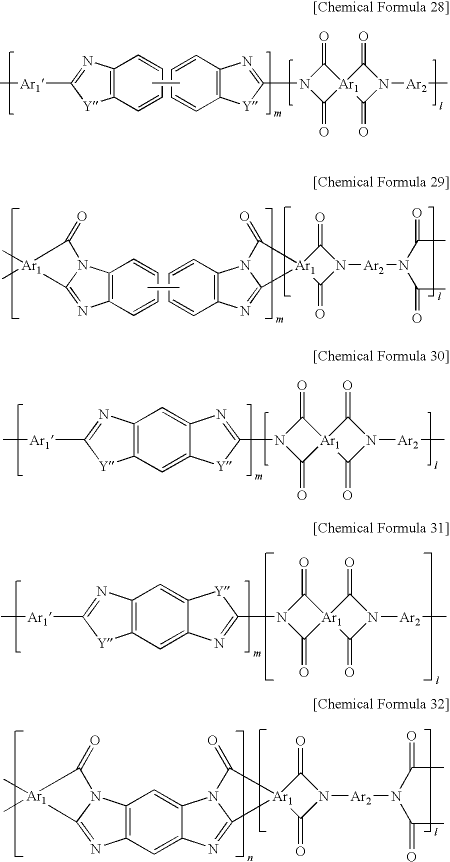
wherein in the above Chemical Formulae 19 to 32,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Ar₁′ and Ar₂ are the same or different, and are independently an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y″ is O or S,
n is an integer ranging from 20 to 200,
m is an integer ranging from 10 to 400, and
l is an integer ranging from 10 to 400.

43. The method of claim 41, wherein the polyimide represented by one of the above Chemical Formulae 1 to 8 is obtained from imidization of polyamic acid represented by one of the following Chemical Formulae 33 to 40: 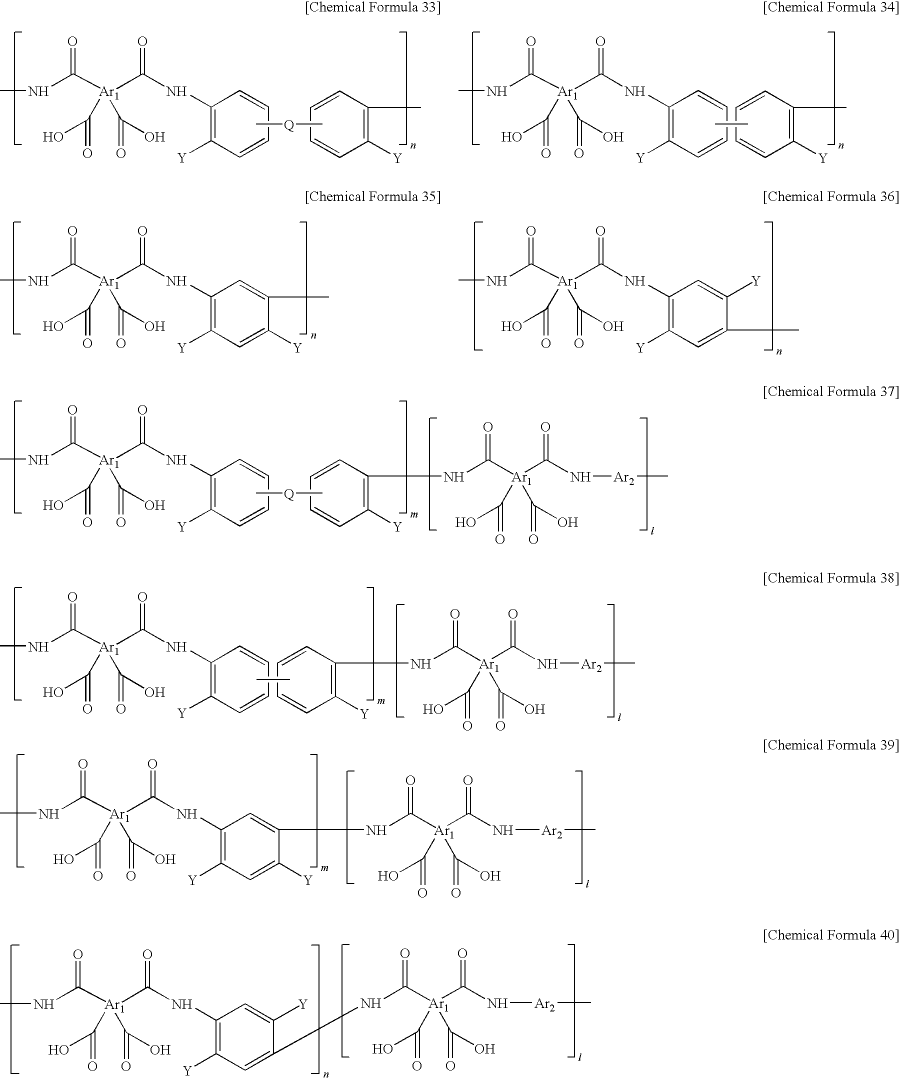
wherein in the above Chemical Formulae 33 to 40,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH, Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), S(═O)₂, Si(CH₃)₂, (CH₂)ₚ (where 1≦p≦10), (CF₂), (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different from each other in each repeating unit and independently selected from OH, SH, or NH₂,
n is an integer ranging from 20 to 200,
m is an integer ranging from 10 to 400, and
l is an integer ranging from 10 to 400.

44. The method of claim 43, wherein the imidization comprises chemical imidization or solution-thermal imidization.

45. The method of claim 44, wherein the chemical imidization is performed at 20 to 180° C. for 4 to 24 hours.

46. The method of claim 44, wherein the chemical imidization further comprises
protecting an ortho-positioned functional group of polyamic acid with a protecting group before imidization, and
removing the protecting group after imidization.

47. The method of claim 44, wherein the solution-thermal imidization is performed at 100 to 180° C. for 2 to 30 hours in a solution.

48. The method of claim 44, wherein the solution-thermal imidization further comprises
protecting an ortho-positioned functional group of polyamic acid with a protecting group before imidization, and
removing the protecting group after imidization.

49. The method of claim 44, wherein the solution-thermal imidization is performed using an azeotropic mixture.

50. The method of claim 44, wherein the heat treatment is performed by increasing a temperature at 10 to 30° C./min up to 400 to 550° C., and then maintaining the temperature for 1 minute to 1 hour under an inert atmosphere.
